(19) United States
(12) Patent Application Publication
(10) Pub. No.: US 2025/0104020 A1
(43) Pub. Date: Mar. 27, 2025

(54) SYSTEM AND METHOD FOR ESTIMATING UNIFORM ANNUAL COST FOR LOCALIZED PREVENTIVE MAINTENANCE AND REPAIR OF PAVEMENT

(71) Applicant: United States of America as Represented by The Secretary of The Army, Alexandria, VA (US)

(72) Inventors: Mohamed Y. Shahin, Windsor, CO (US); Robert E. Reinke, Indianapolis, IN (US); Spencer H. Dickey, Indianapolis, IN (US)

(21) Appl. No.: 18/372,337

(22) Filed: Sep. 25, 2023

(51) Int. Cl. G06Q 10/20; G06Q 10/063

(52) U.S. Cl. CPC G06Q 10/20; G06Q 10/063

(57) ABSTRACT

PMA, a specialized computer running PMA software, may be configured to apply risk cost and return on investment analysis to determine an optimized work plan for maintenance and repairs of a network of road sections. PMA may be configured to incorporate global maintenance and repair activities (such as surface treatments), major maintenance and repair activities (such as overlays and reconstruction), and localized preventative maintenance and repair activities (such as crack sealing and patching).

### STATEMENT REGARDING FEDERALLY SPONSORED RESEARCH OR DEVELOPMENT

The invention described herein was made by an employee of the United States Government and may be manufactured and used by the Government of the United States of America for governmental purposes without the payment of any royalties thereon or therefore.

### CROSS CITATIONS

Co-pending application (COE-871A) filed on the same day as this application and incorporated by reference in its entirety contains detailed information on determining estimated uniform annual cost with and without global M&R at time tₑᵥₐₗ; localized cost component of estimated uniform annual cost for Global and Major M&R; and estimated uniform annual cost with and without major M&R at time tₑᵥₐₗ. COE-871A also contains detailed information on the algorithm and method to resolve EUAC^{S}^{^{w}}(tₑᵥₐₗ) and EUAC^{S}_{wo}(tₑᵥₐₗ) for global M&R. A full explanation and detailed process flow for the LocalCostCalc may be found in co-pending application (COE-871A).

Co-pending application (COE-871B) filed on the same day as this application and incorporated by reference in its entirety contains detailed information on the algorithm and method to determine critical PCI for a PCI using major ROI calculations.

### FIELD OF INVENTION

This invention relates to systems and methods for repairing pavement.

### BACKGROUND OF THE INVENTION

Airfield and roadway pavements are deteriorating faster than they are being repaired. In the past, pavements were maintained but not managed, and little regard was given either to life cycle costing or to priority, as compared to other requirements. Letting pavements deteriorate without preventive maintenance is very costly and results in an increased backlog and eventually a loss of assets. As pavement infrastructure has proliferated and aged, a more systematic approach to determining maintenance and repair (M&R) needs and priorities became necessary. Optimum timing of repairs results in improved pavement condition and considerable cost savings over the life of the system. If M&R is performed during the early stages of deterioration, i.e., before the sharp decline in pavement condition, over 50% of lifecycle repair costs are saved. In addition to cost reduction, long periods of closure to traffic and detours can be avoided.

PCI (pavement condition index) provides both a numerical and a “qualitative” estimate of pavement condition on a scale. PCI allows pavement M&R managers to use and create other condition indices. Qualitative ranges for PCI may be customized and used for reporting analysis results in accordance with user requirements. Manuals for roads and airfields show defect type, severity level definitions, and guidelines for the measuring criteria used by inspectors.

Prior art interfaces exist for importing inspection data from automated collection resources such as those that may be affixed to a vehicle traveling over the target pavement section(s). Select embodiments of the present invention provide users a prior art interface for recording the results of an inspection and an online user's guide for selecting the type of distress and assigning a severity thereto, thereby facilitating the assessment of all pavement distresses on each pavement section.

The following materials and patents provide background information on the invention.
Patent: US 2010/0235203 A1 (incorporated by reference in its entirety), titled “Engineered Management System Particularly Suited for Maintenance and Repair (M&R) Management of Structure Such as Pavements.”
Patent: U.S. Pat. No. 10,936,282 B2 (incorporated by reference in its entirety), titled “System for Processing Multi-Level Condition Data to Achieve Standardized Prioritization.”
Textbook: Shahin, M. Y., “Pavement Management for Airports, Roads, and Parking Lots”, Second Edition.
U.S. Air Force Technical Letter (ETL), “Preventive Maintenance Plan (PMP) for Airfield Pavements.”
Shahin, M. Y. and Dodson, E. “Procedures for Determining the Risk of Not Performing Pavement Preventive Maintenance”, 17th International Road Federation World Meeting, November 2013.

### BRIEF SUMMARY OF THE INVENTION

Aspects of the invention may relate to a pavement management application (PMA) computer comprising a processor and tangible memory storing non-transitory computer readable software configured to cause the processor to execute a pavement repair program specialized in determining calculating EUAC^{S}_{w}(tₑᵥₐₗ) (estimated uniform annual cost per unit area for S when performing work (w) of a particular category at time/age tₑᵥₐₗ) and EUAC^{S}_{wo}(tₑᵥₐₗ) (estimated uniform annual cost per unit area for S without (wo) performing work of a particular category on S at time/age tₑᵥₐₗ) for localized preventive M&R when the PCI family was built with preventive maintenance.

The program may comprise an input interface configured to allow a user to specify to the program: a Section of pavement for evaluation(S); a PCI family (PF) assigned to Section(S) defined as PF^{S}; wherein PCI is a pavement condition index of the Section; a PCI_{crit} defined as a critical for PF^{S}; a M&R family (MF^{S}) assigned to S; an inspection history (IH^{S}) for S; a work history (WH^{S}) for S; a tᵢᵢ defined as an age of last inspection prior to any global work on S; ΔT^{S} defined as a lifespan loss not doing preventive maintenance on S; a work plan start (t_{WP}); a time of evaluation (tₑᵥₐₗ); a work-planned work WP^{S}(tₑᵥₐₗ) for S before (tₑᵥₐₗ); and a work-plan predicted conditions (C^{S}(tₑᵥₐₗ)) for S up to tₑᵥₐₗ.

The program may comprise a EUAC calculator configured to use: Common$, the sum of global work cost up to tₑᵥₐₗ (G$_{before}), localized work costs before work planning (L$ₚᵣₑ₁), localized work costs from work plan start to tₑᵥₐₗ (L$ₚᵣₑ₂), and a cost for major at PCI_{crit} (Major$_{crit}) to determine EUAC^{S}_{wo} and EUAC^{S}_{w}.

The program may comprise a global cost calculator configured to calculate G$_{before}. Additionally, the program may comprise a calculator configured to: determine localized costs before a workplan starts (L$ₚᵣₑ₁) from conditions by using the family curve shifted based on inspection and work history at each time t from 0 to t_{WP}−1 to determine a condition at time t of the Section S, and using MF^{S} to get the appropriate localized cost. The appropriate localized cost may be a preventive maintenance cost when the condition of the Section is above or equal to critical. The appropriate localized cost may be a safety maintenance cost when the condition of the Section is below critical. The work plan results (WP^{S}(tₑᵥₐₗ)) may comprise localized costs L$ₚᵣₑ₂. The program may comprise a calculator configured to calculate Major$_{crit}; calculate inputs for EUAC^{S}_{w}(tₑᵥₐₗ) using a family curve for families built with preventative maintenance; and calculate inputs for EUAC^{S}_{wo}(tₑᵥₐₗ) using a family curve for families built without preventative maintenance.

Aspects of the invention may relate to a pavement management application (PMA) computer comprising a processor and tangible memory storing non-transitory computer readable software configured to cause the processor to execute a pavement repair program specialized in determining calculating EUAC^{S}_{w}(tₑᵥₐₗ) and EUAC^{S}_{wo}(tₑᵥₐₗ) for localized preventive M&R when the PCI family was built without preventive maintenance.

The program may comprise an input interface configured to allow a user to specify to the program: a Section of pavement for evaluation (S); a PCI family (PF) assigned to Section (S) defined as PF^{S}; wherein PCI is a pavement condition index of the Section; an input estimated critical PCI (PCI_{crit}) for PF^{S}; a PCI_{crit} defined as a critical for PF^{S}; a M&R family (MF^{S}) assigned to S; an inspection history (IH^{S}) for S; a work history (WH^{S}) for S; a tᵢᵢ defined as an age of last inspection prior to any global work on S; ΔT^{S} defined as a lifespan gain for doing preventative maintenance on S; a work plan start (t_{WP}); a time of evaluation (tₑᵥₐₗ); a work-planned work for S before (tₑᵥₐₗ); and a work-plan predicted conditions (C^{S}(tₑᵥₐₗ)) for S up to tₑᵥₐₗ.

The program may comprise a EUAC calculator configured to use: Common$, the sum of global work cost up to tₑᵥₐₗ (G$_{before}), localized safety costs before work planning (L$ₚᵣₑ₁), localized work costs from work plan start to tₑᵥₐₗ (L$ₚᵣₑ₂), and a cost for major at PCI_{crit} (Major$_{crit}) to determine EUAC^{S}_{wo} and EUAC^{S}_{w}.

The program may comprise a global cost calculator configured to calculate G$_{before}. The calculator may be configured to determine localized costs before a workplan starts (L$ₚᵣₑ₁) from conditions by using the family curve shifted based on inspection and work history at each time t from 0 to t_{WP}−1 to determine the condition at time t, and using MR to get the appropriate localized safety cost at that condition cost; the work plan results (WP^{S}(tₑᵥₐₗ)) comprising localized costs L$ₚᵣₑ₂. The calculator may be configured to calculate Major$_{crit}; and calculate inputs for EUAC^{S}_{wo}(tₑᵥₐₗ) using a family curve for families built with preventative maintenance.

### COLOR DRAWINGS

The patent or application file contains at least one drawing executed in color. Copies of this patent or patent application publication with color drawing(s) will be provided by the Office upon request and payment of the necessary fee.

### BRIEF DESCRIPTION OF THE DRAWINGS

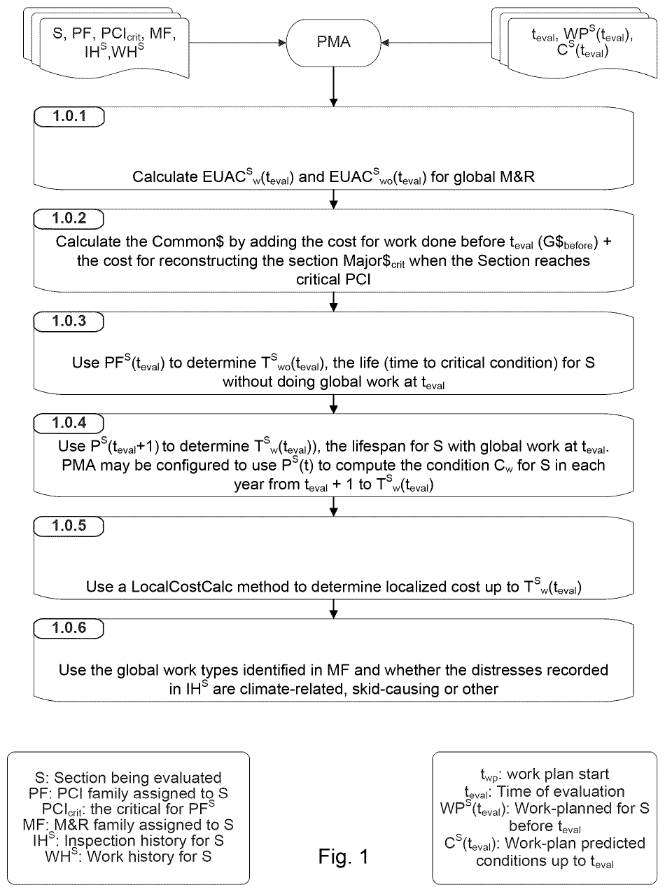

FIG. 1 is a flowchart for a method of determining estimated uniform annual cost with and without global M&R at time tₑᵥₐₗ.

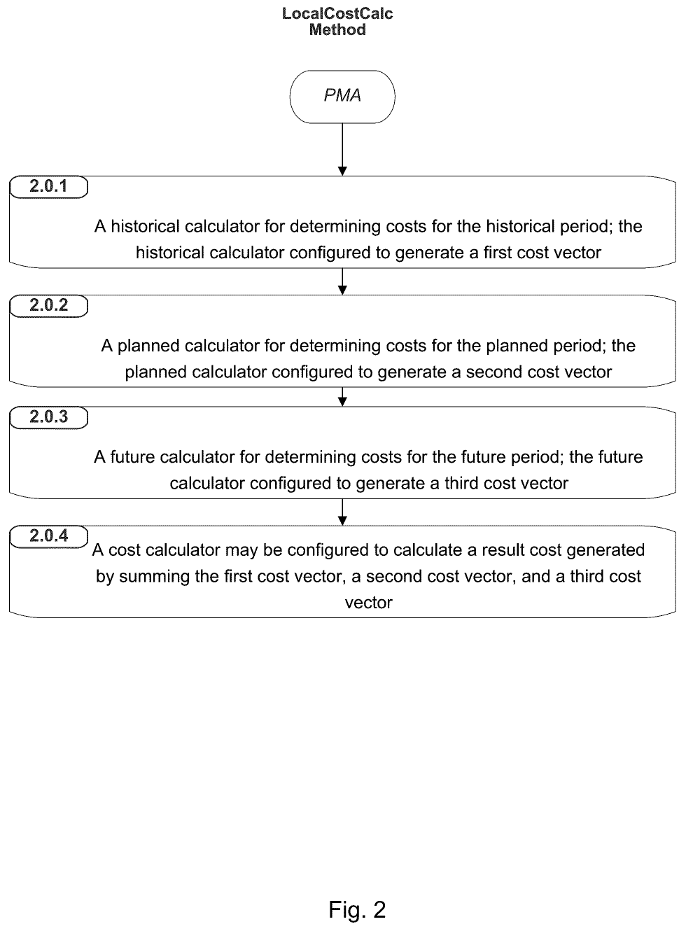

FIG. 2 is a flowchart for calculating the localized cost component of estimated uniform annual cost for Global and Major M&R.

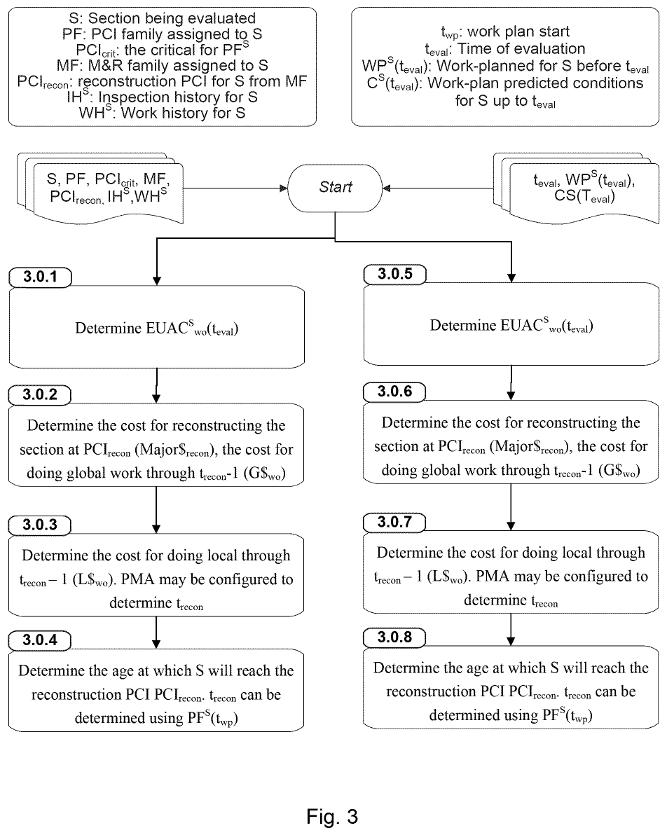

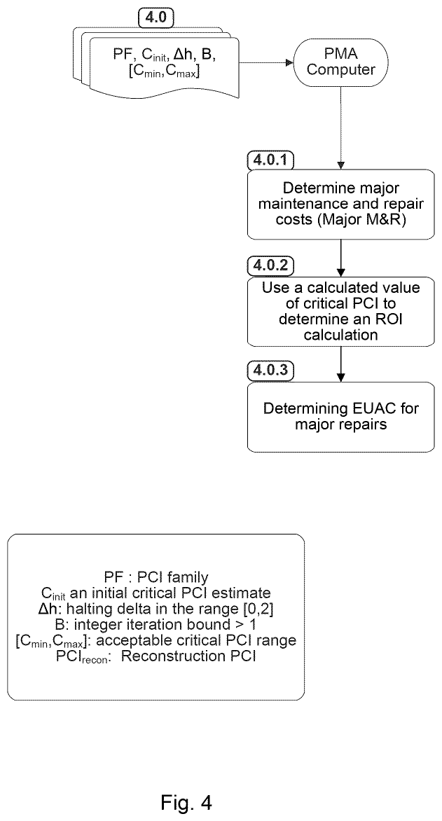

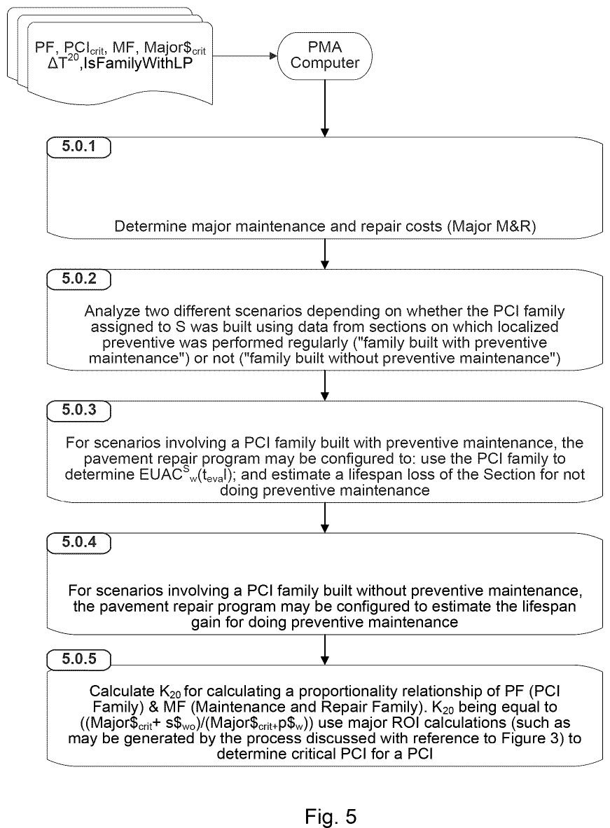

FIG. 3 is a flowchart for determining estimated uniform annual cost with and without major M&R at time tₑᵥₐₗ.

FIG. 4 is a flowchart detailing an algorithm for using major ROI calculation to determine critical PCI for a PCI family PF.

FIG. 5 is a flowchart for calculating the value of k₂₀ in the proportionality function P (PF, MF).

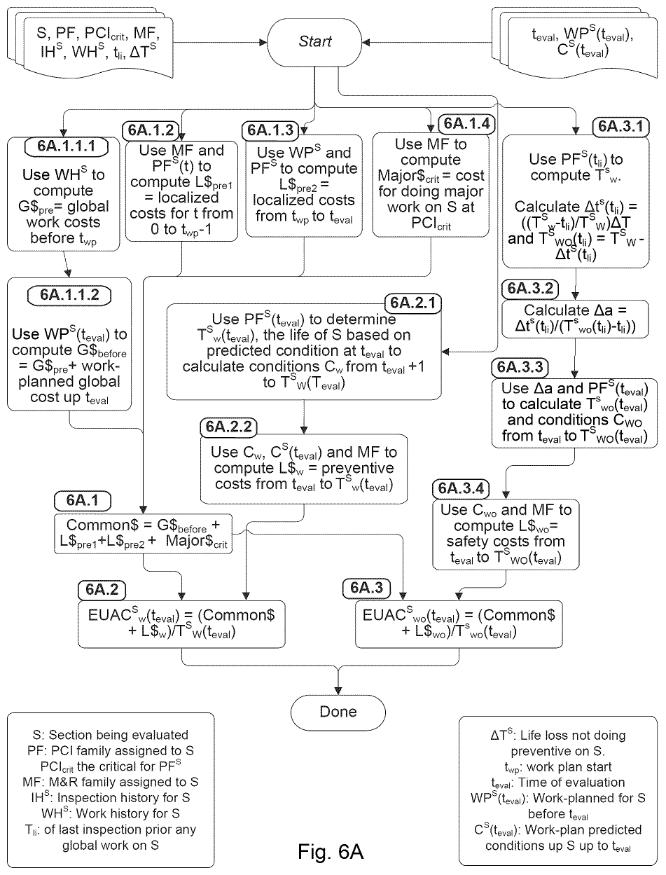

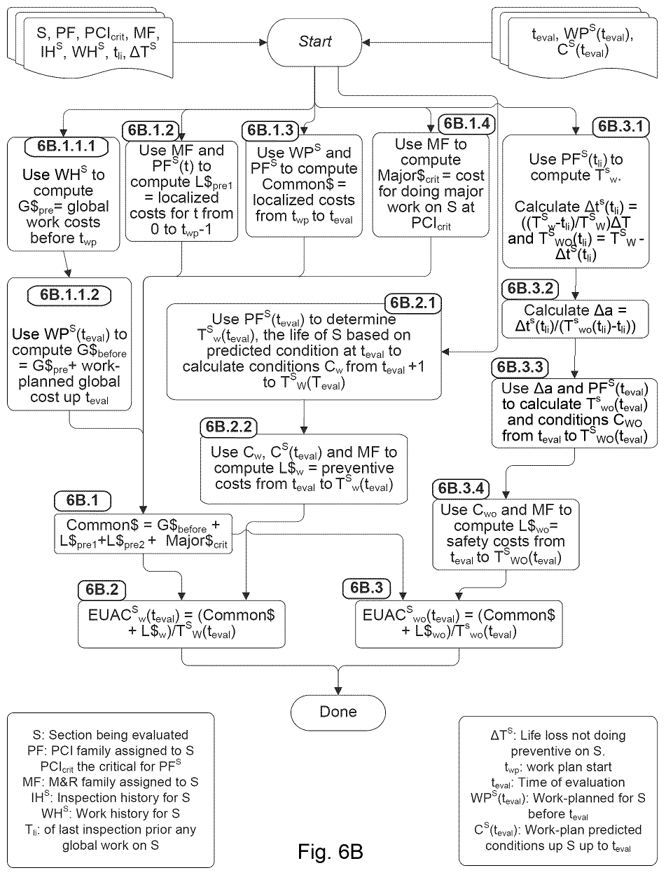

FIG. 6A is a flowchart for determining an estimated uniform annual cost for localized preventive M&R at tₑᵥₐₗ when the family is built with preventive to compute the ROI for continuing to do preventive work at tₑᵥₐₗ.

FIG. 6B is a flowchart for determining an estimated uniform annual cost for localized preventive M&R at tₑᵥₐₗ when the family is built with preventive to compute the ROI for starting to do preventive work at tₑᵥₐₗ.

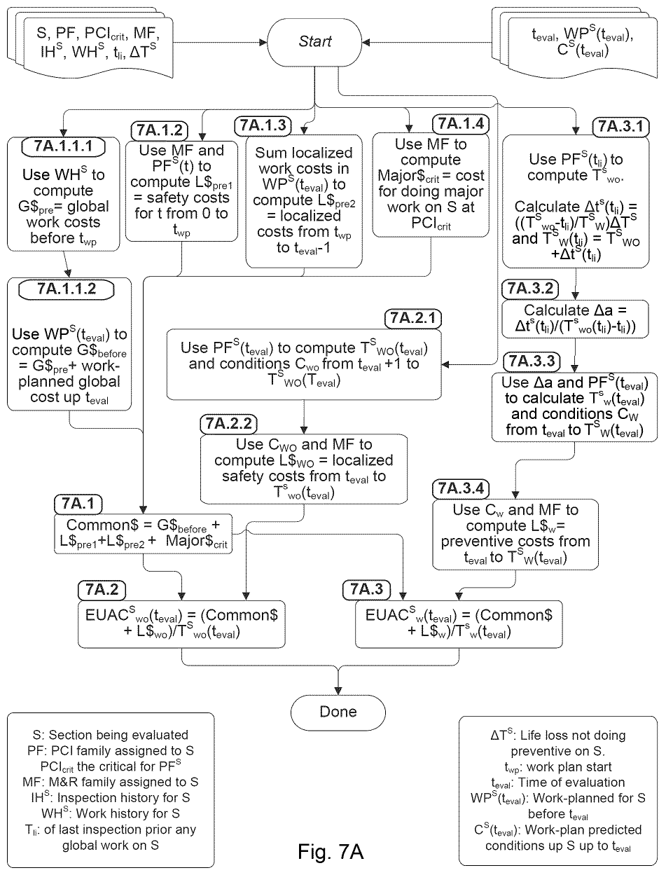

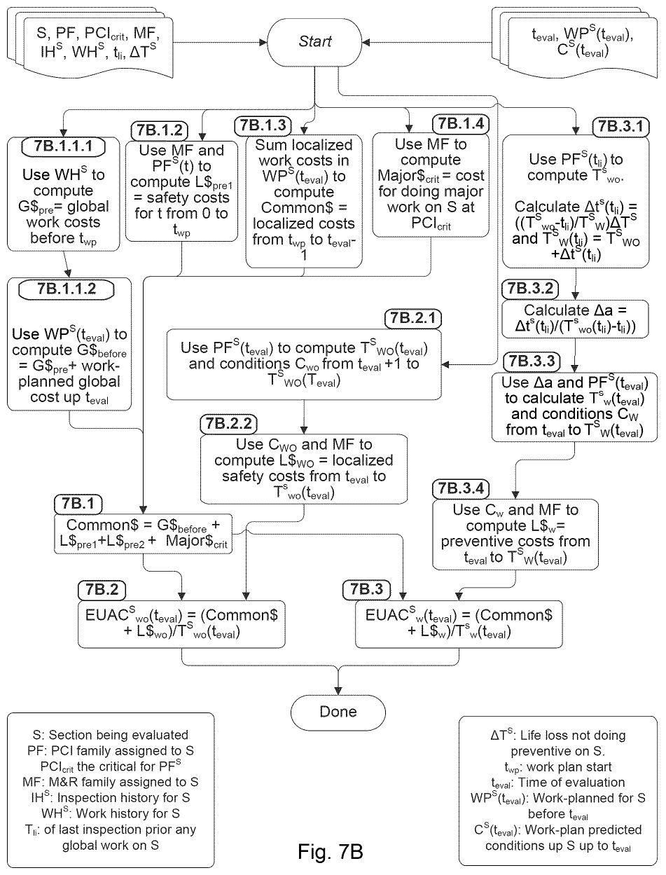

FIG. 7A is a flowchart for determining estimated uniform annual cost for localized preventive M&R at tₑᵥₐₗ when the family is built without preventive to compute the ROI for continuing to do preventive work at tₑᵥₐₗ.

FIG. 7B is a flowchart for determining estimated uniform annual cost for localized preventive M&R at tₑᵥₐₗ when the family is built without preventive to compute the ROI for starting to do preventive work at tₑᵥₐₗ.

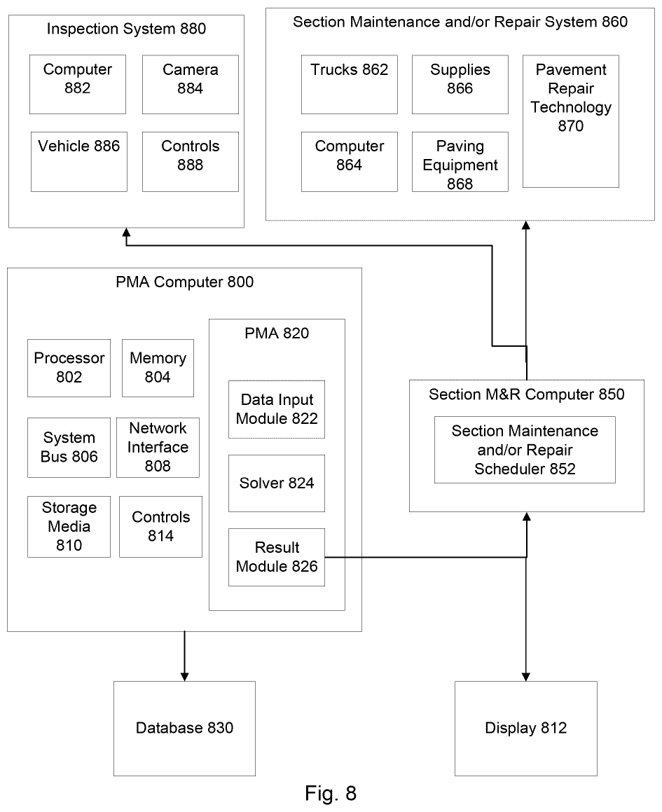

FIG. 8 shows a schematic view of the pavement management application (PMA) computer section M&R computer, inspection system and section maintenance and/or repair system.

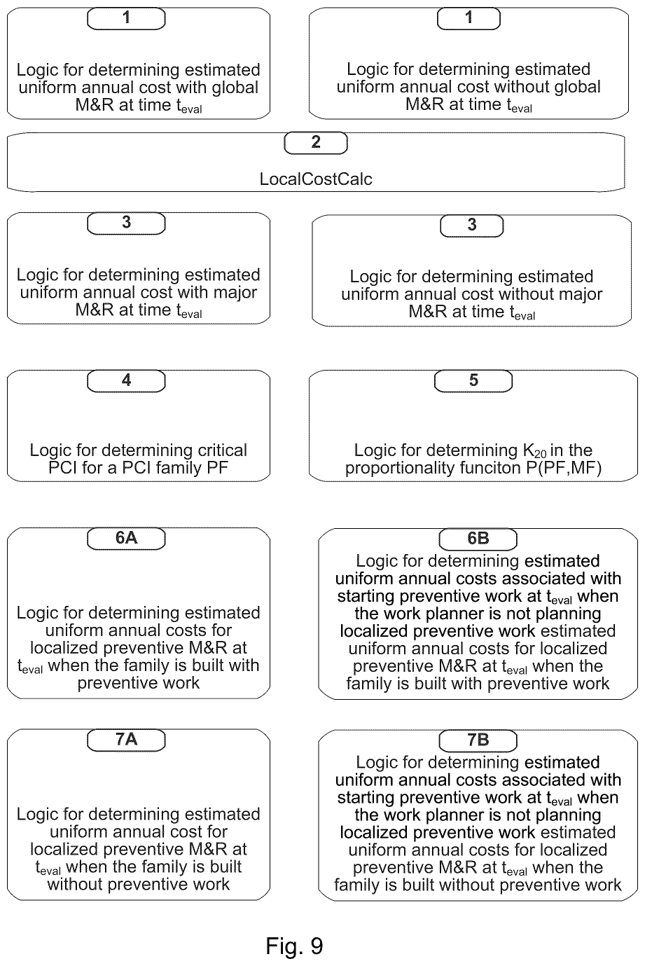

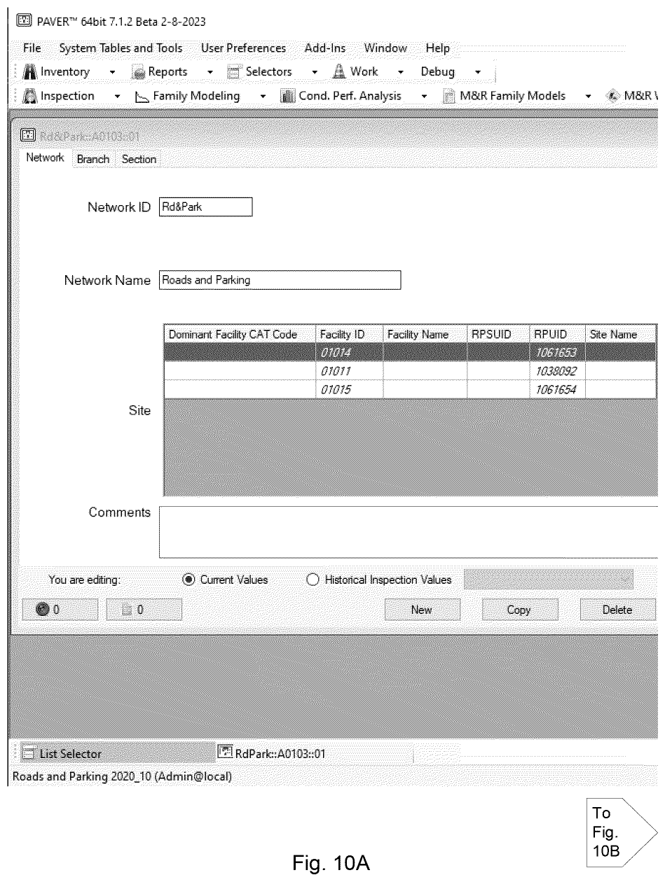

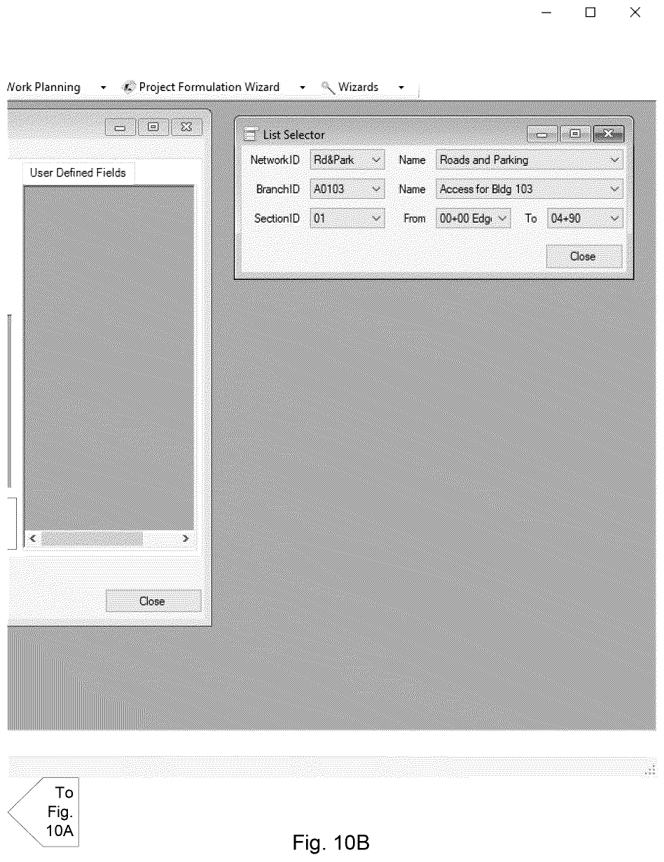

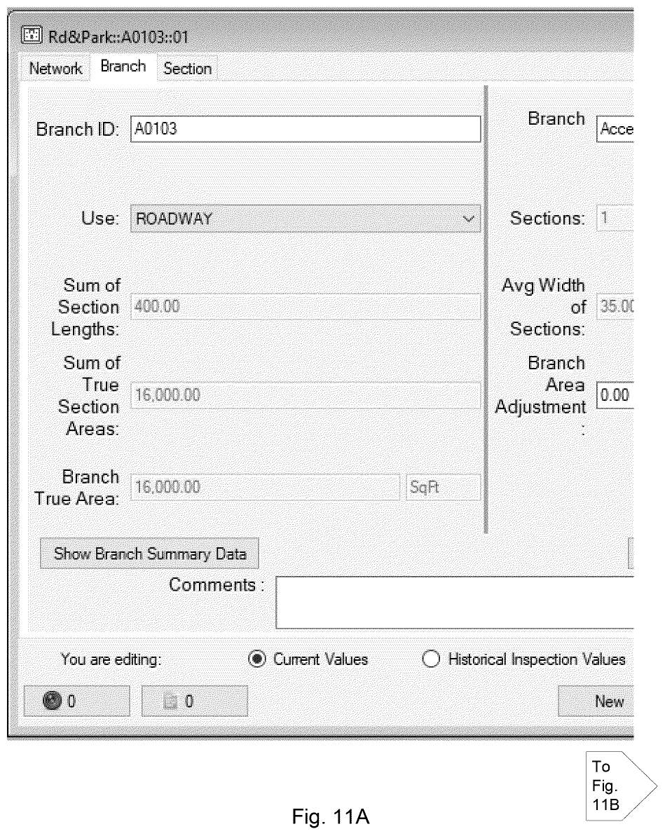

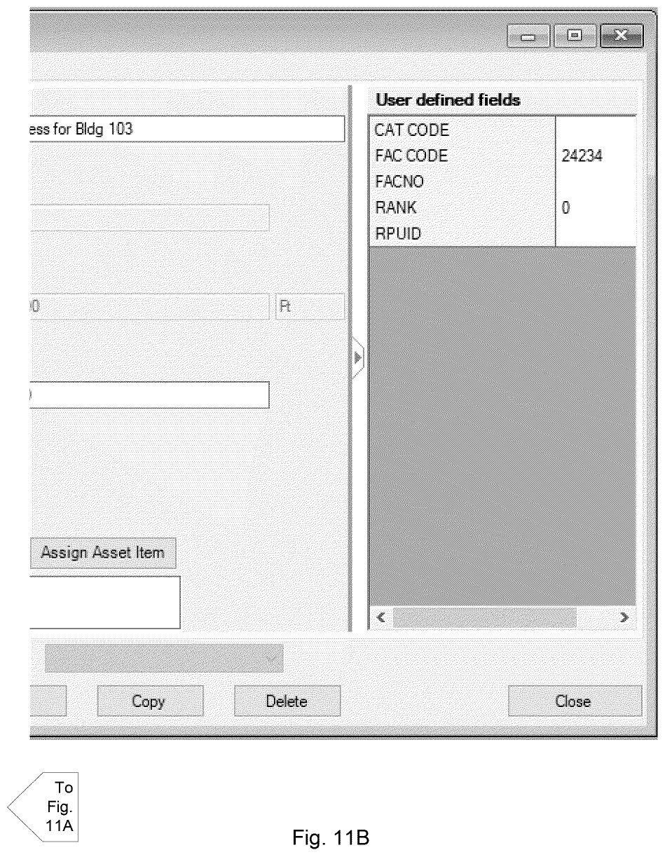

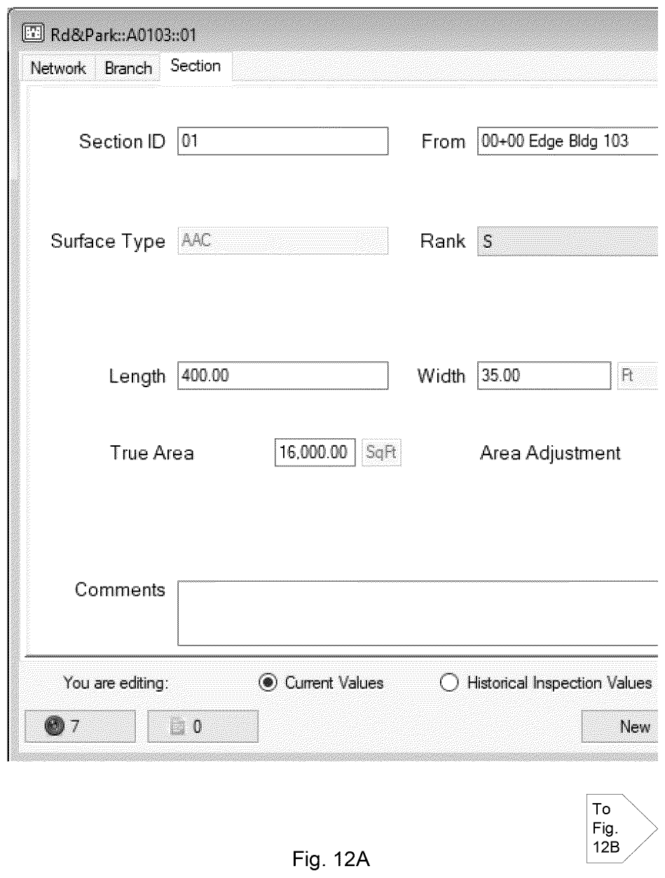

FIG. 9 shows an overall view of various algorithms that pavement management application (PMA) may be programmed to execute.

FIGS. 10A-10B shows an inventory window in the pavement management application (PMA).

FIGS. 11A-11B show the inventory window of the branch tab, the branch tab may show branch properties.

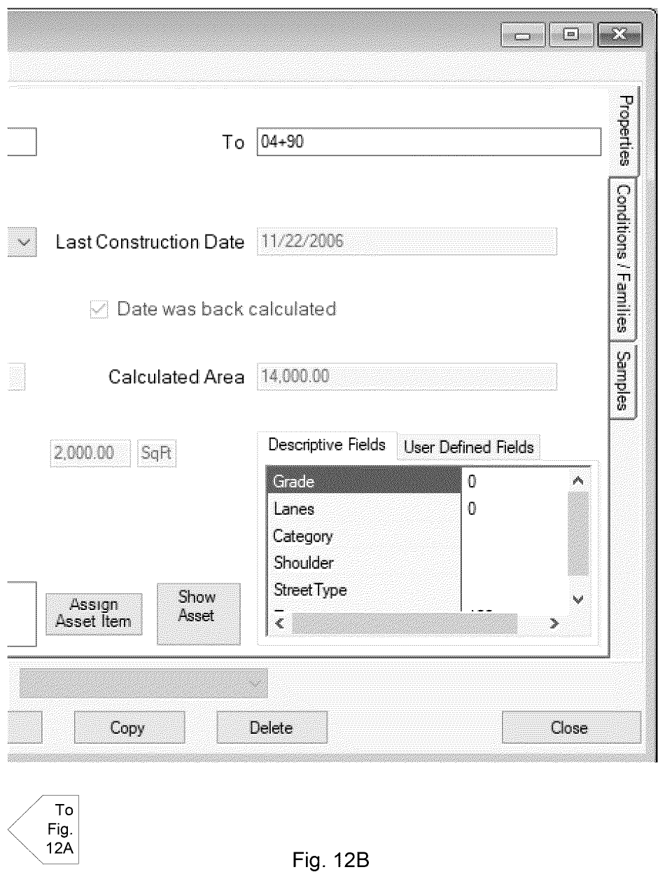

FIGS. 12A-12B shows the inventory window of the section tab.

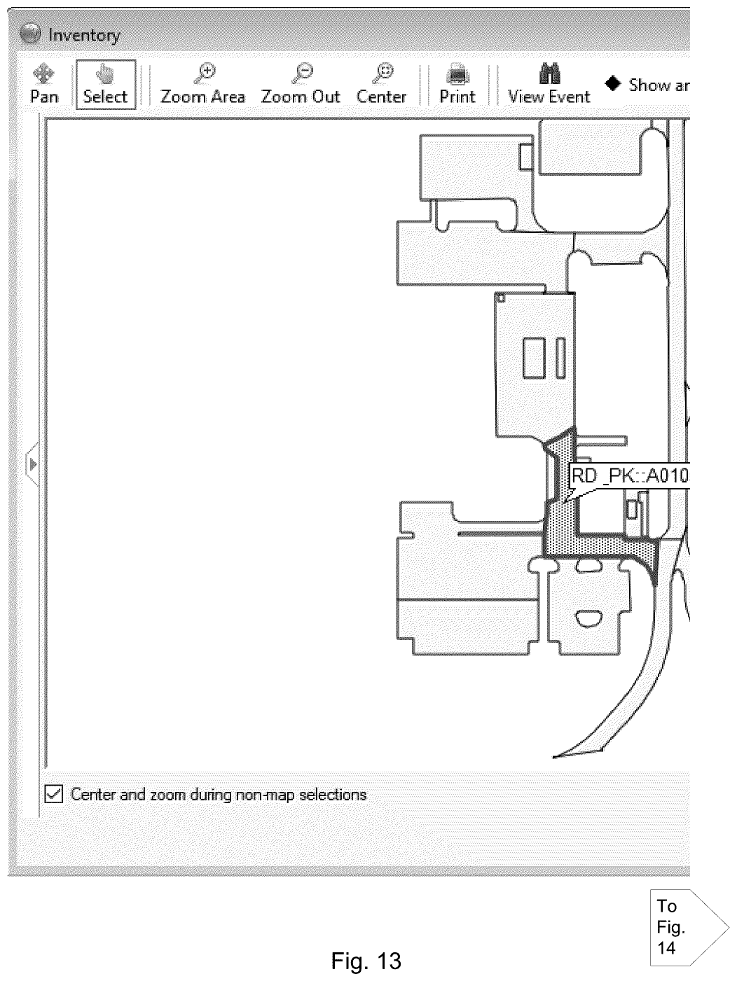

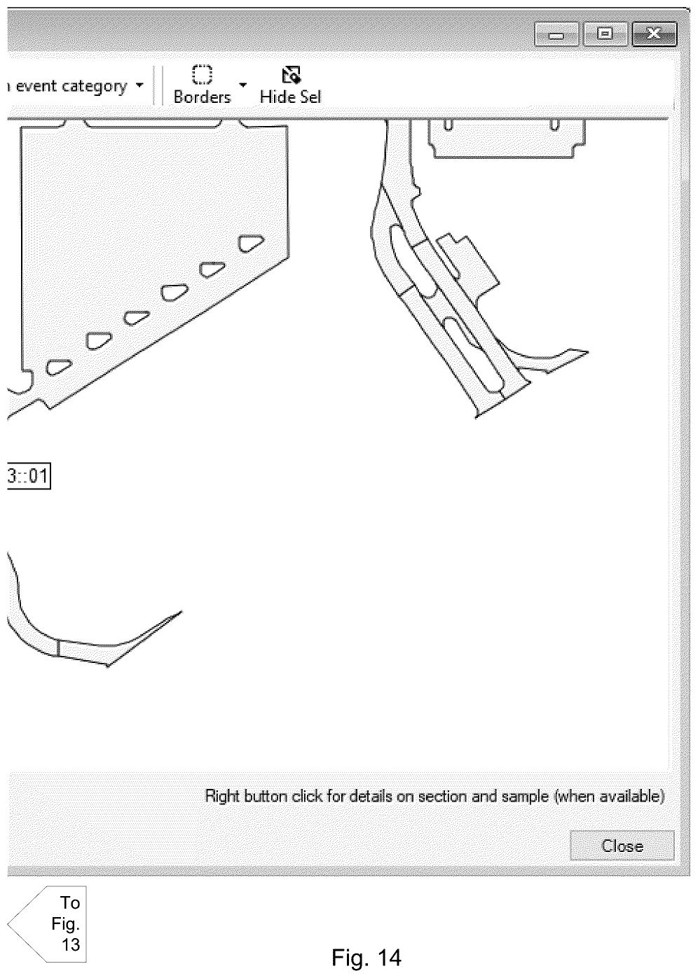

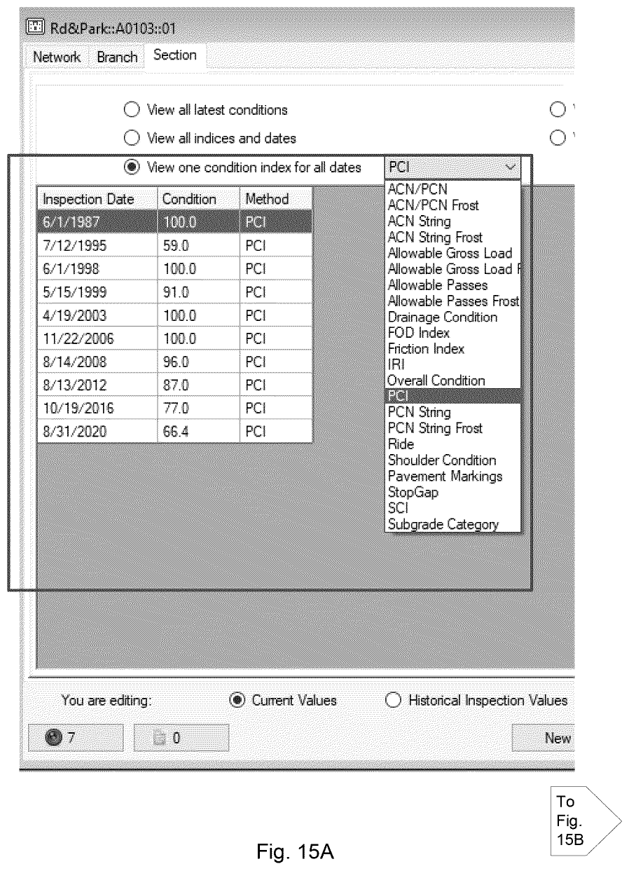

FIGS. 13-14 shows a window of GIS maps. GIS Maps can be used to give context to the inventory. FIGS. 13-14 show a current selection section.

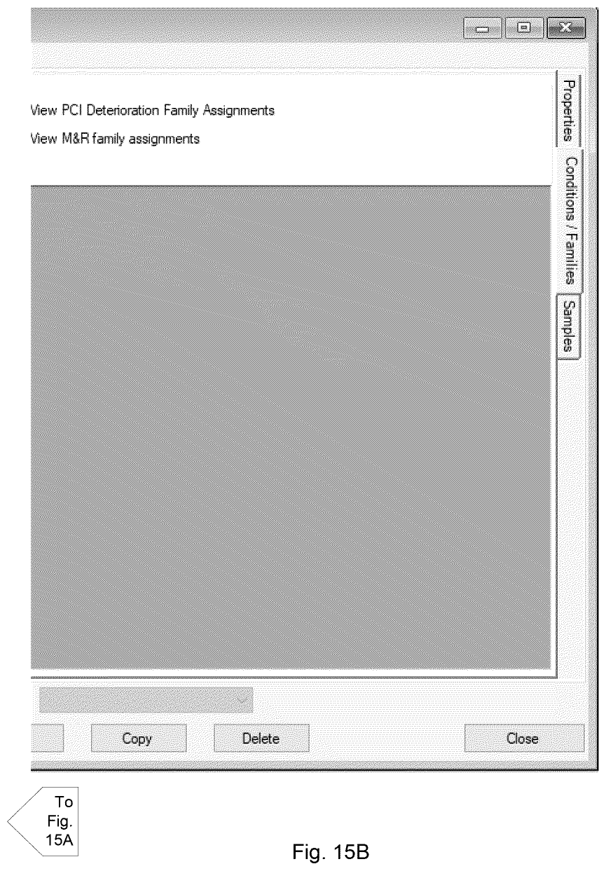

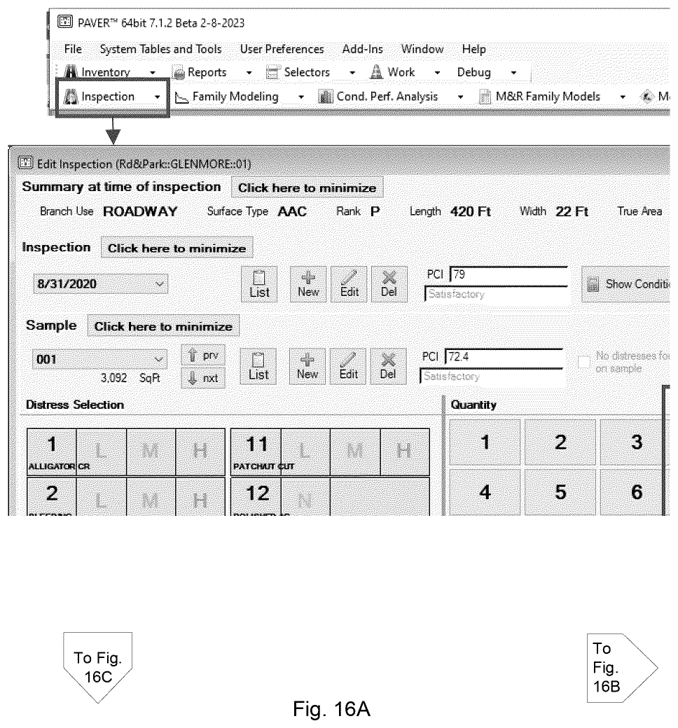

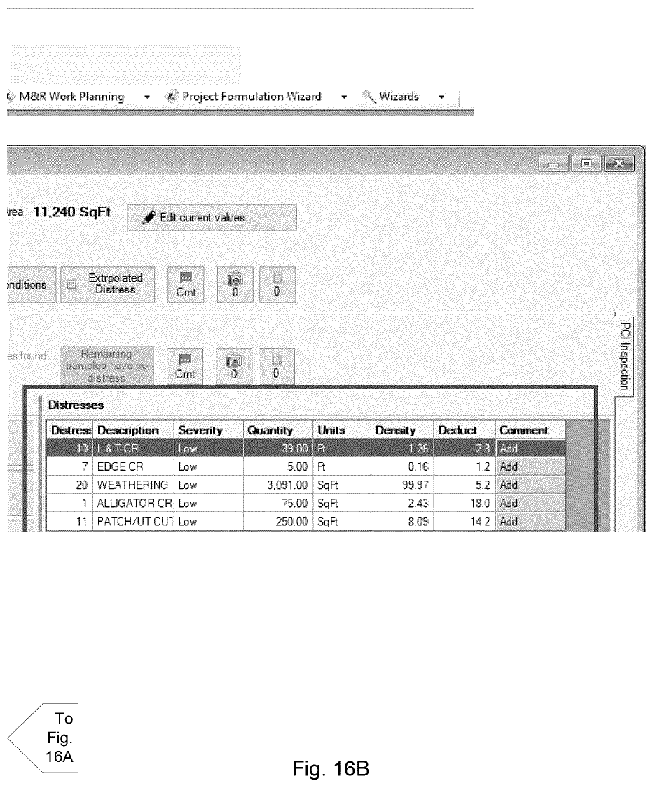

FIGS. 15A-15B shows the inventory window with the conditions/families tab selected and the view M&R family assignments radial selector selected. The box indicates M&R families (MF) assigned to this section.

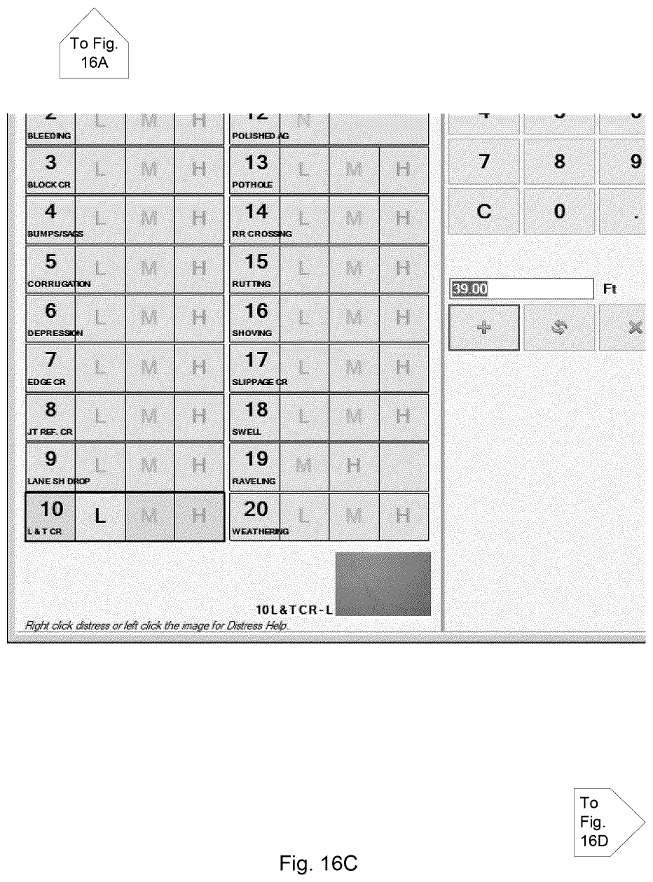

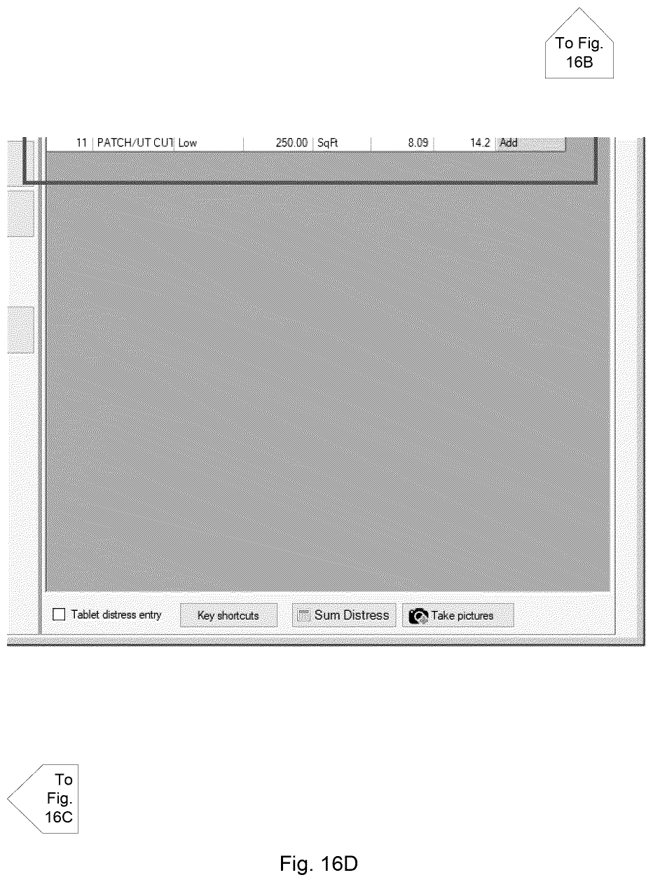

FIGS. 16A-16D shows an inspection window of the inspection submenu.

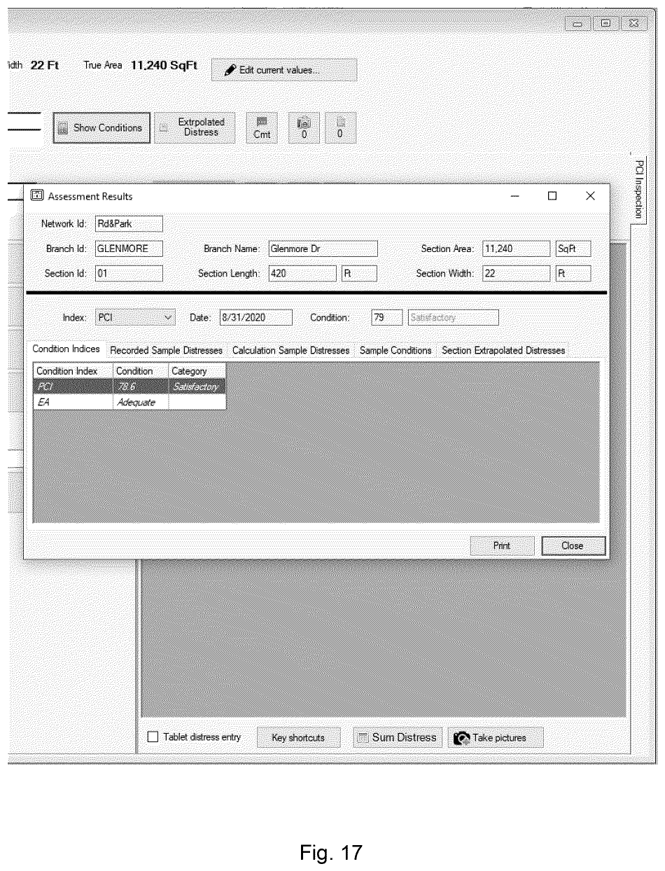

FIG. 17 shows a window called or displayed when the show conditions button is clicked.

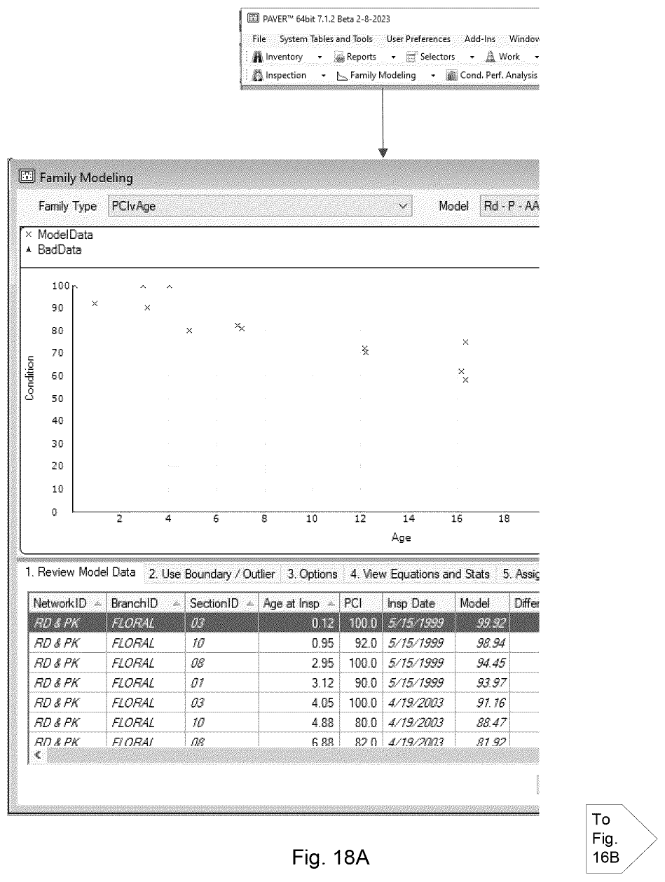

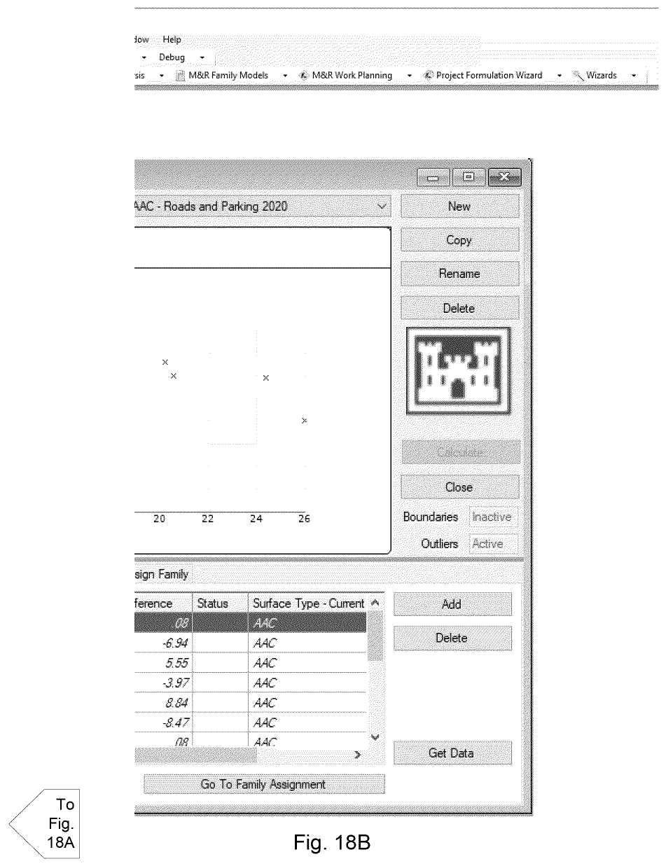

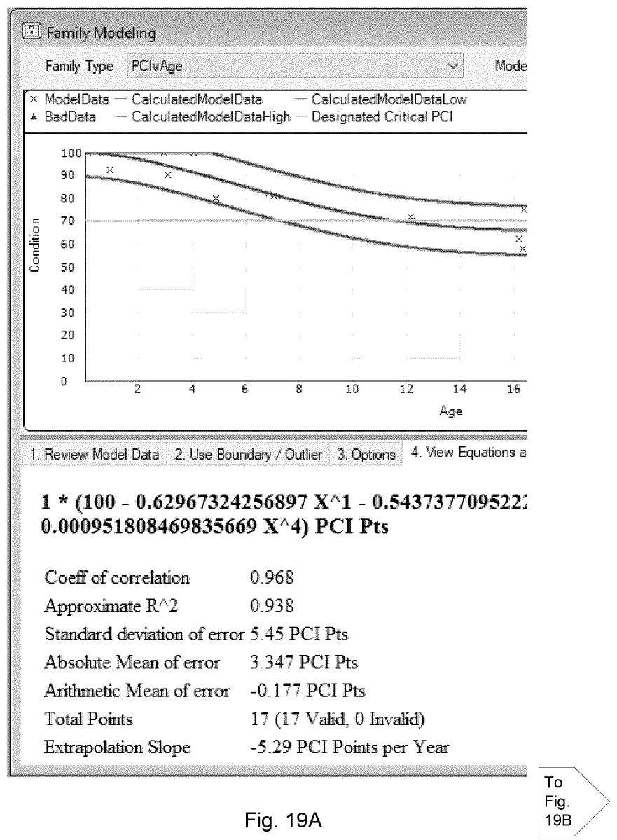

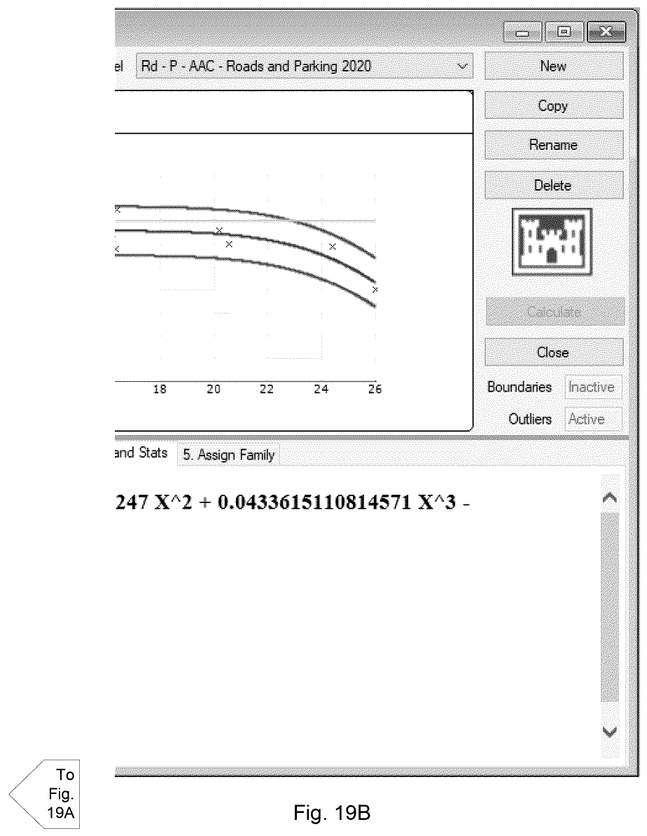

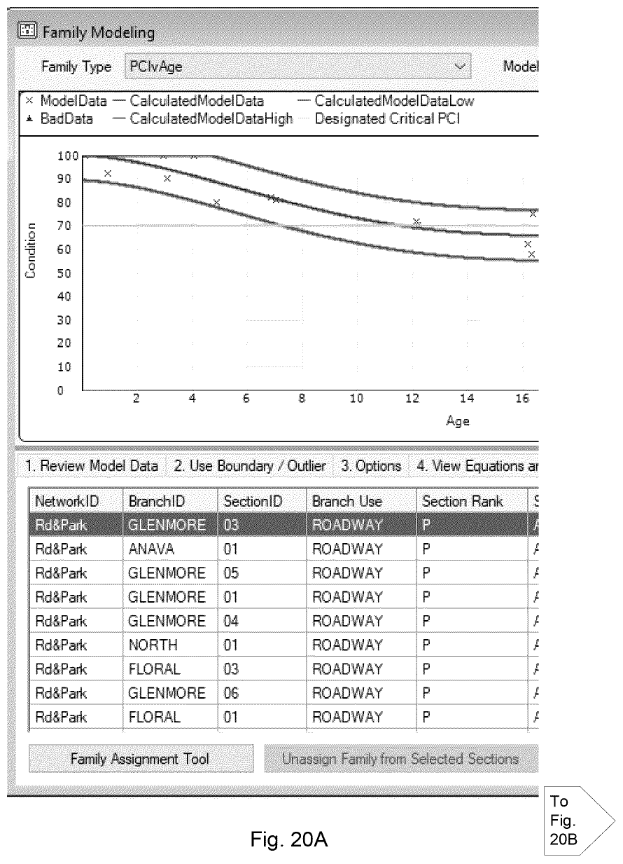

FIGS. 18A and 18B show a PCI Family Models (PF) window.

FIGS. 19A and 19B show the PCI family model window with the view equations and stats tab selected.

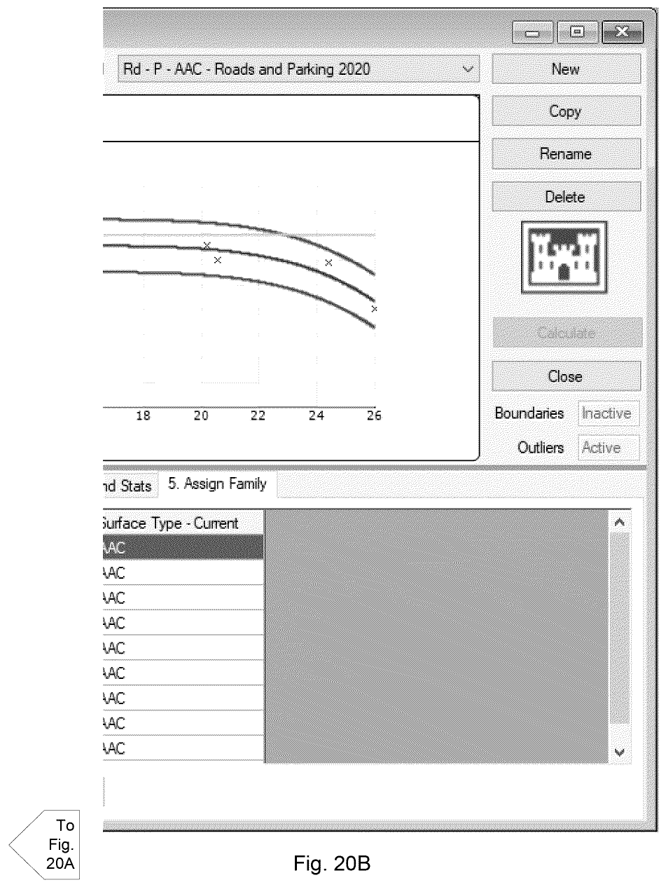

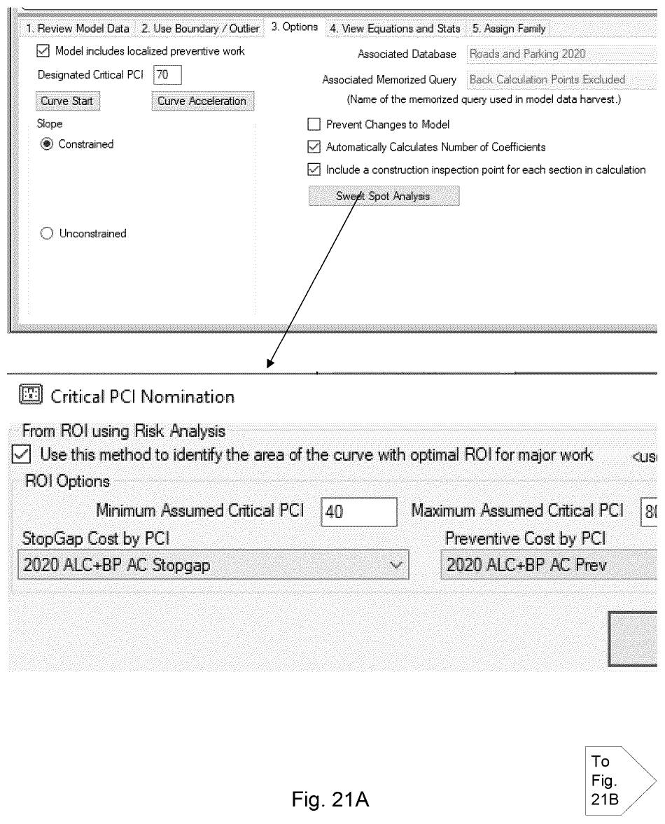

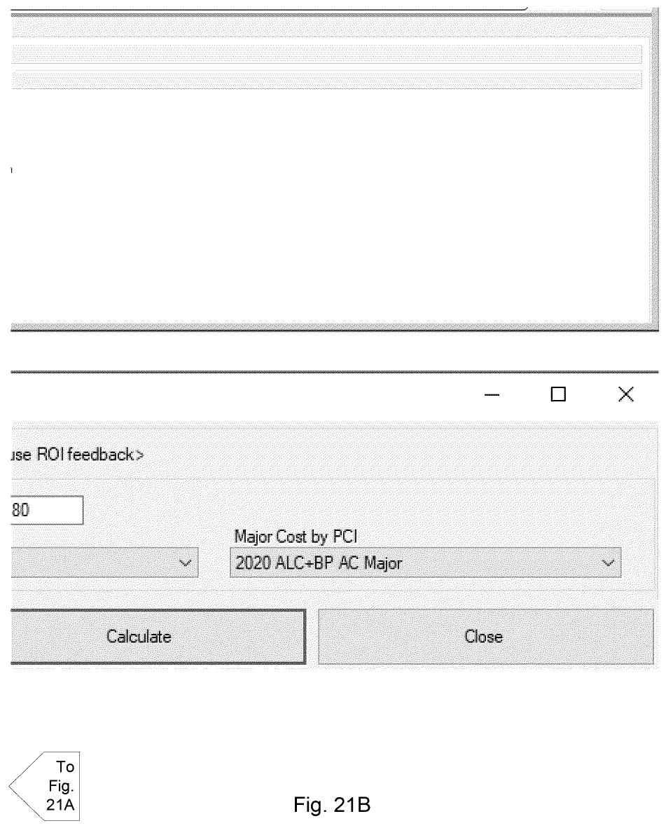

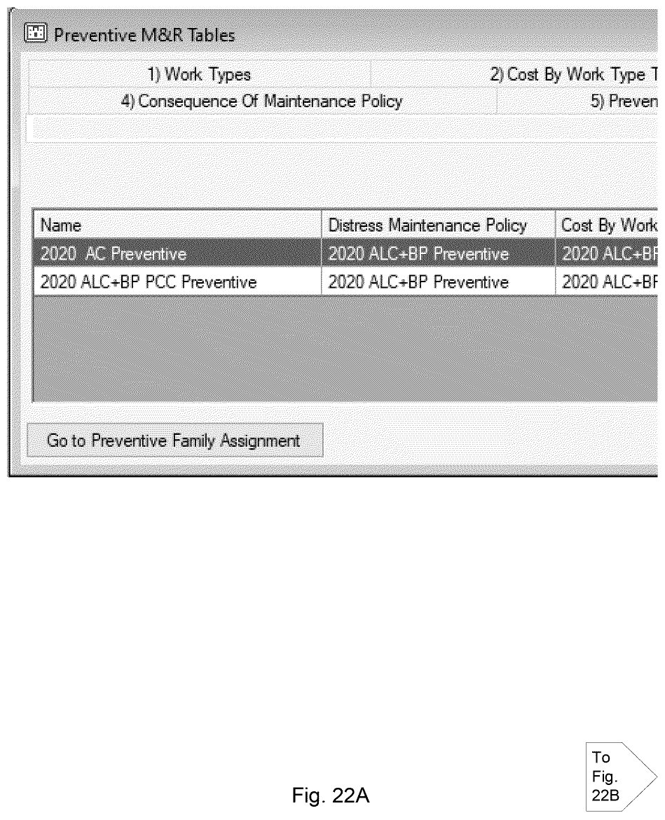

FIGS. 20A and 20B show the PCI family model window with the Assign Family tab selected.

FIGS. 21A and 21B show the PCI family model window with the Assign Family tab selected, but the top graph is not shown for illustration purposes.

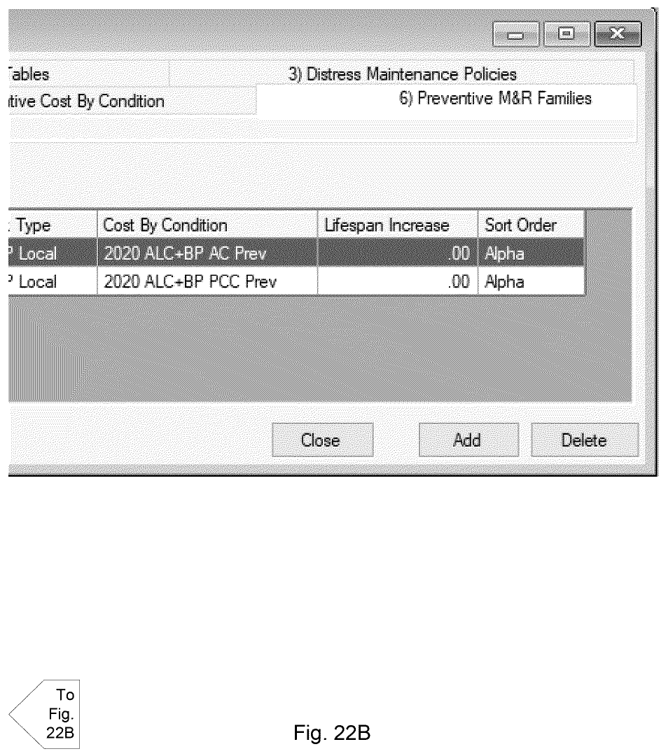

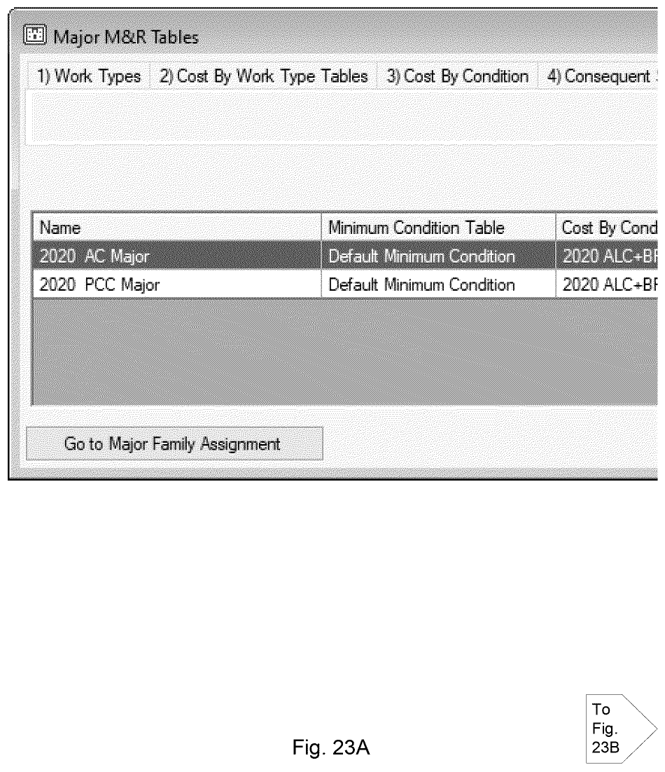

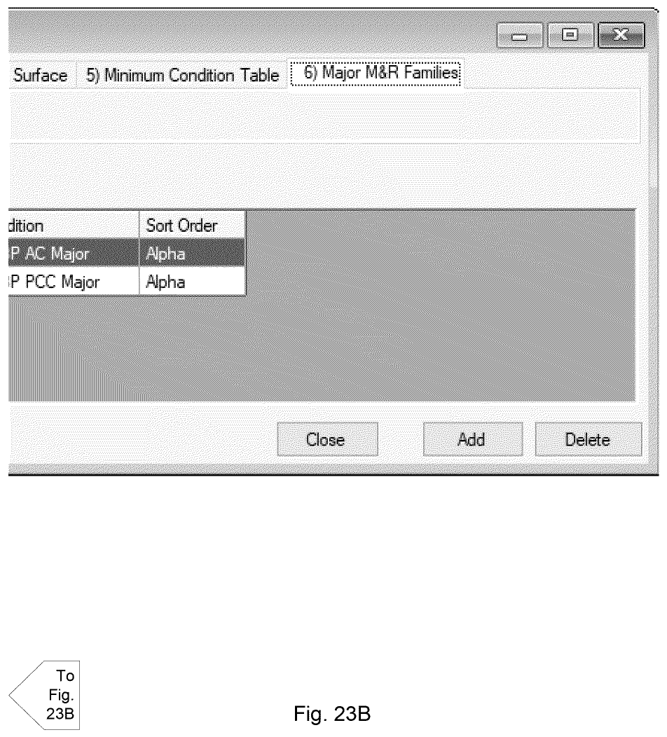

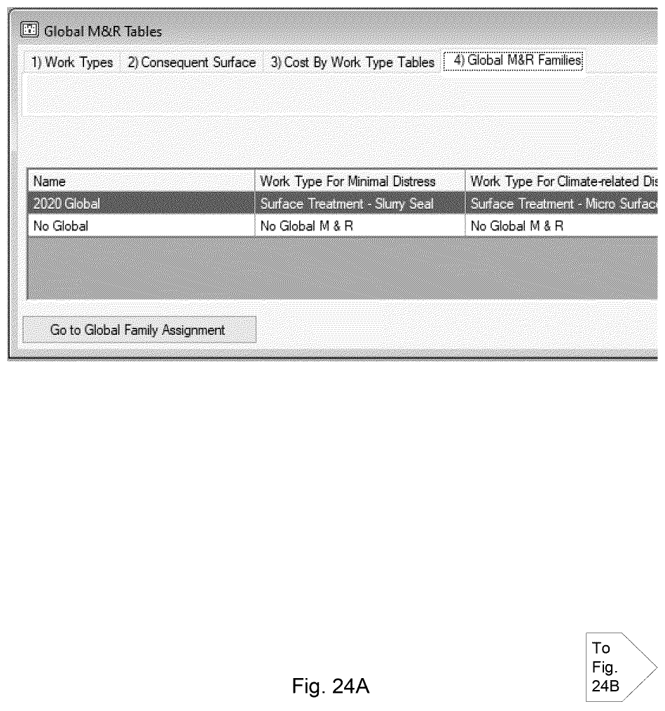

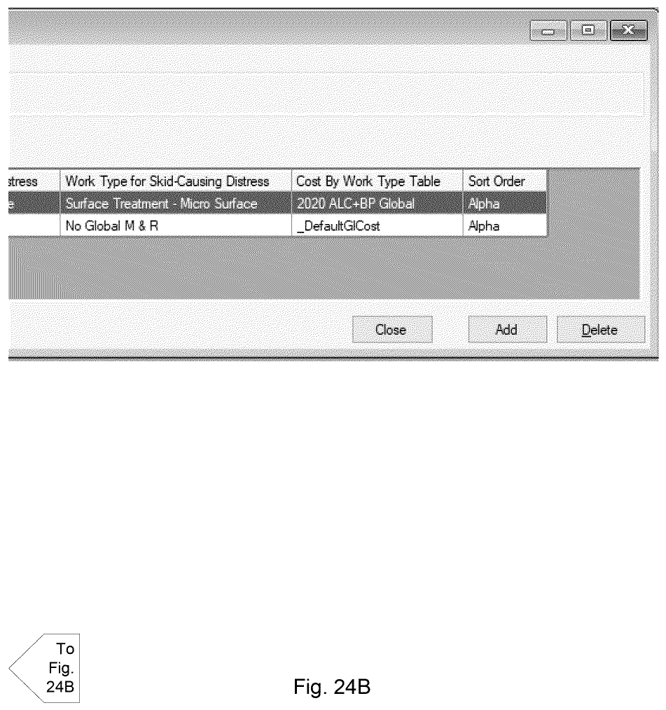

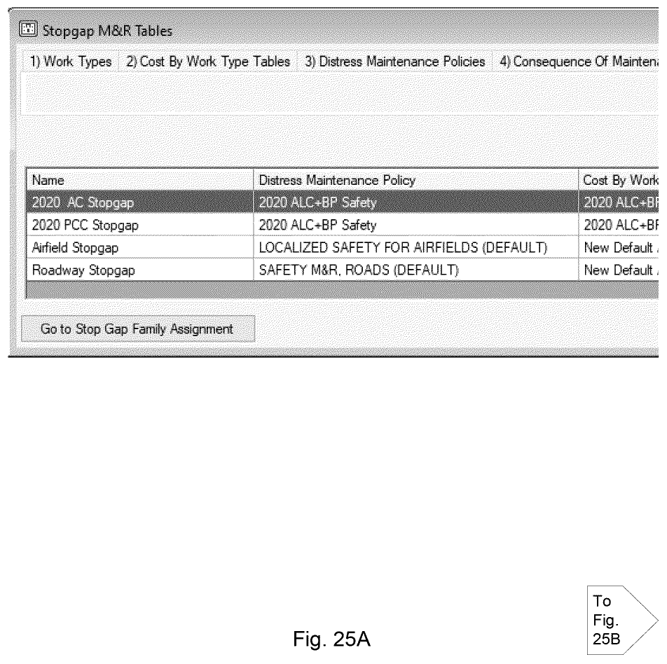

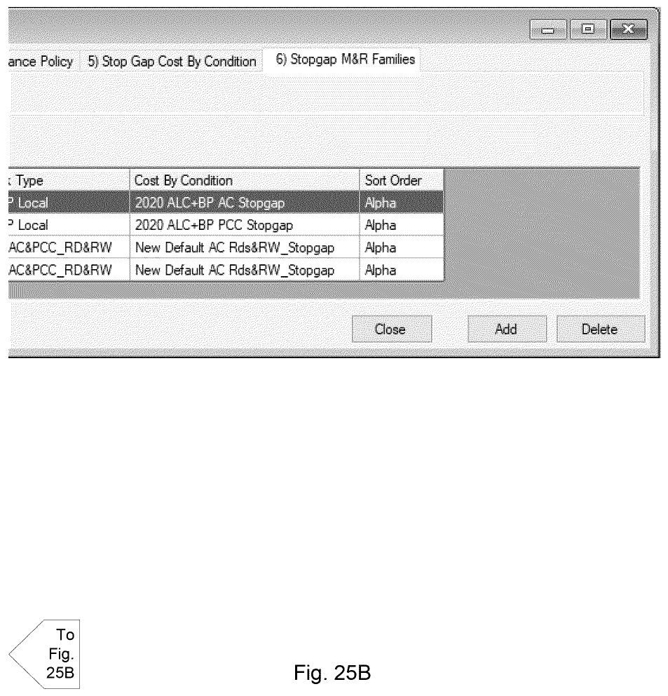

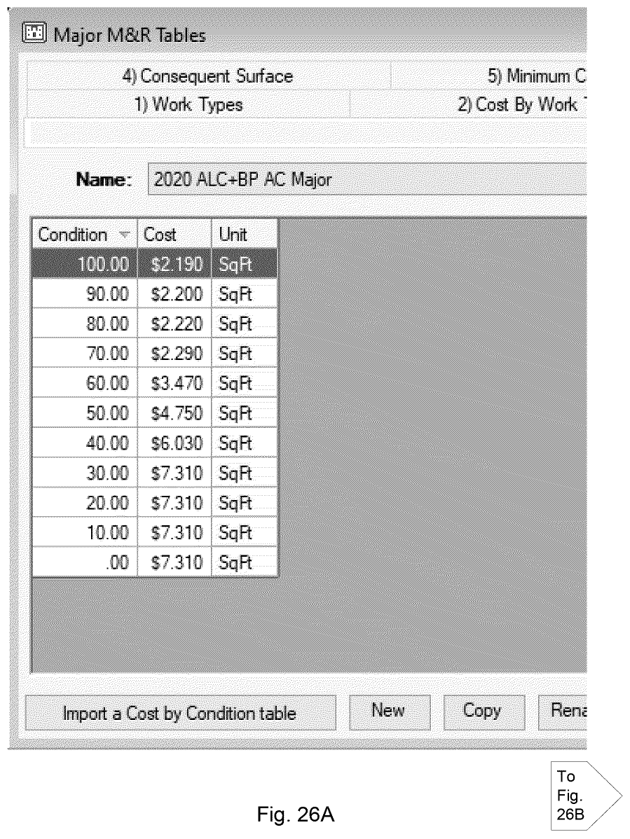

FIGS. 22A-22B, 23A-23B, 24A-24B, 25A-25B show examples of M&R Family windows.

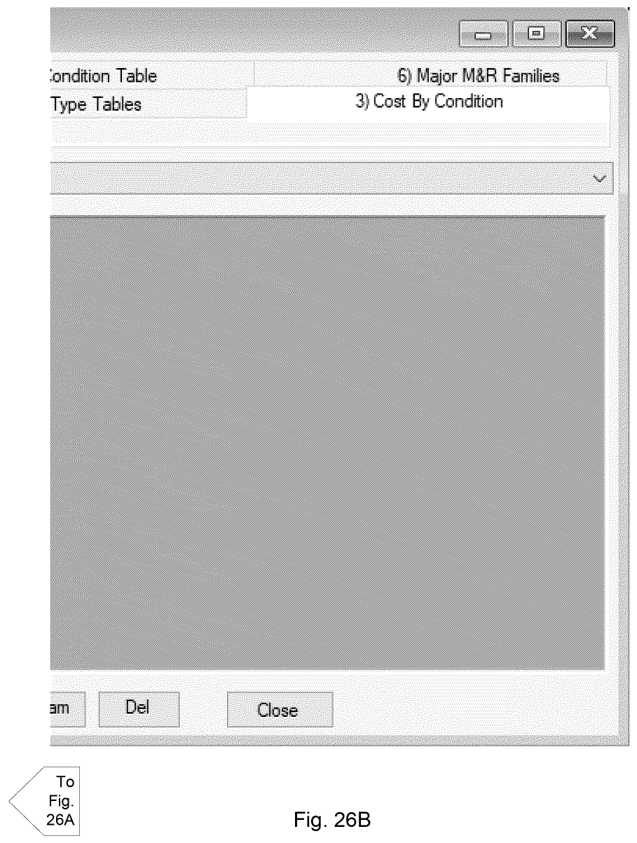

FIGS. 26A and 26B show a major M&R cost table window.

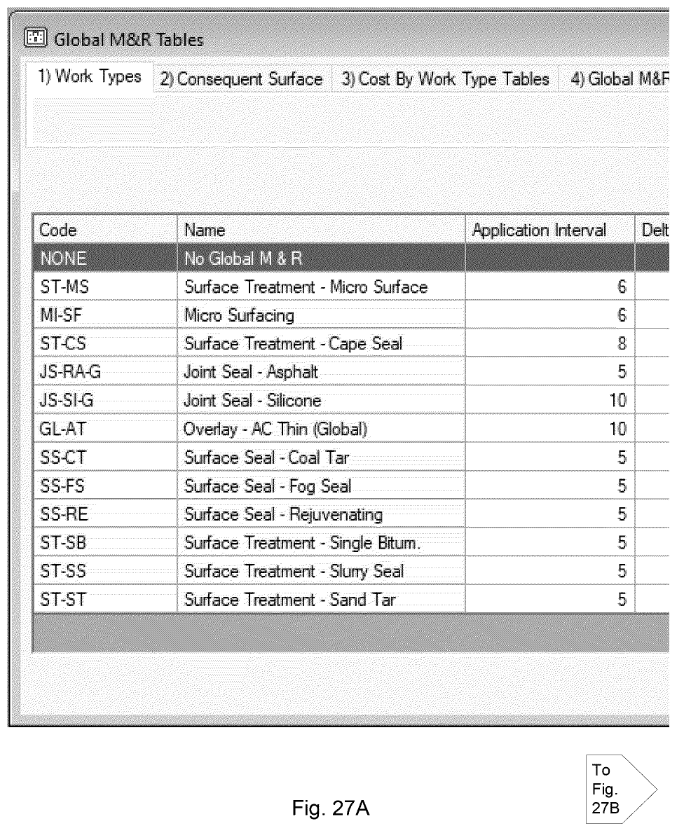

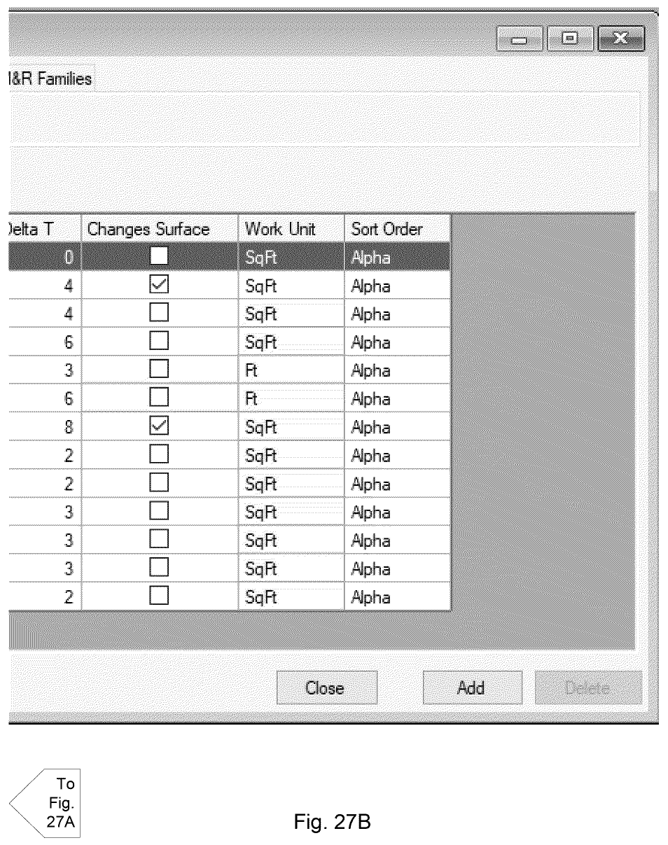

FIGS. 27A and 27B show a global M&R work type window.

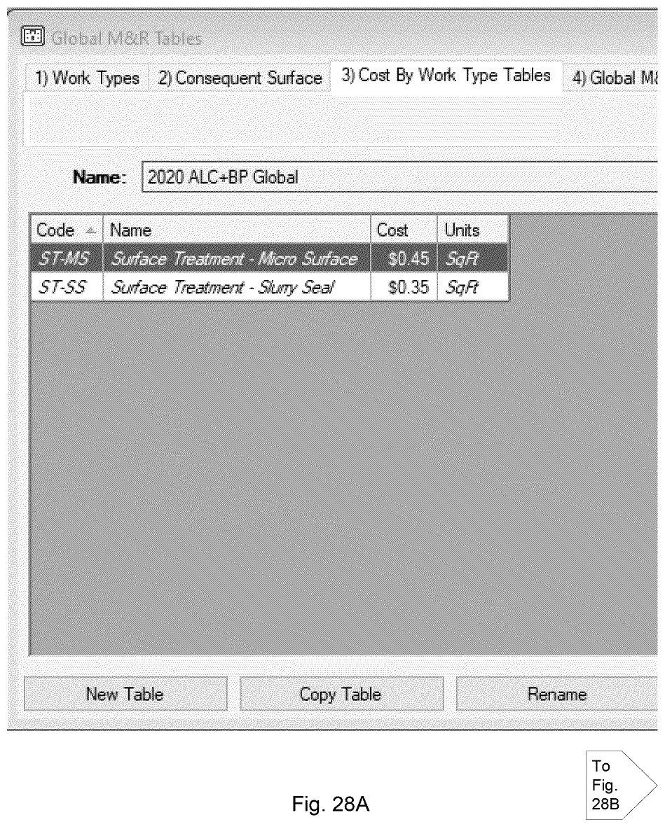

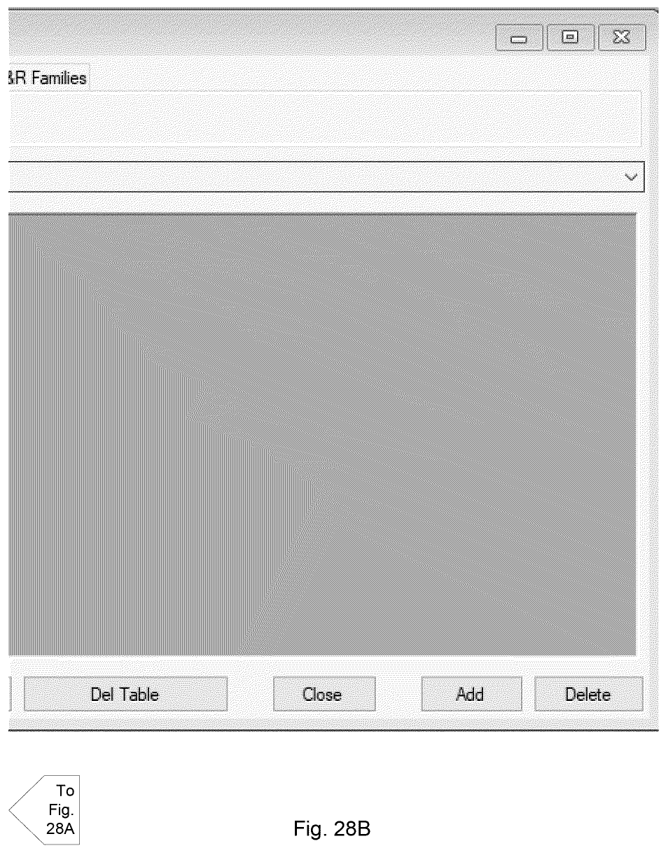

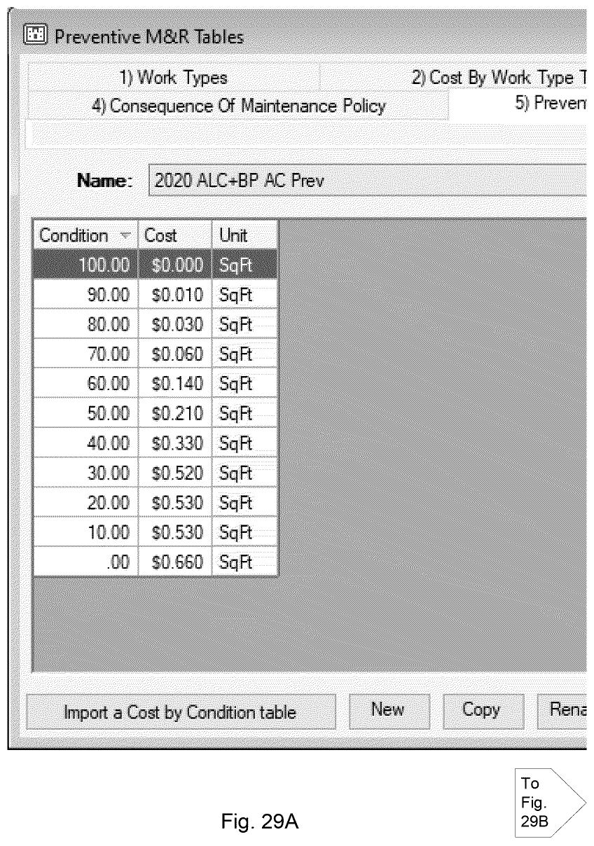

FIGS. 28A and 28B show a global work is priced by work types instead of condition.

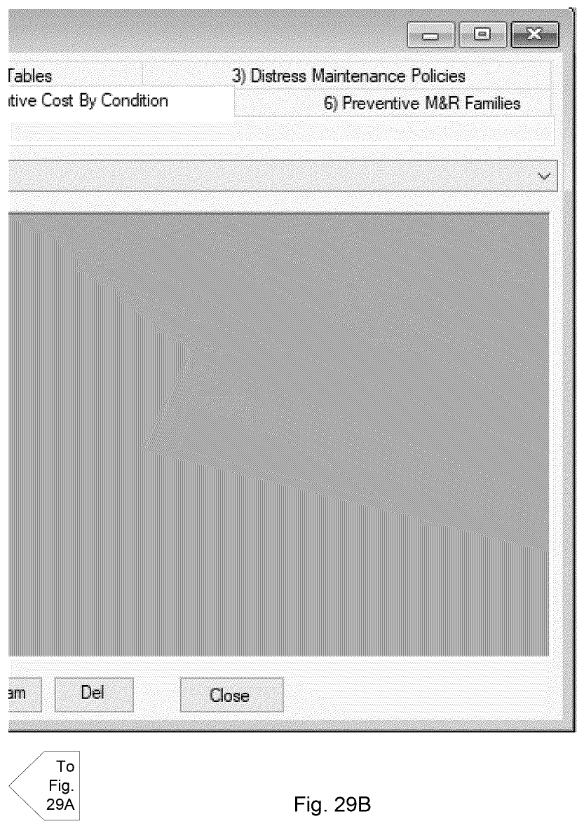

FIGS. 29A-29B shows a window for preventative cost by condition.

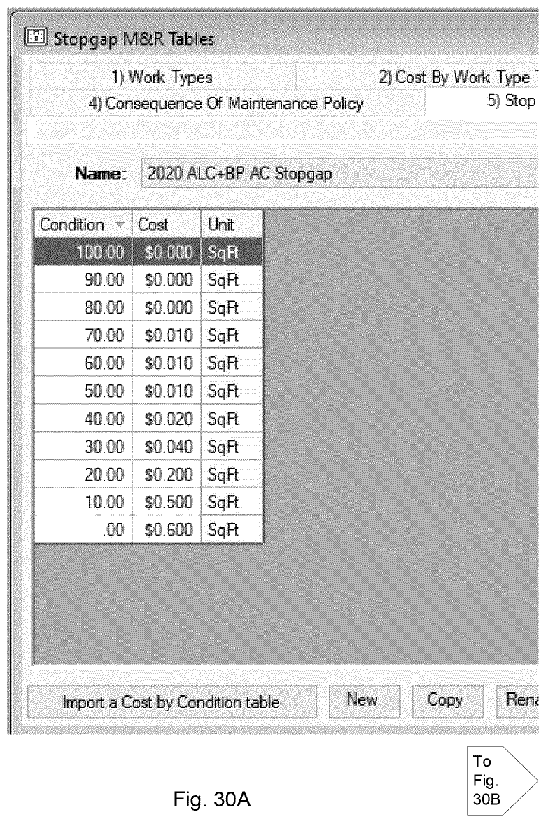

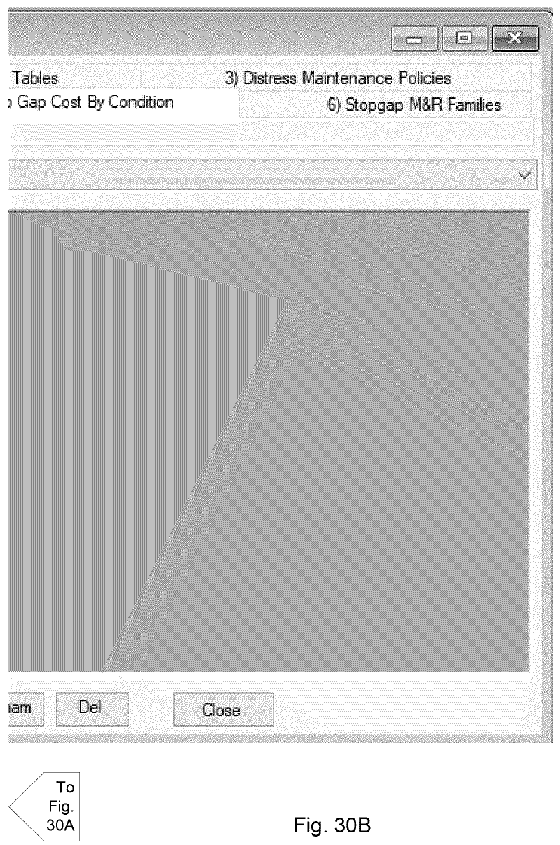

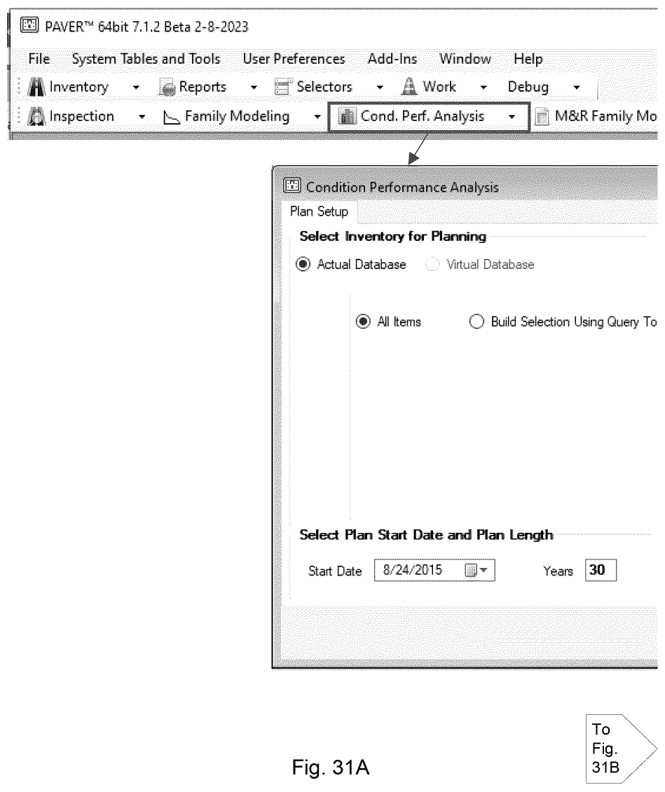

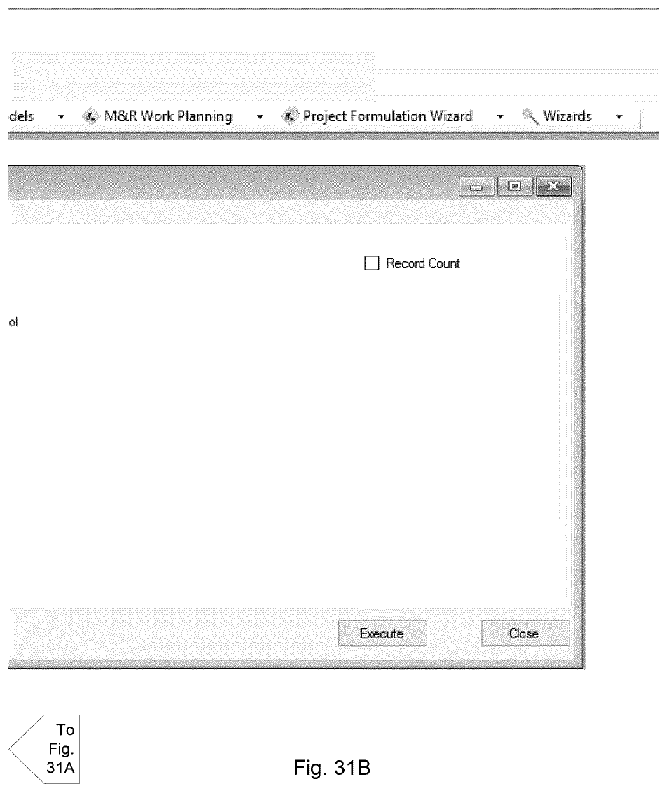

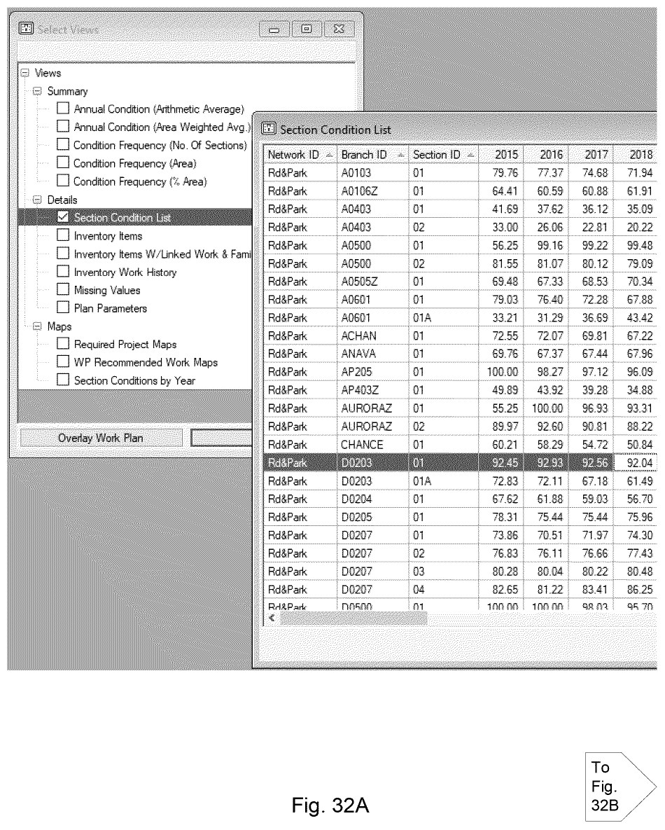

FIGS. 30A-30B shows a window for stopgap cost by condition.

FIGS. 31A-31B shows a condition performance analysis window.

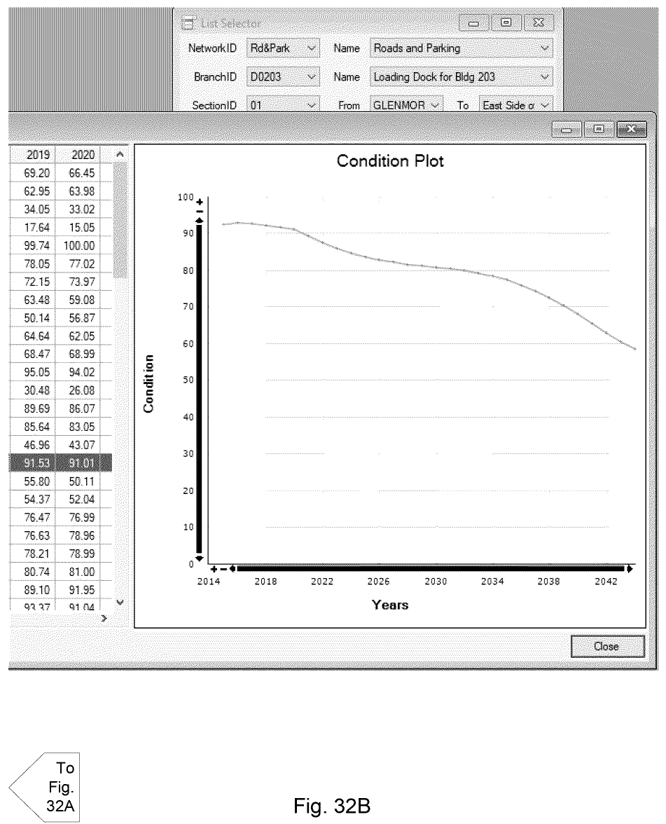

FIGS. 32A-32B shows a section condition list associated with the condition performance analysis window.

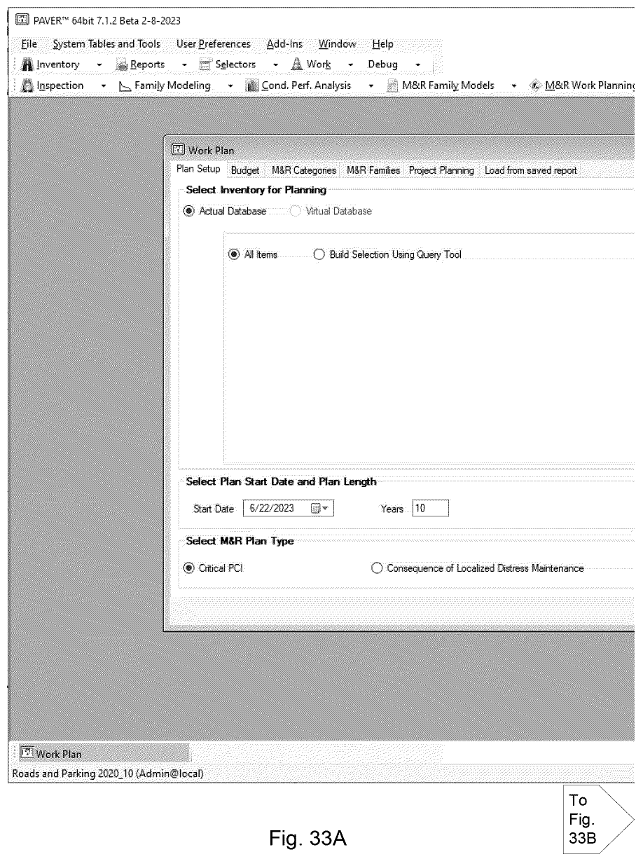

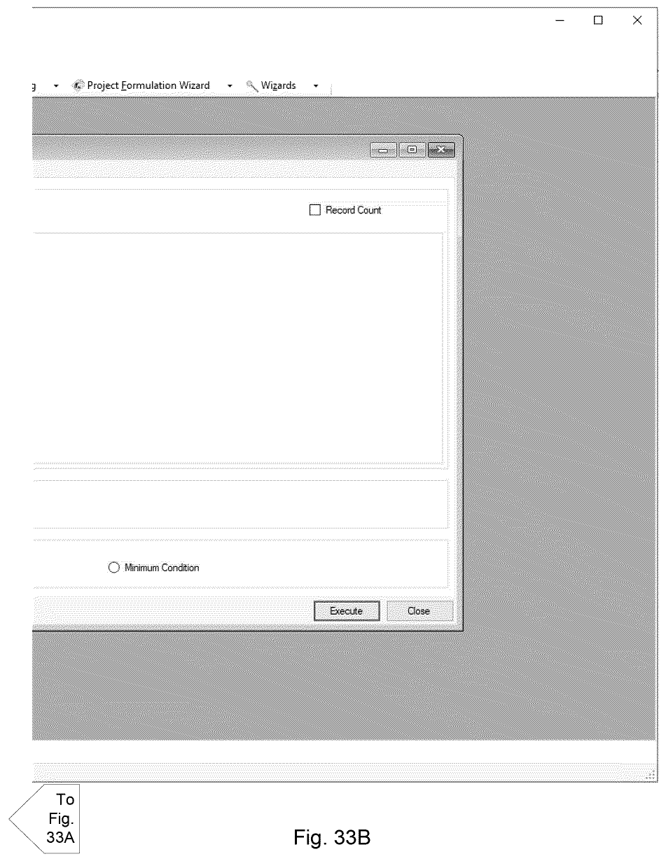

FIGS. 33A-33B shows a work plan analysis window.

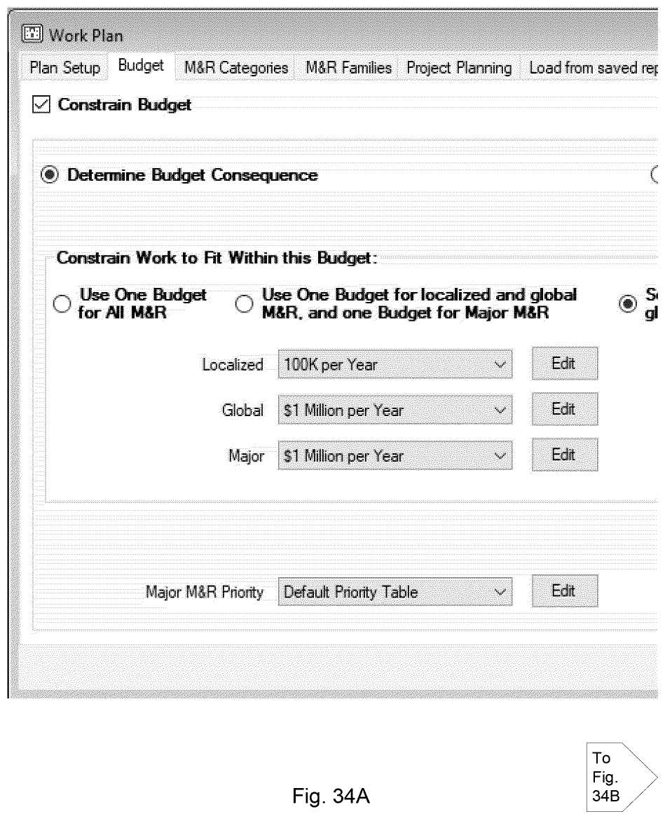

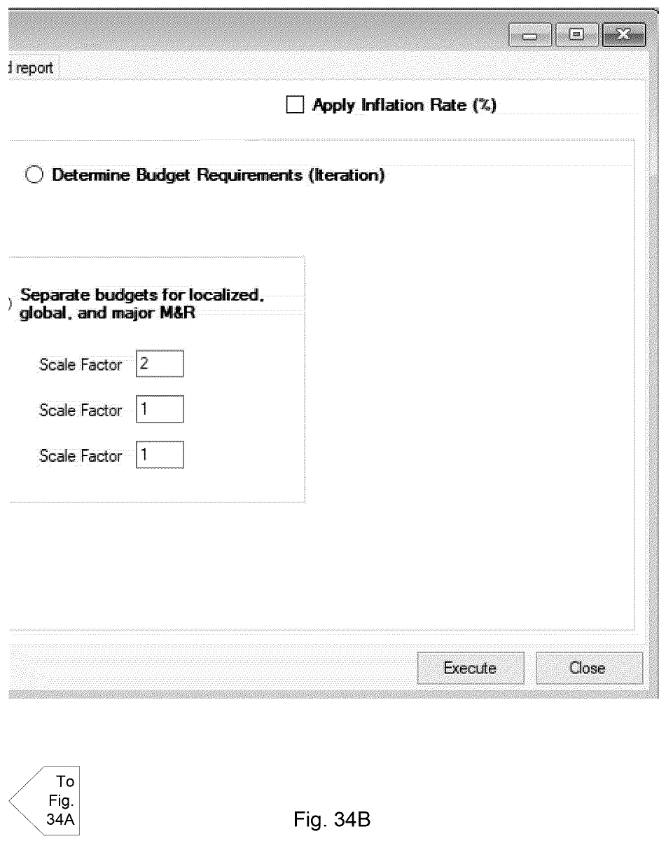

FIGS. 34A-34B shows a work plan analysis window with a budget tab selected.

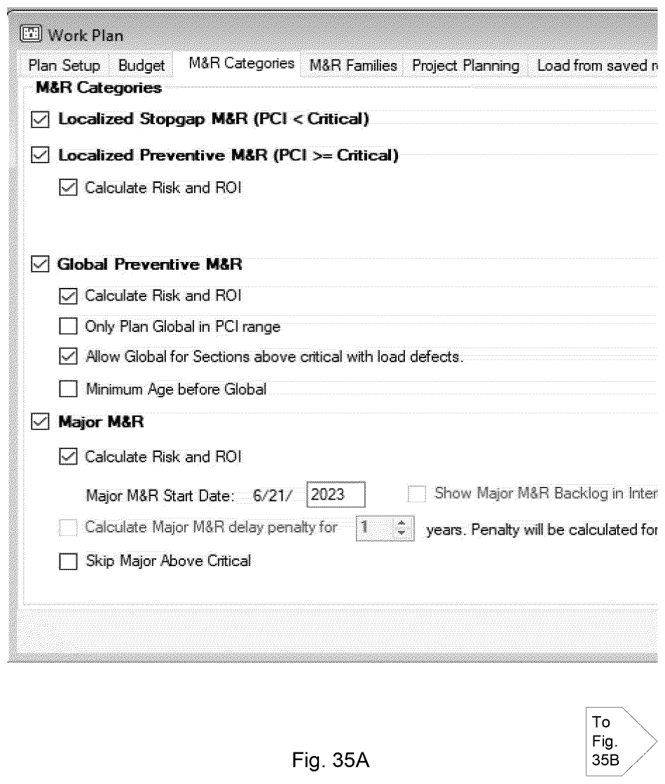

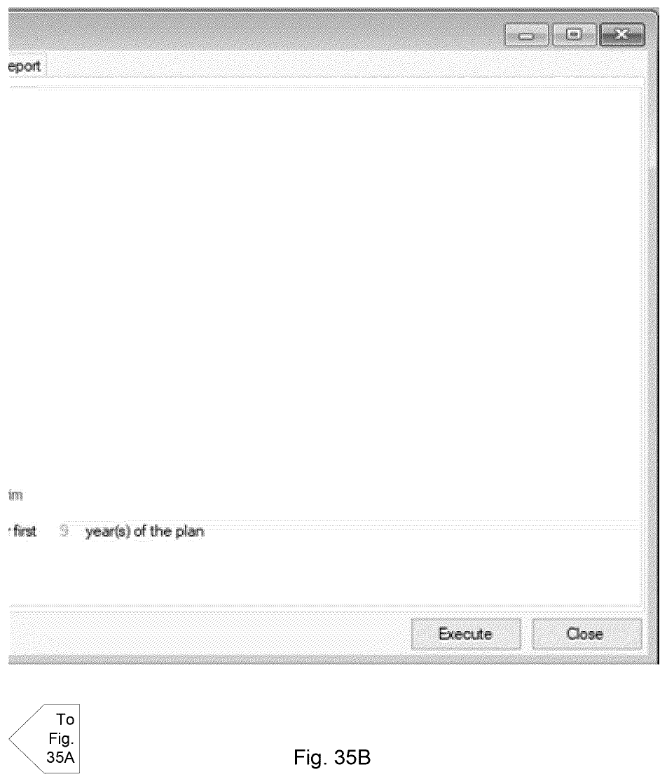

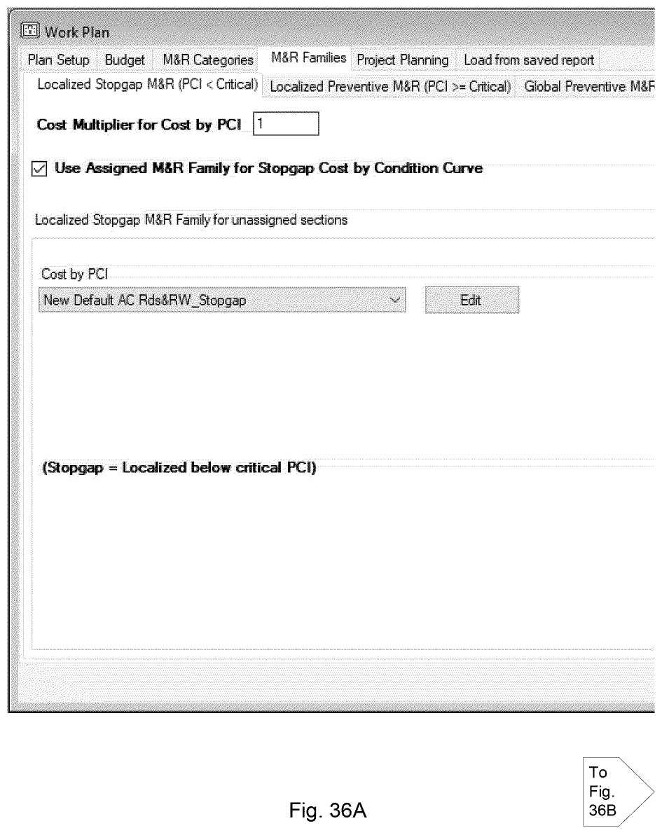

FIGS. 35A-35B show a risk calculation window.

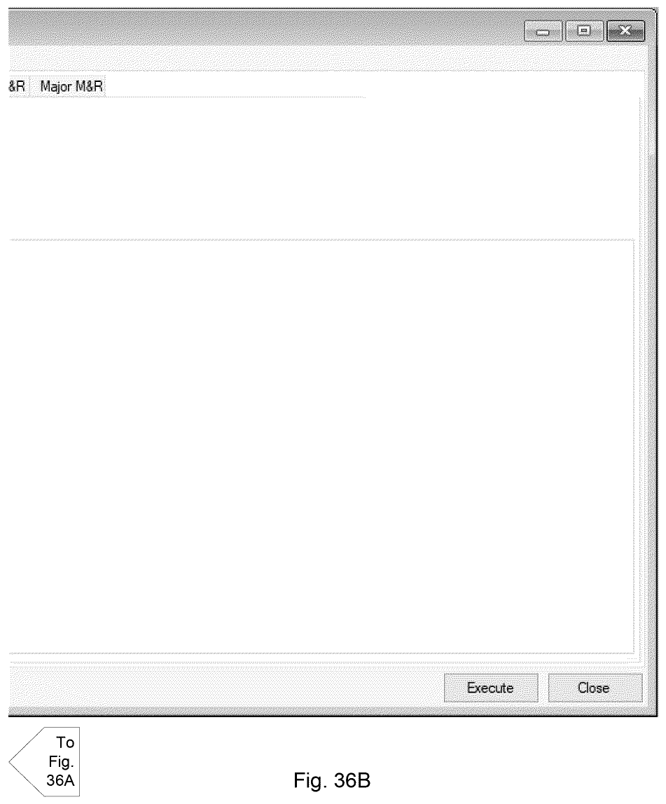

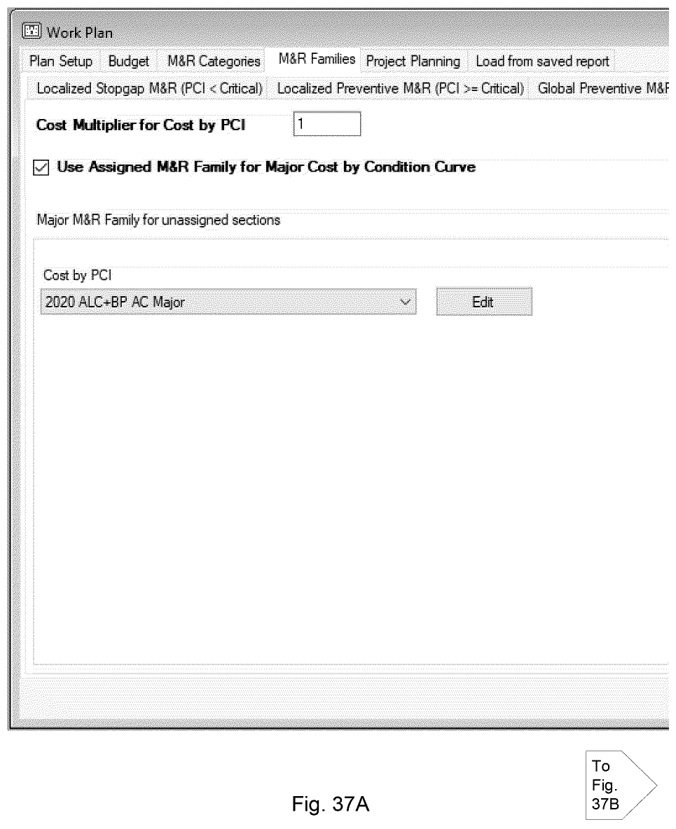

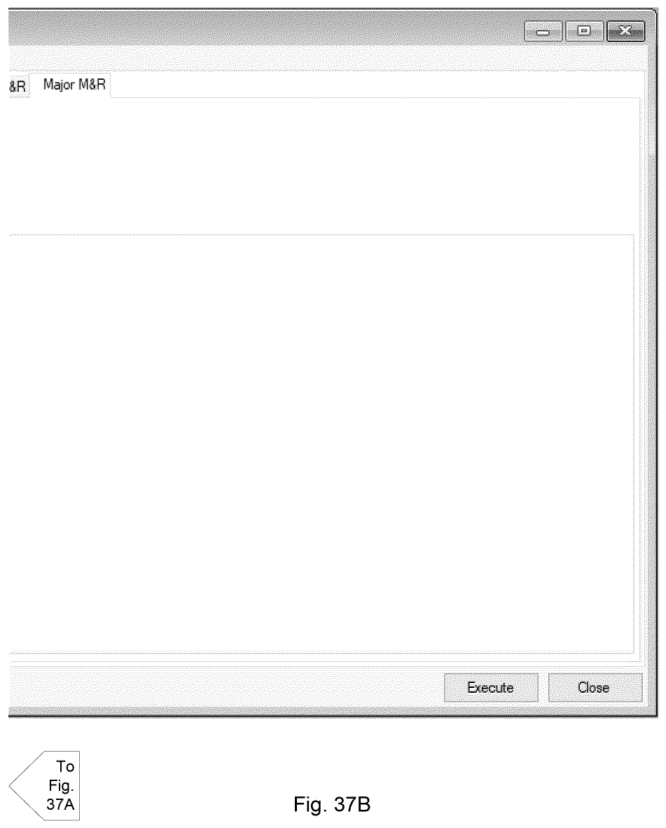

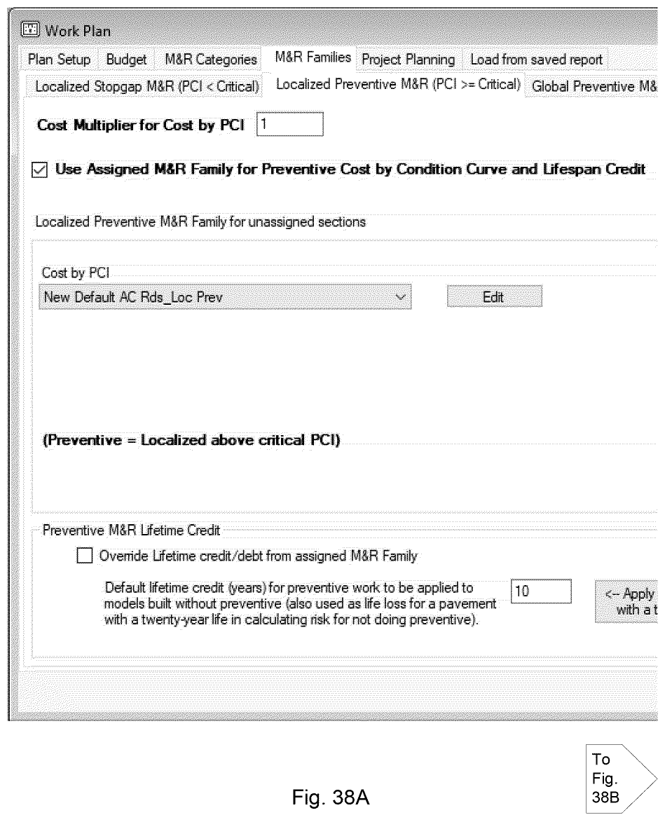

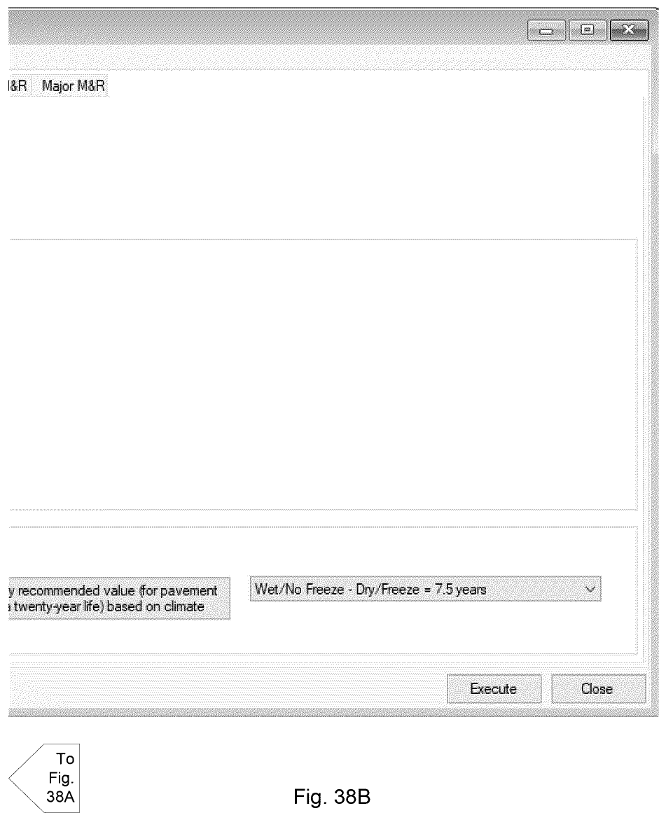

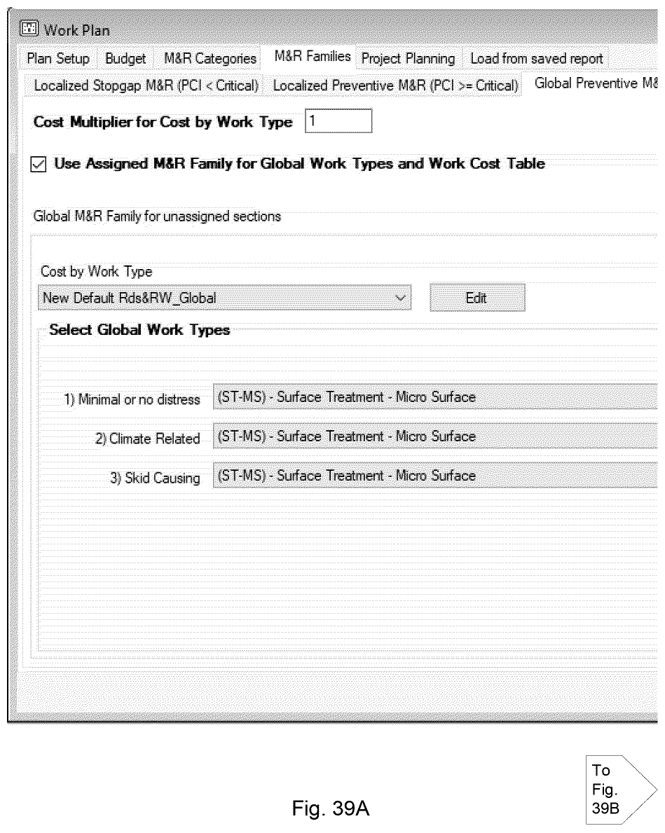

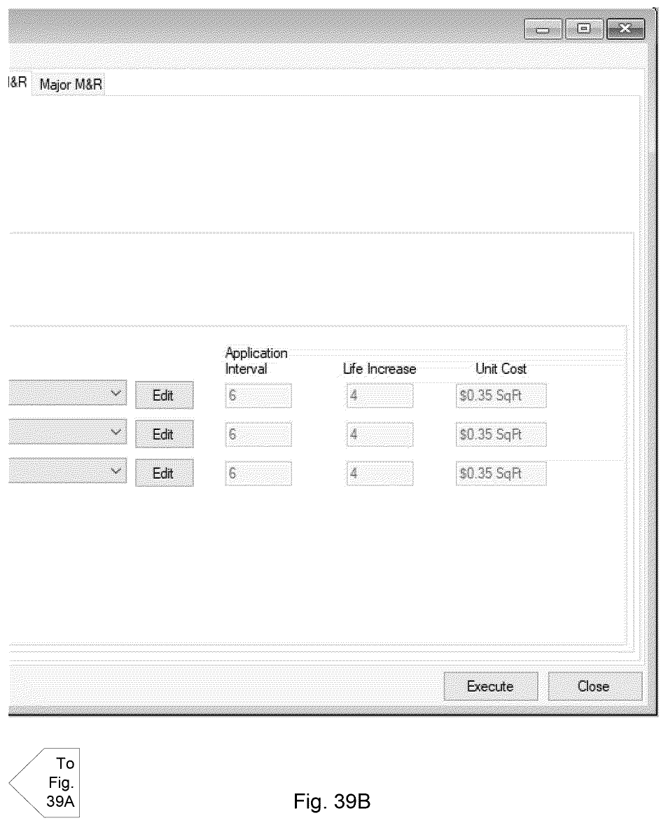

FIGS. 36A-36B, 37A-37B, and 38A-38B show risk calculation tabs.

FIGS. 39A-39B show a work plan analysis window with a global M&R family settings tab selected.

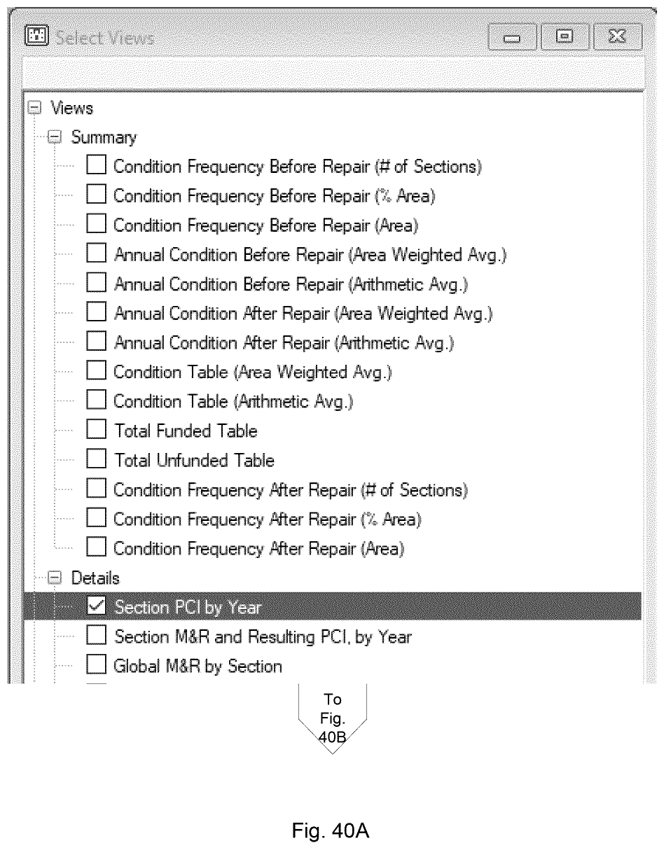

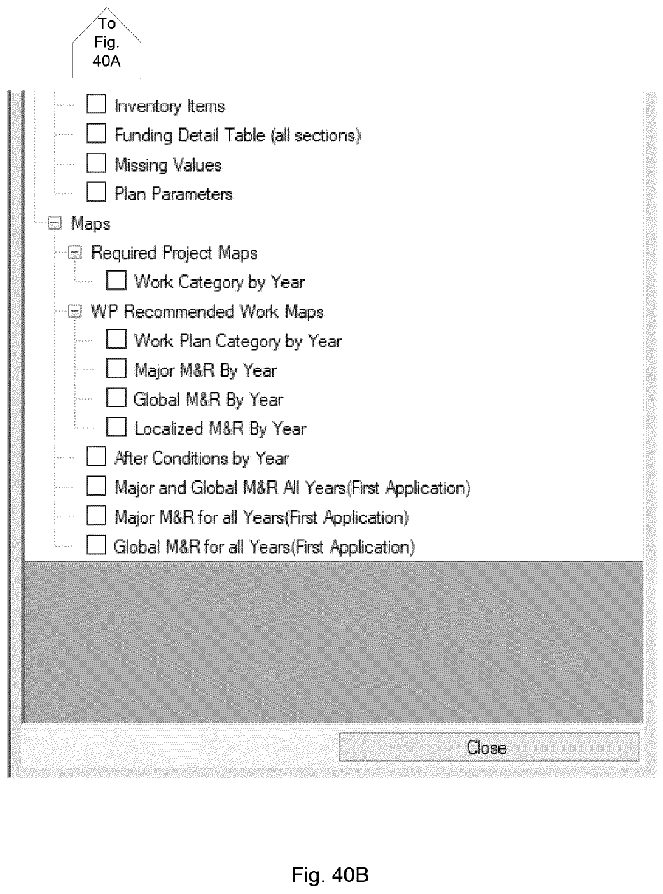

FIGS. 40A-40B show a results selection tool configured to cause the pavement management application (PMA) to display a result window such as a table, graph, map, menu, or display.

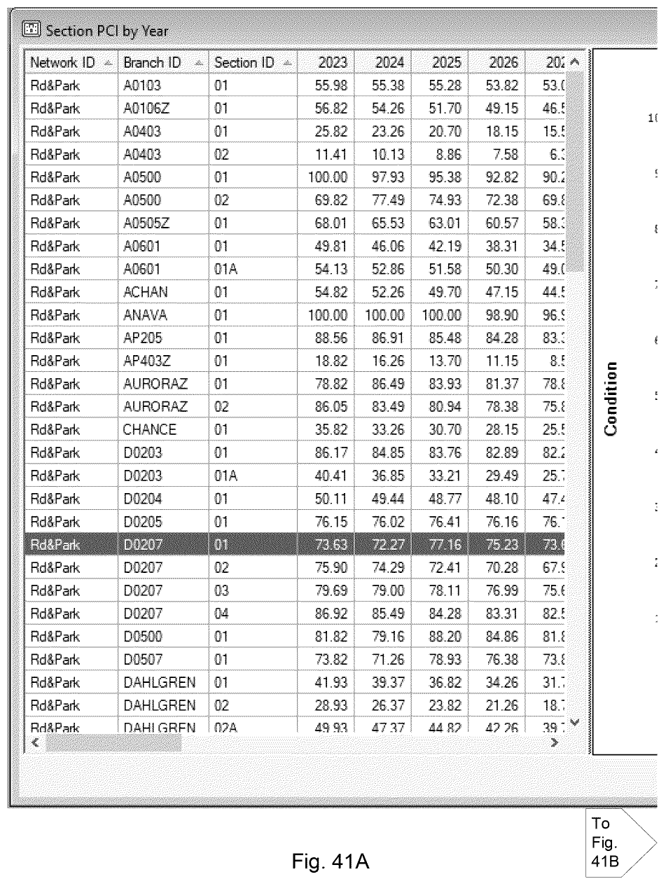

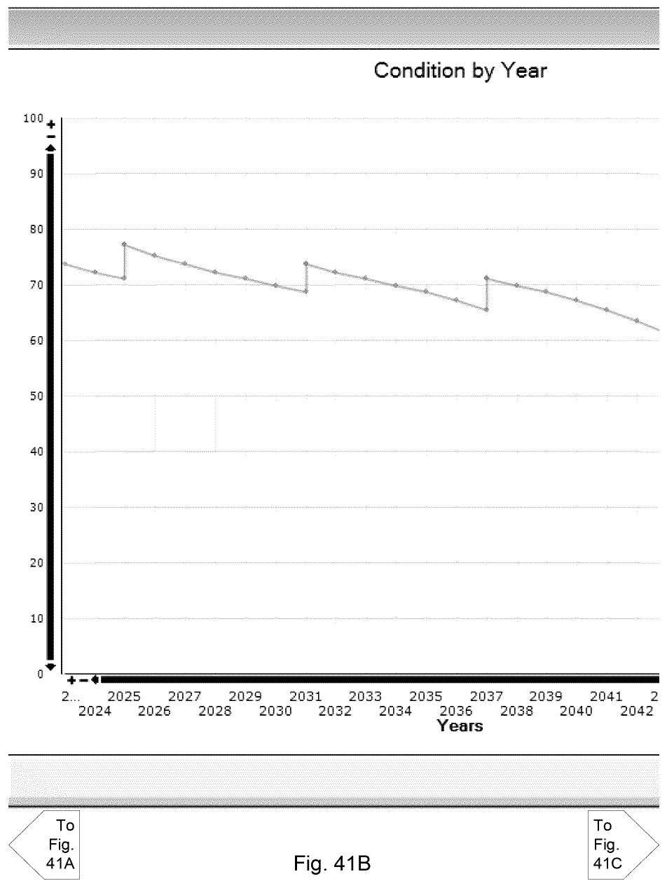

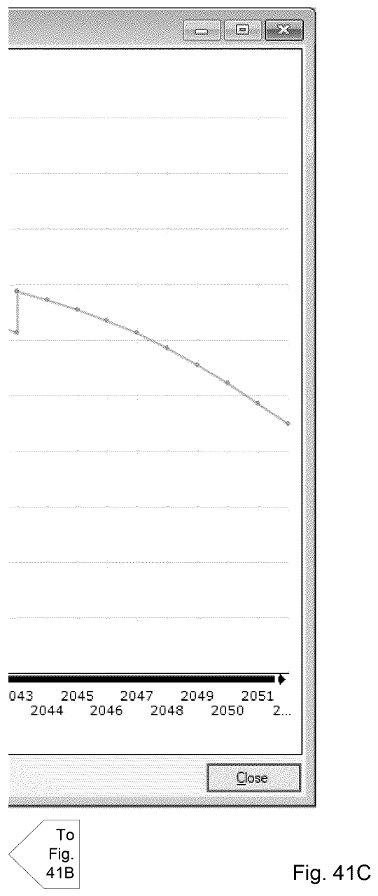

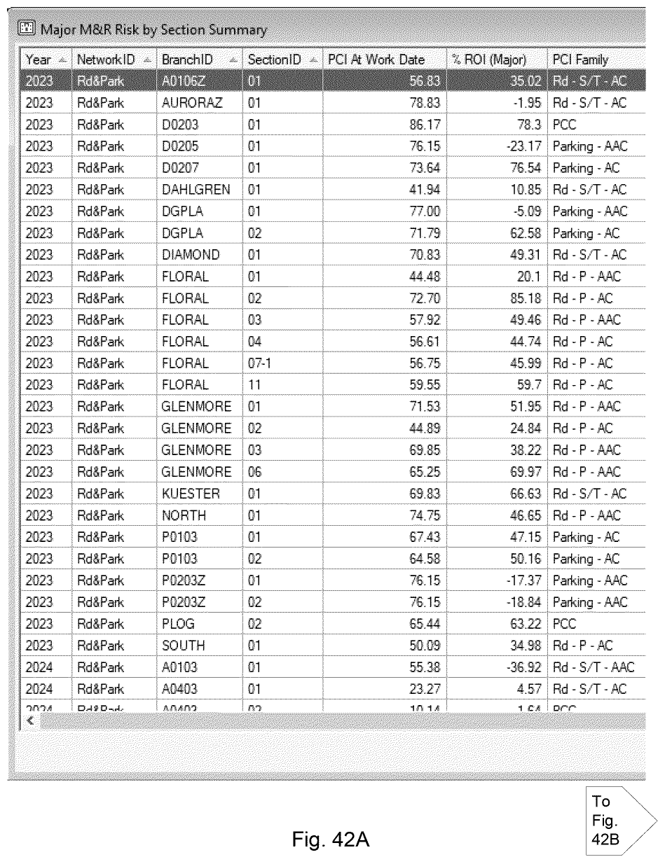

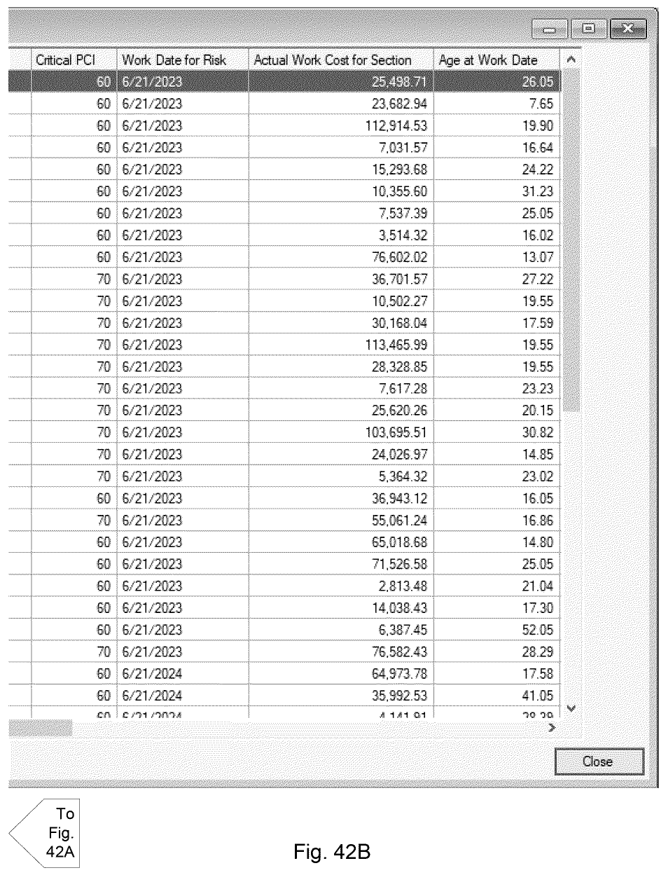

FIGS. 41A-41C show the results table Section PCI by Year table and graph.

FIGS. 42A-42B show a result window configured to display a major M&R risk by Section summary.

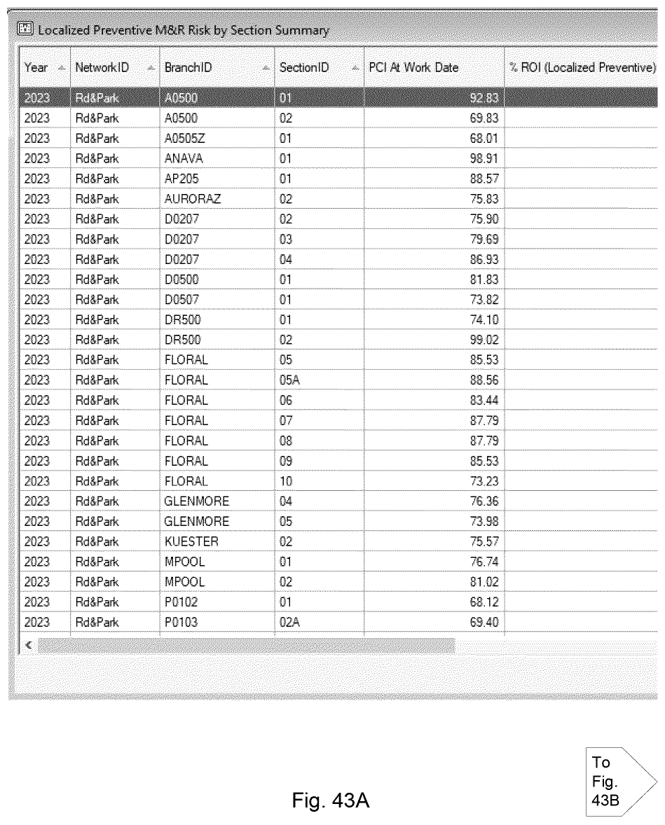

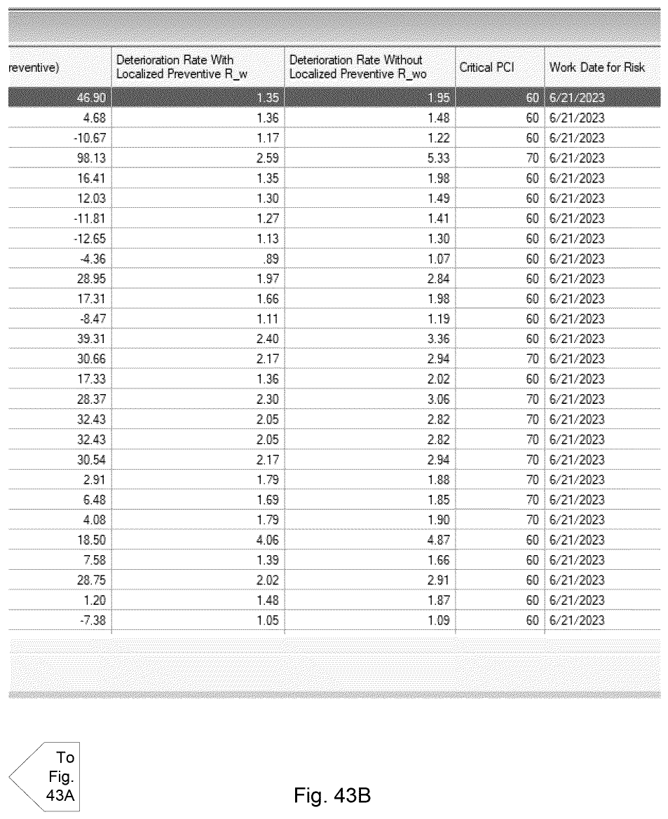

FIGS. 43A-43B show a result window configured to display a localized preventative M&R risk by section summary.

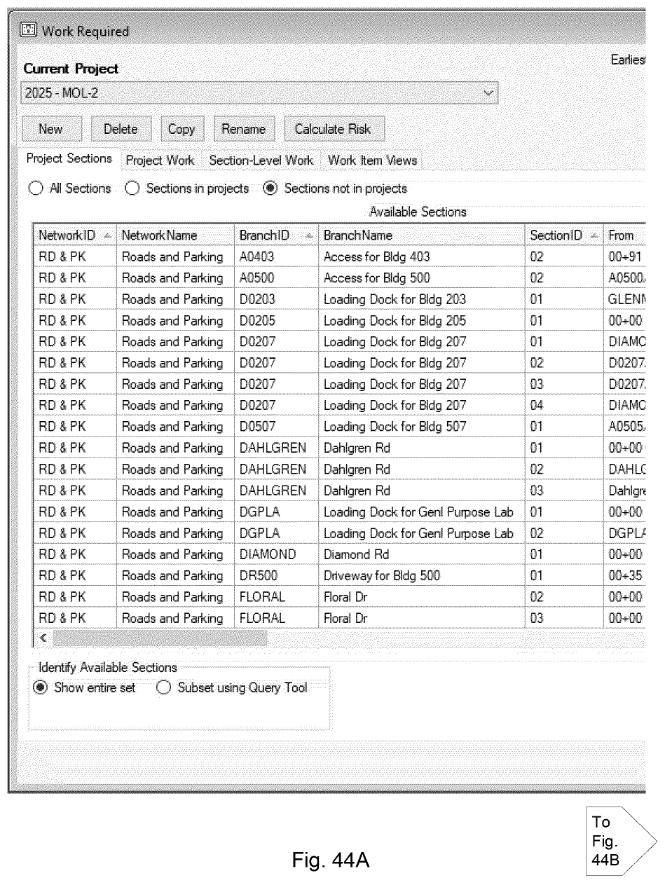

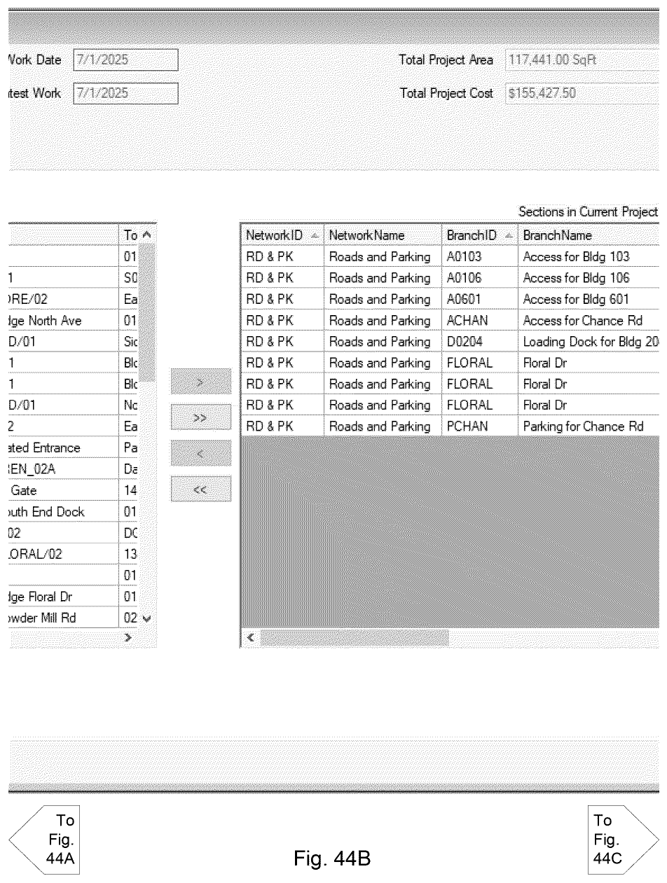

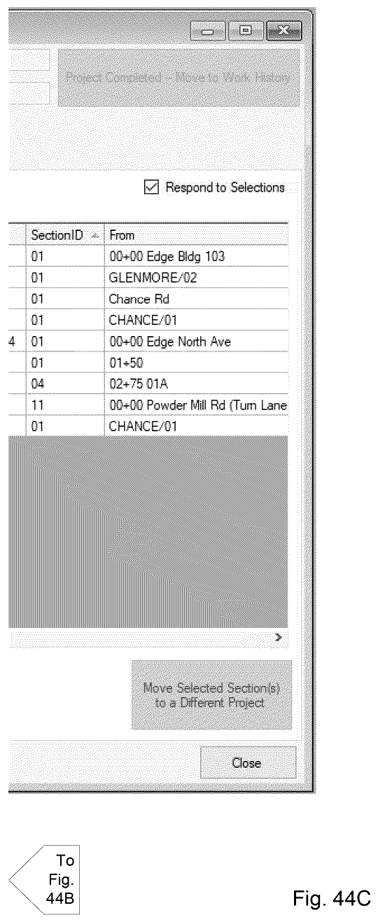

FIGS. 44A-44C show a project planning window.

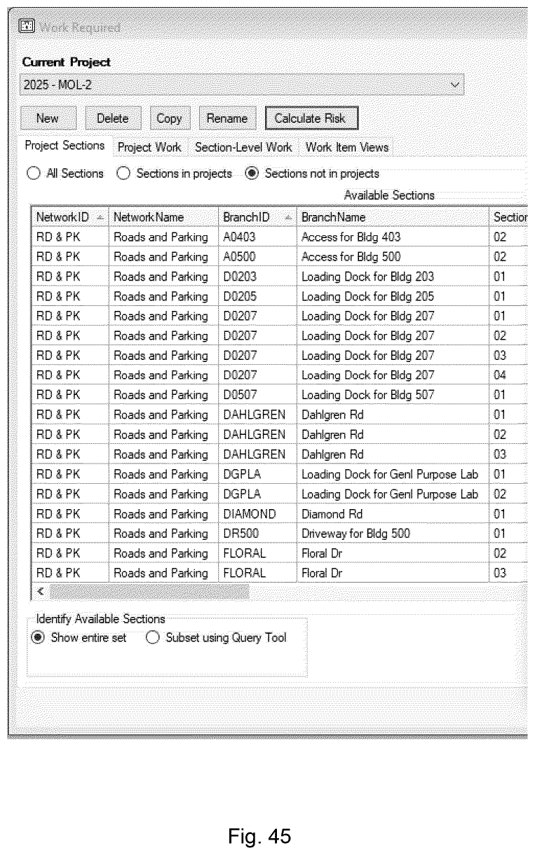

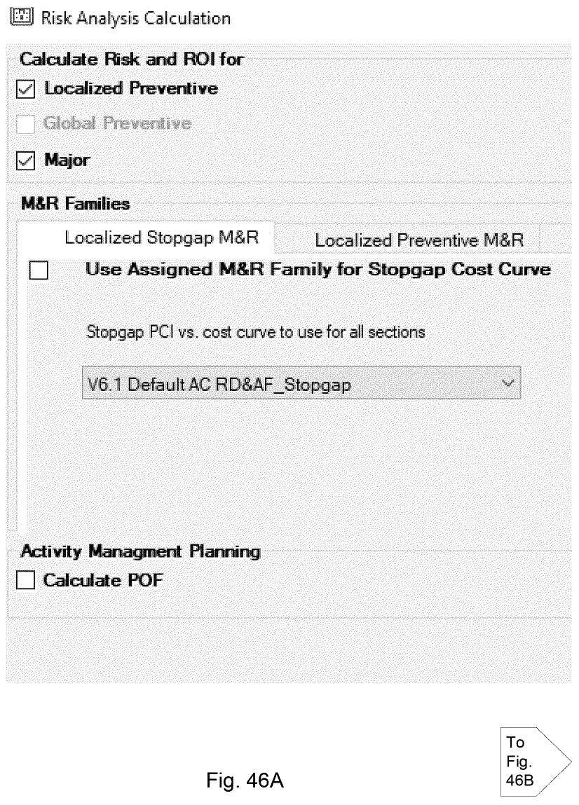

FIG. 45 shows a work required window.

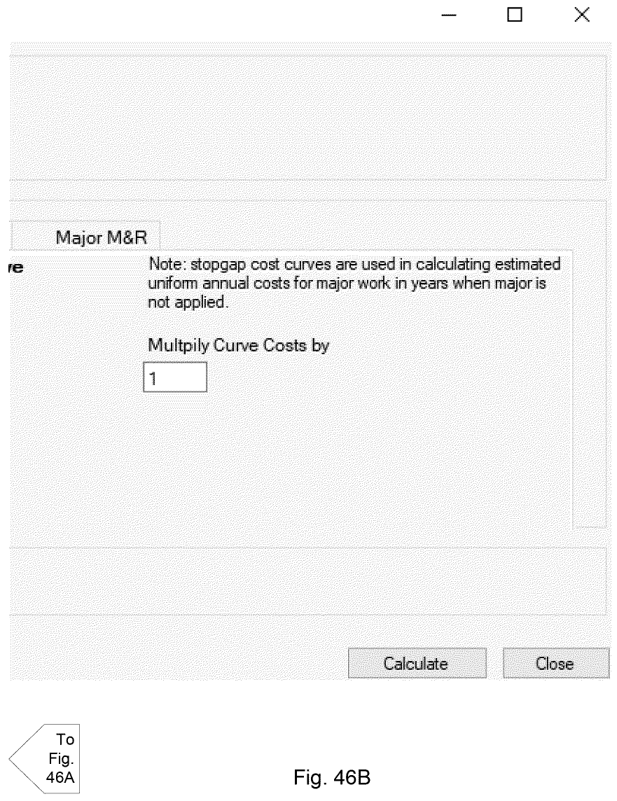

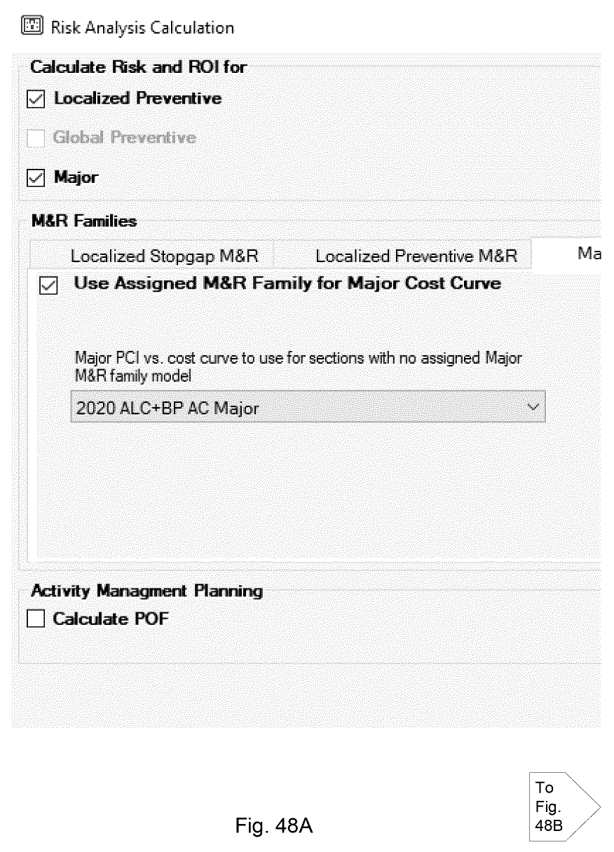

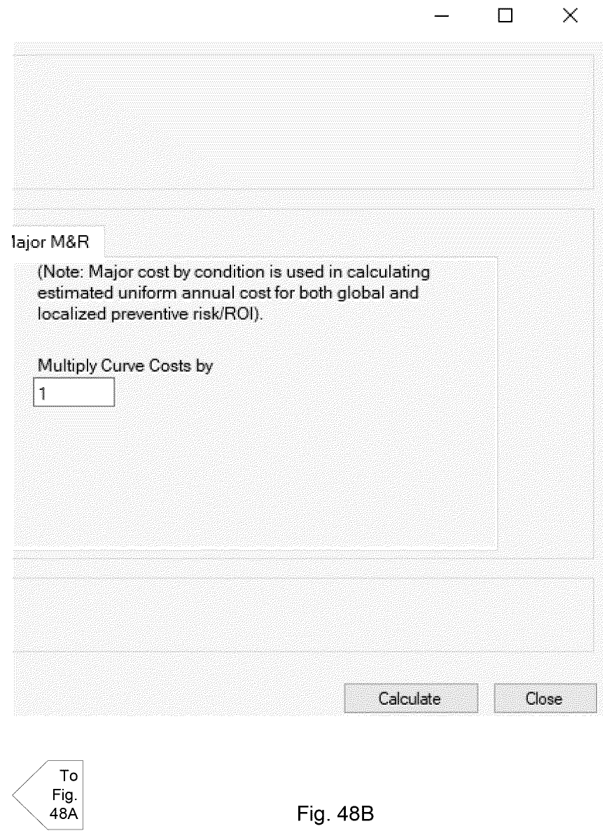

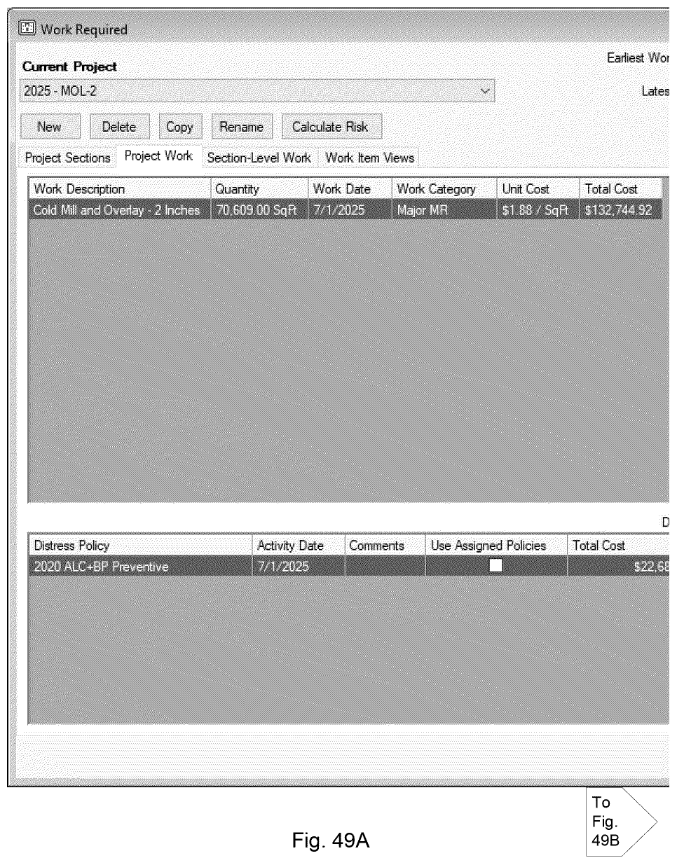

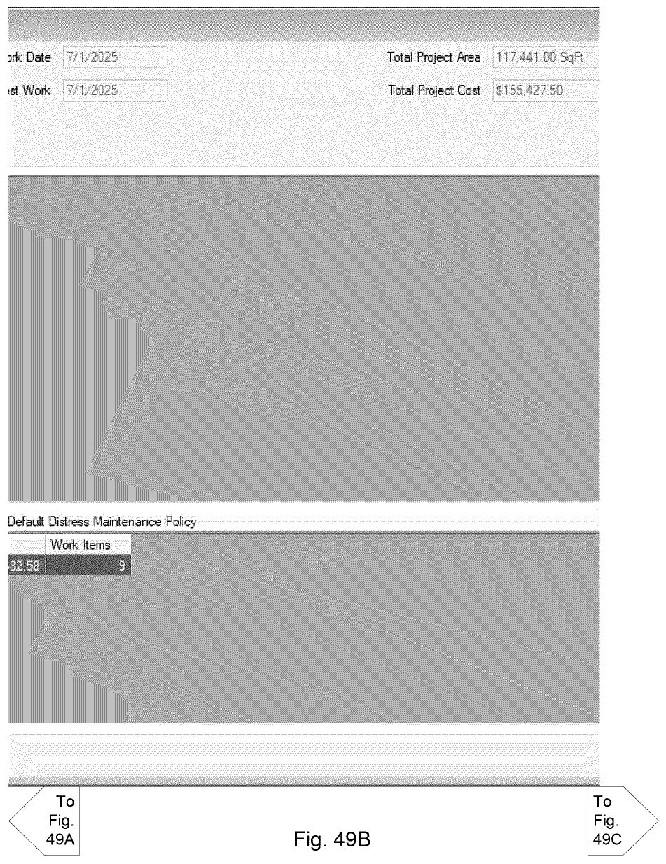

FIGS. 46A-46B, FIGS. 47A and 47B, and FIGS. 48A and 48B show additional risk calculation windows.

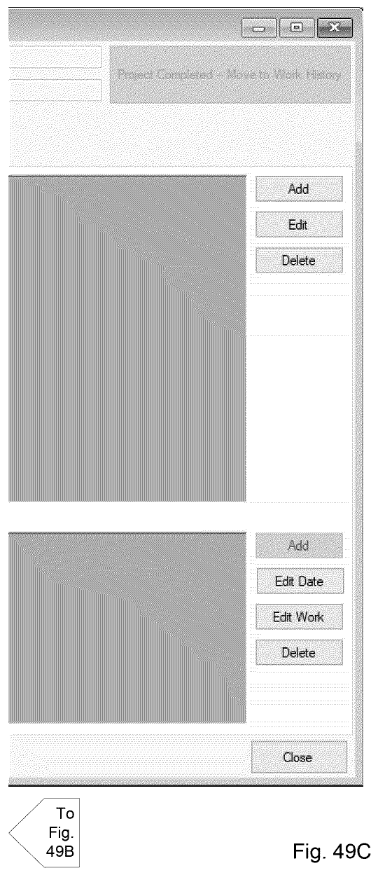

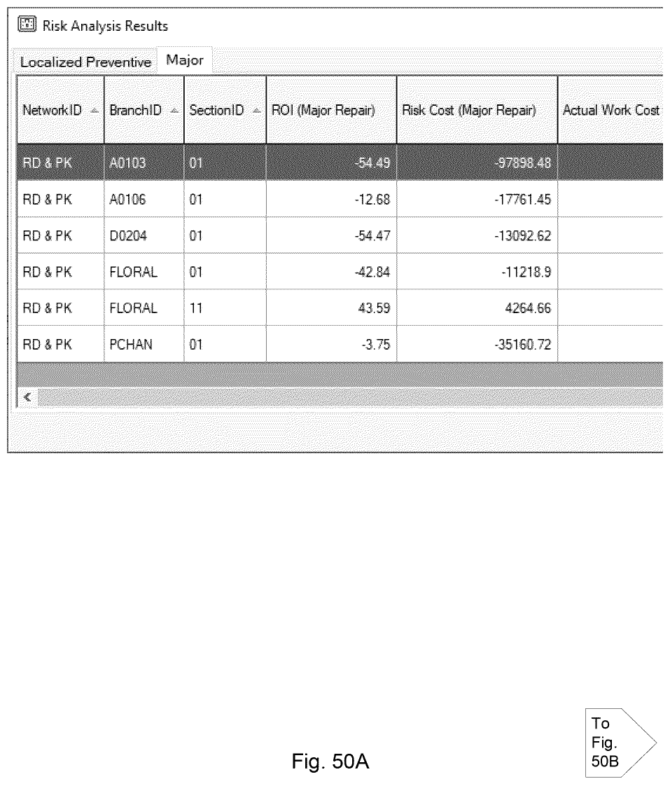

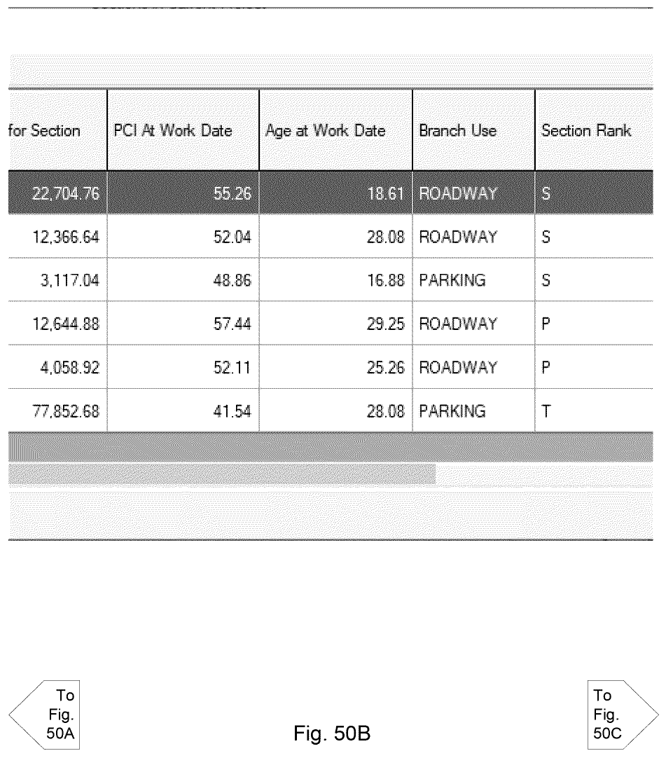

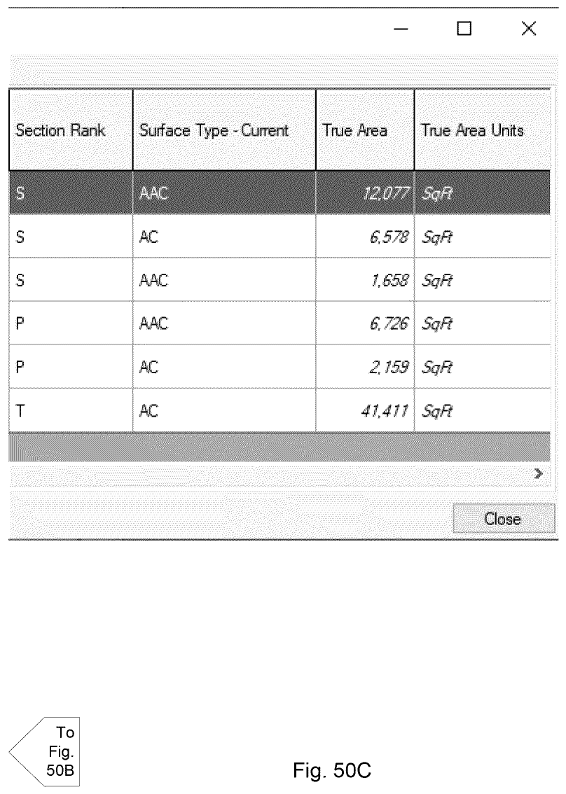

FIGS. 49A-49C and FIGS. 50A-50C show a risk analysis for project work window.

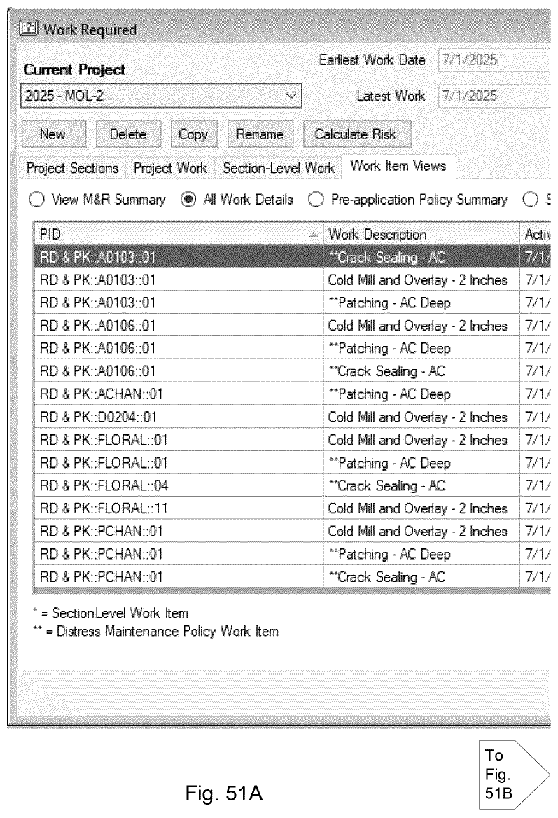

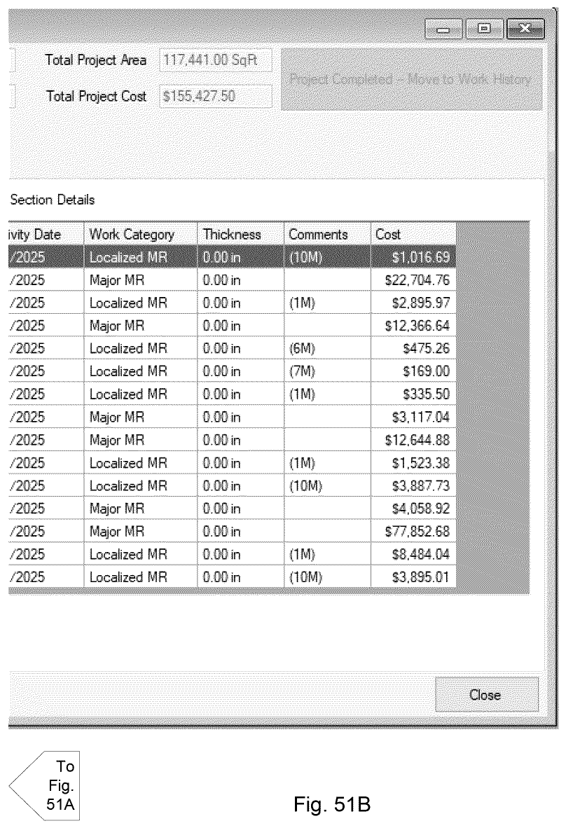

FIGS. 51A to 51B show a project work detail window.

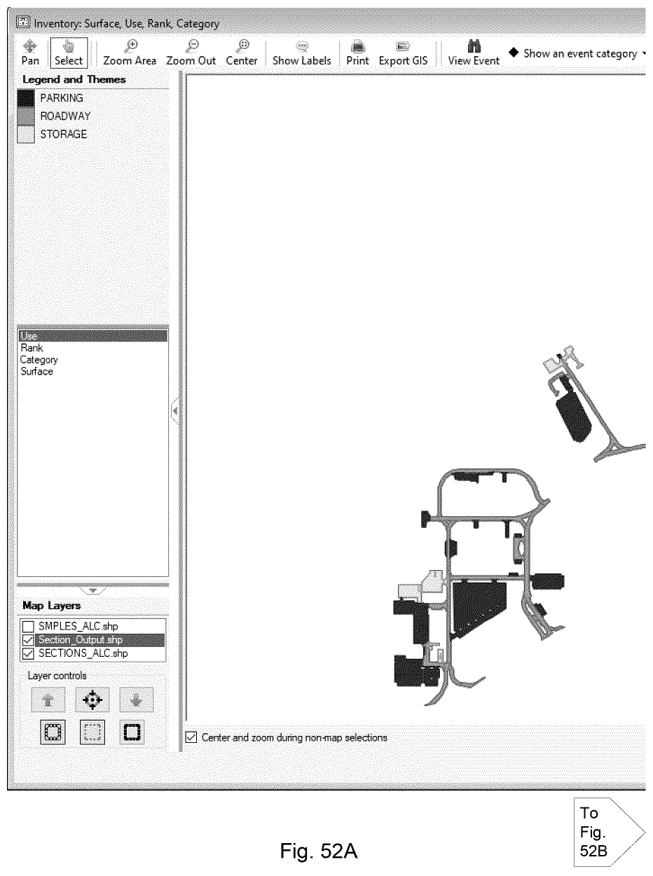

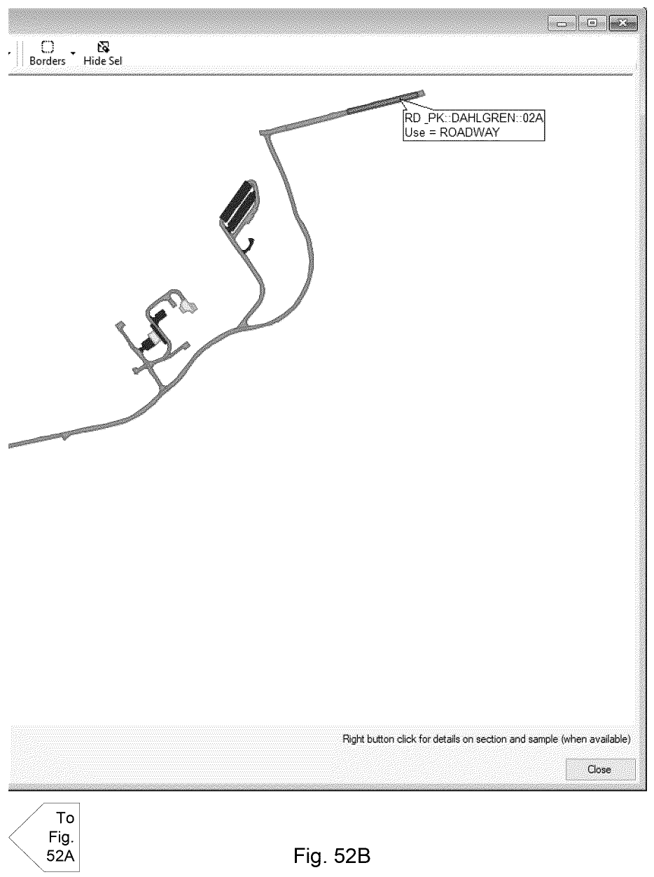

FIGS. 52A-52B show an inventory: surface, use, rank category window.

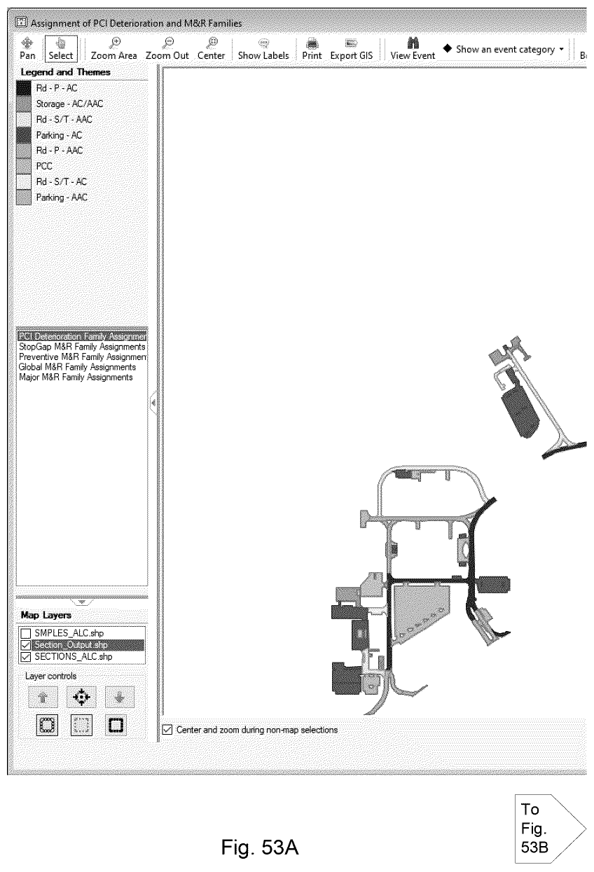

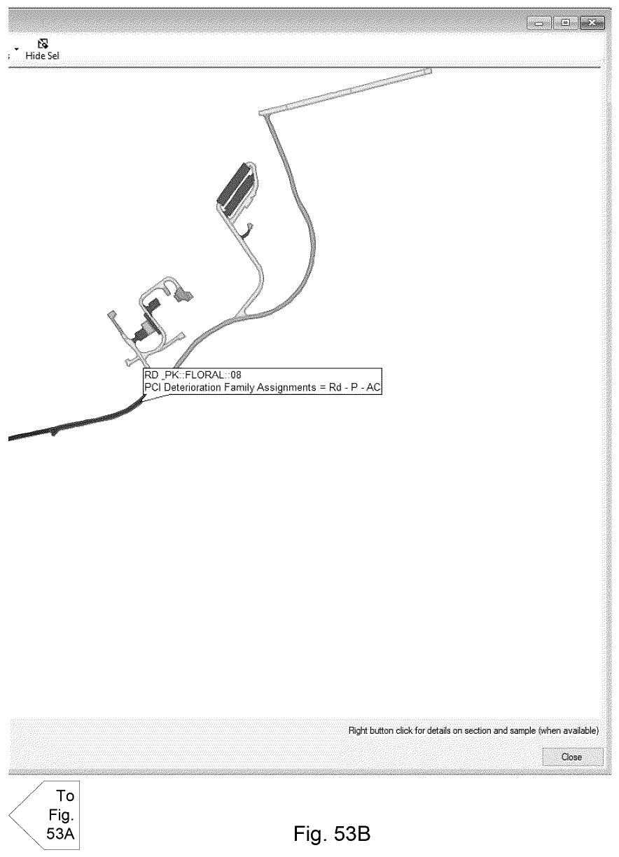

FIGS. 53A-53B show an assignment of PCI deterioration and M&R families window.

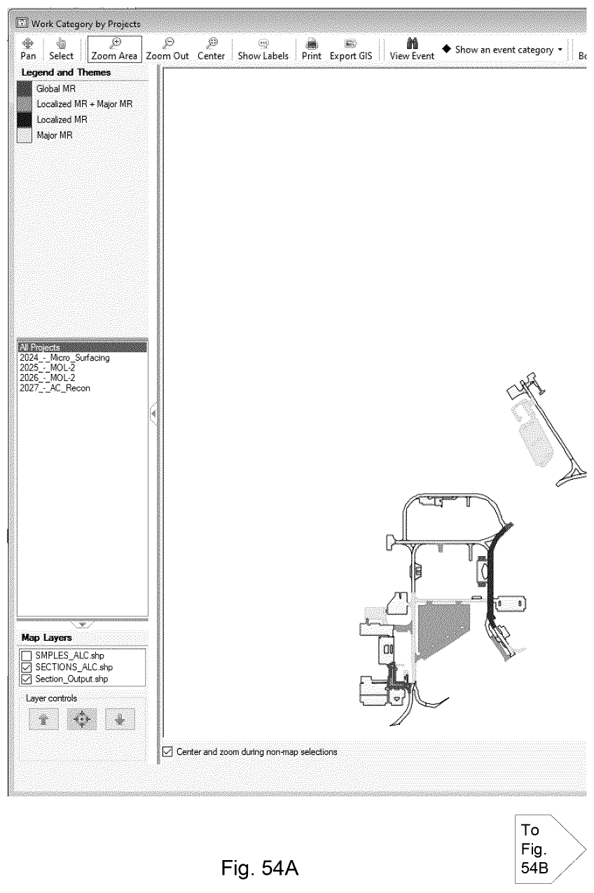

FIGS. 54A-54B show a work category by projects window.

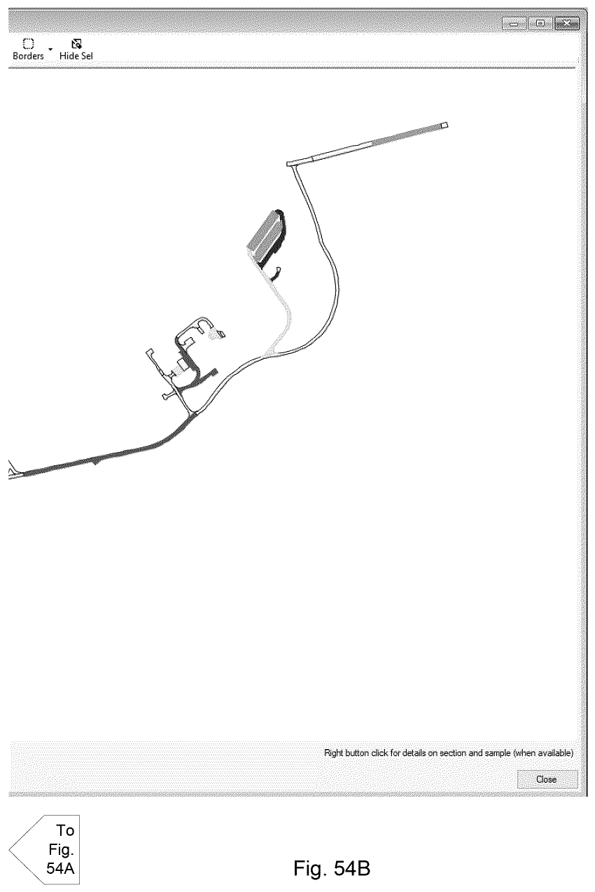

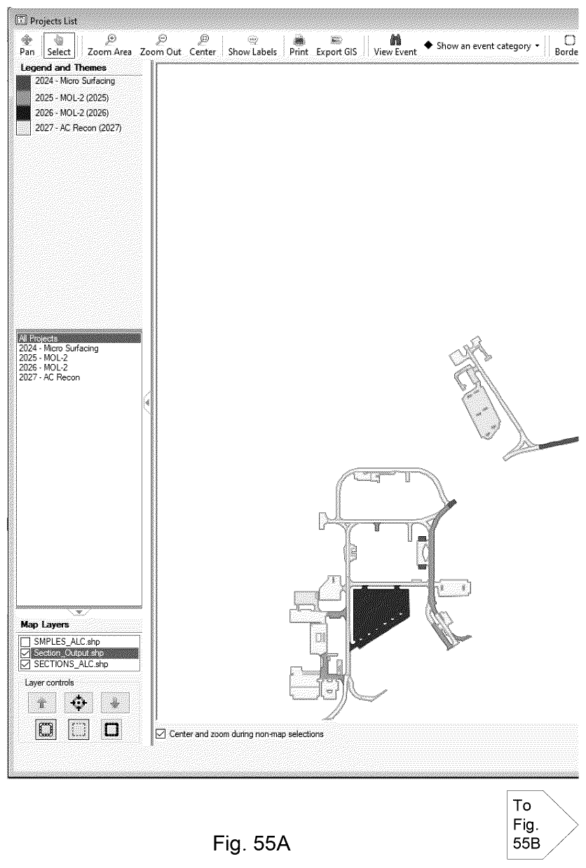

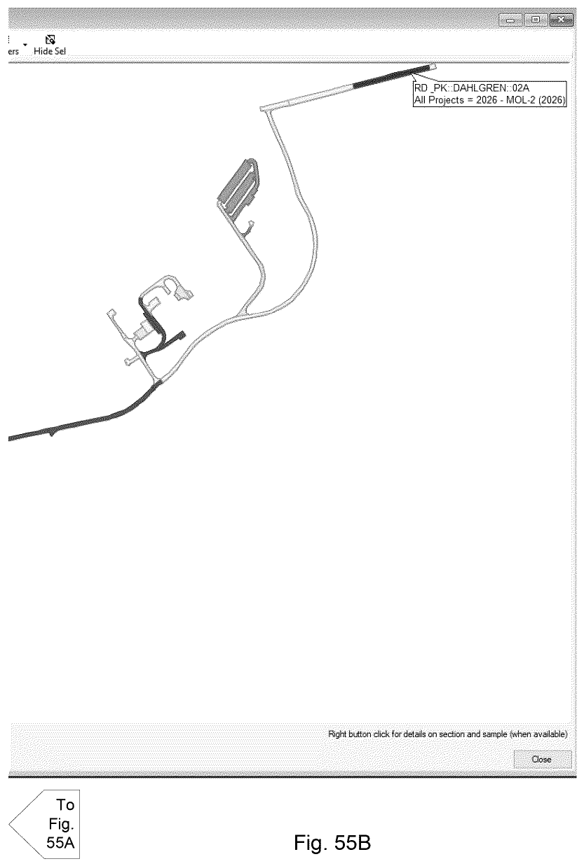

FIGS. 55A-55B show a projects list window.

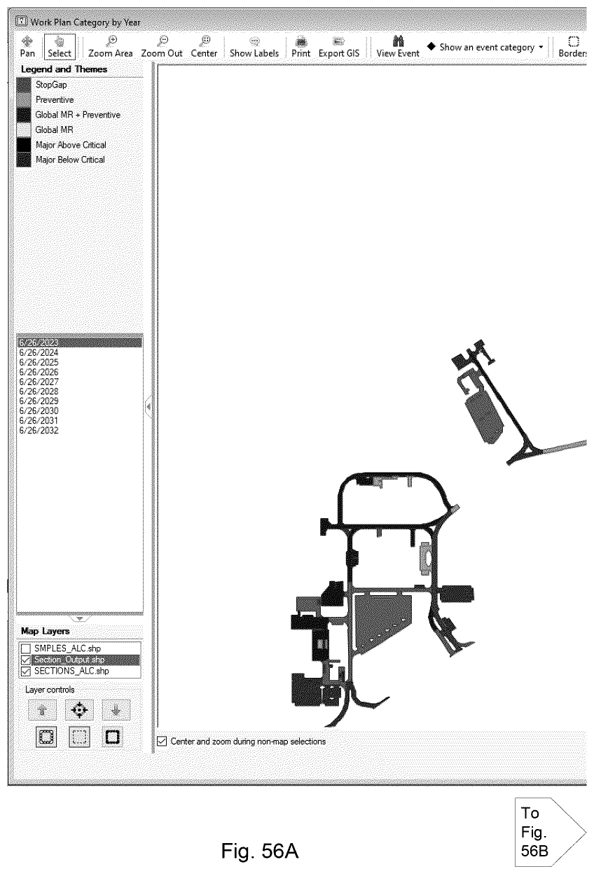

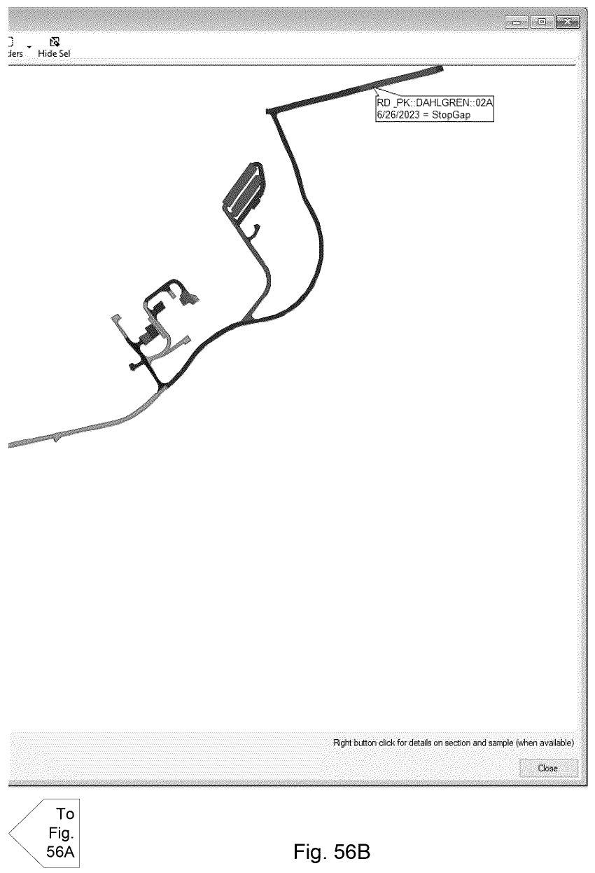

FIGS. 56A-56B show a work plan category by year window.

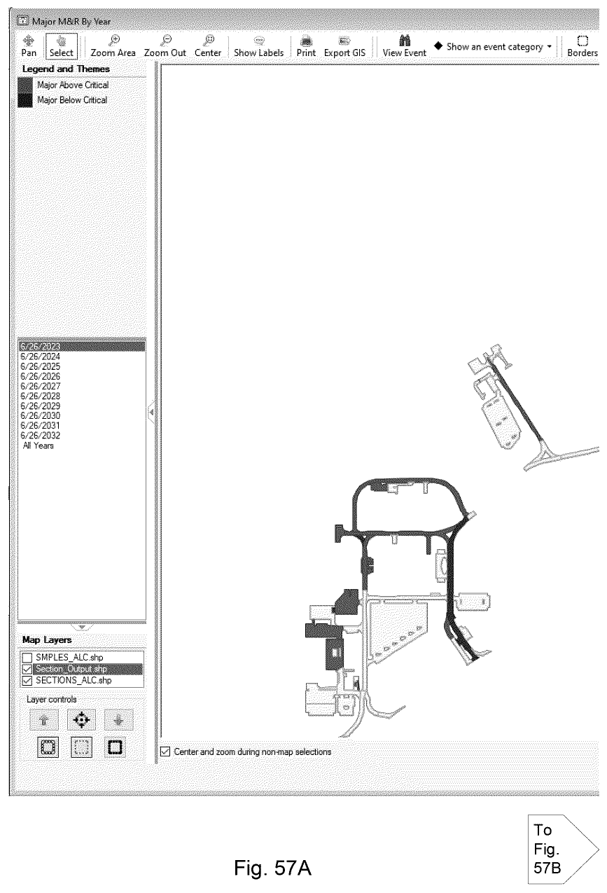

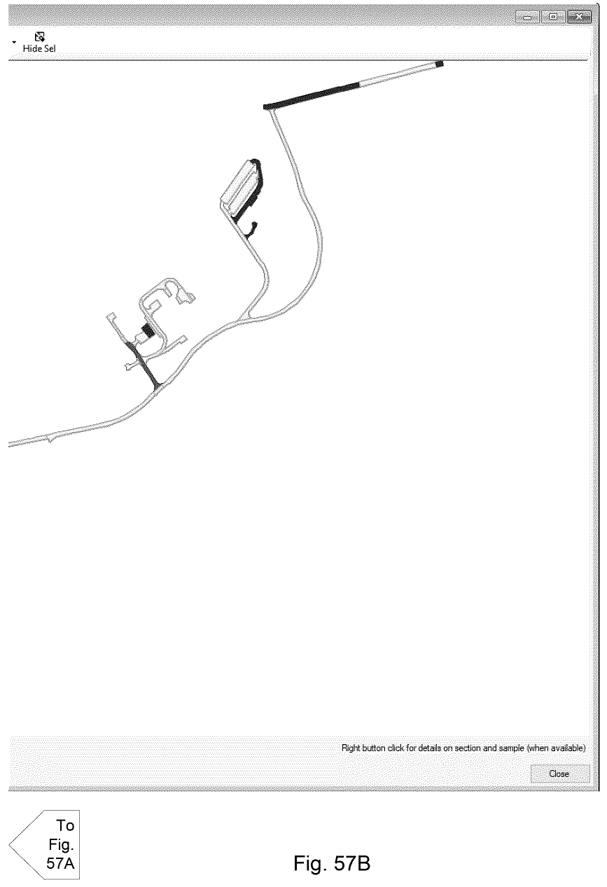

FIGS. 57A-57B show a workplan recommended for Major M&R by year window.

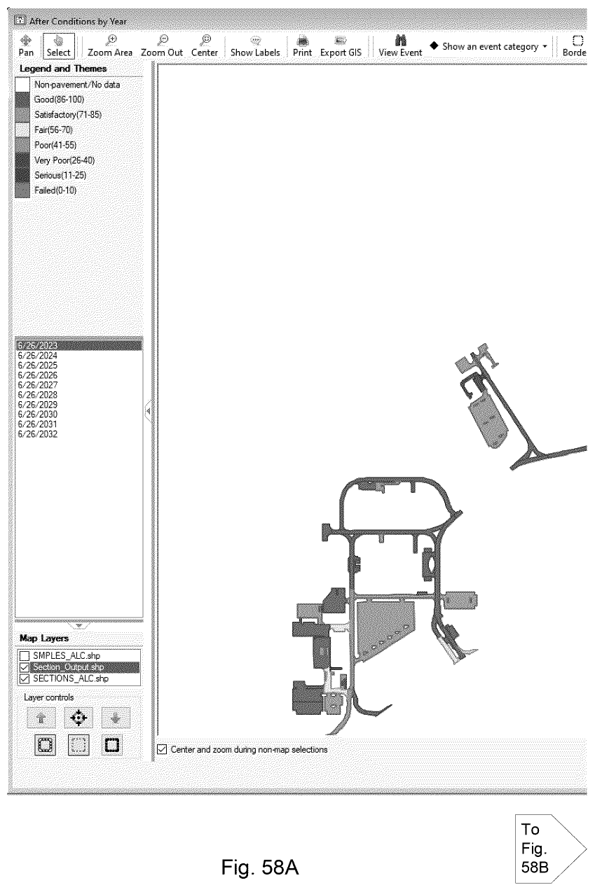

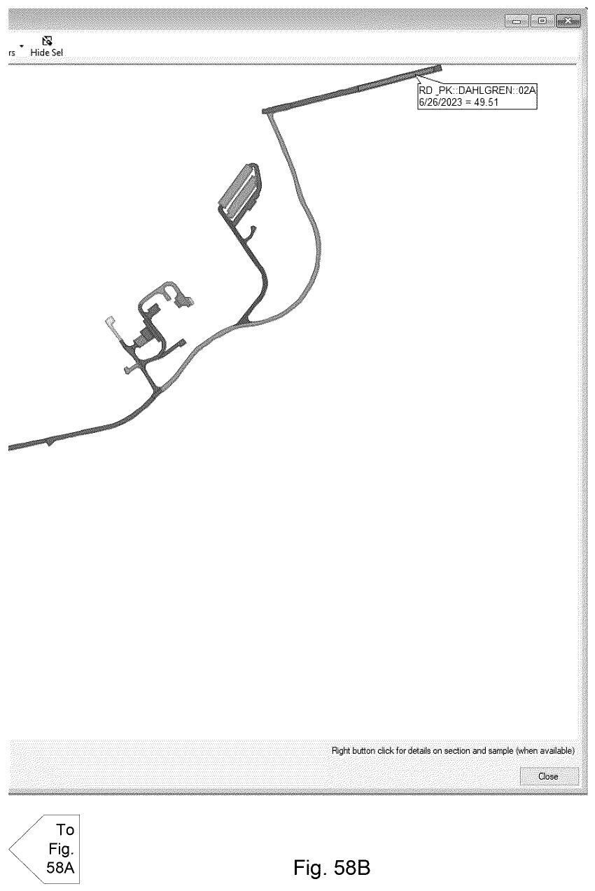

FIGS. 58A-58B shows a first year of an annual section PCI when a recommended workplan is performed window.

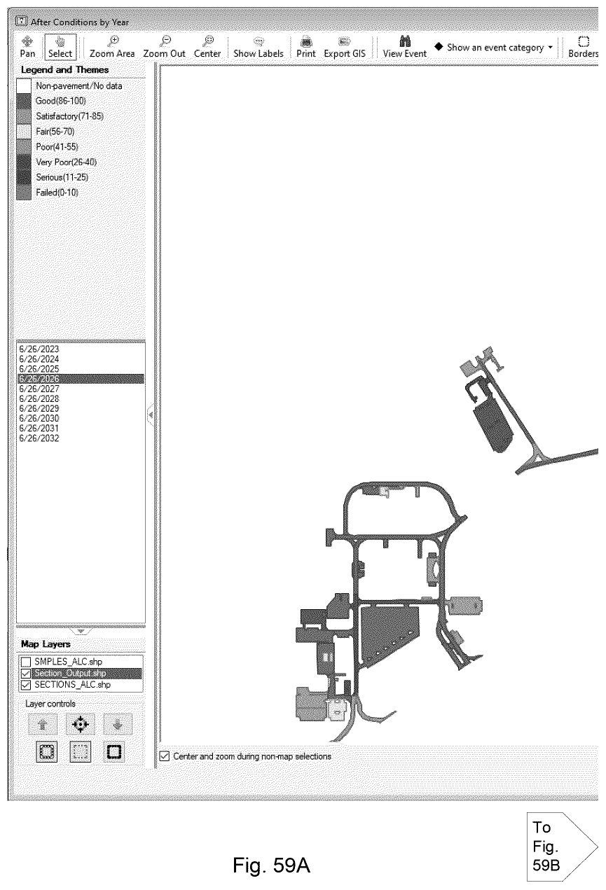

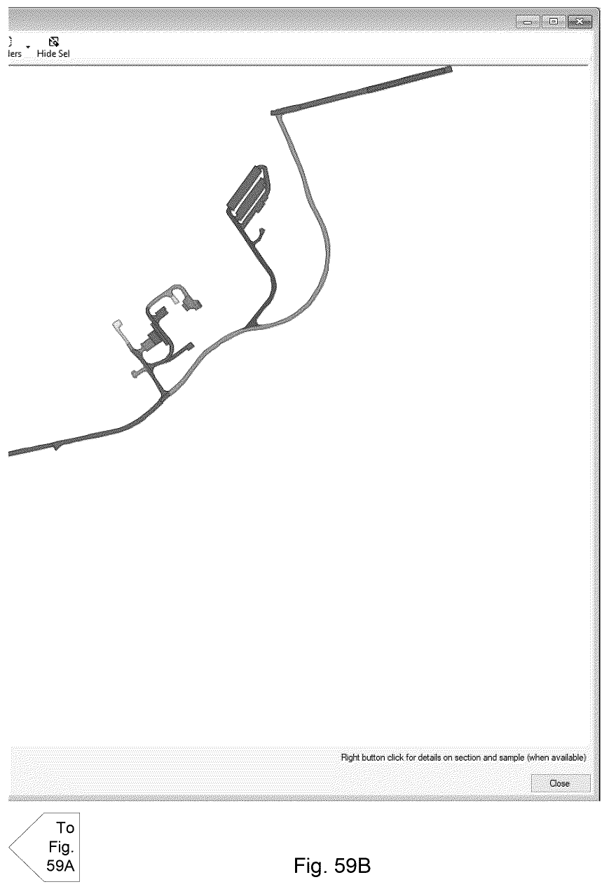

FIGS. 59A-59B show a second year of an annual section PCI when recommended workplan is performed window.

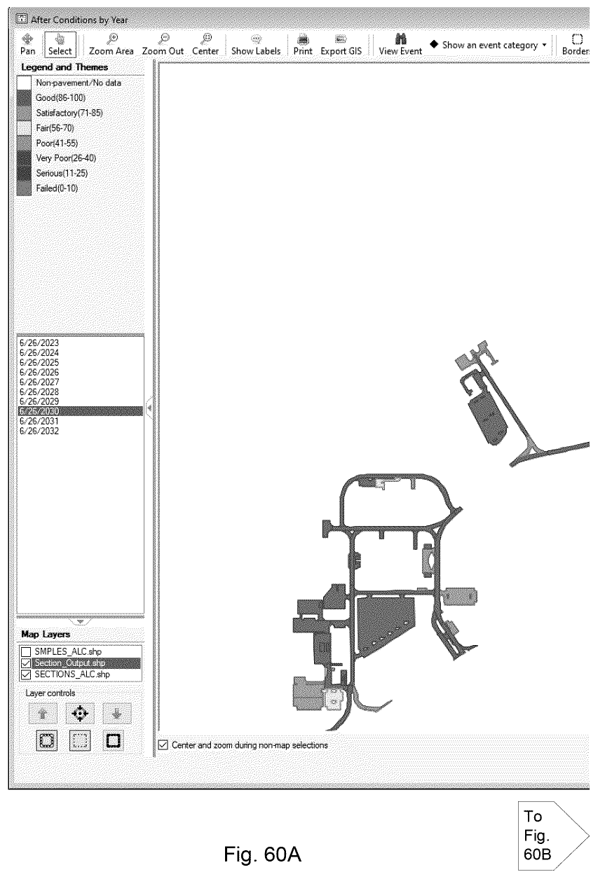

FIGS. 60A-60B show a third year of an annual section PCI when recommended workplan is performed window.

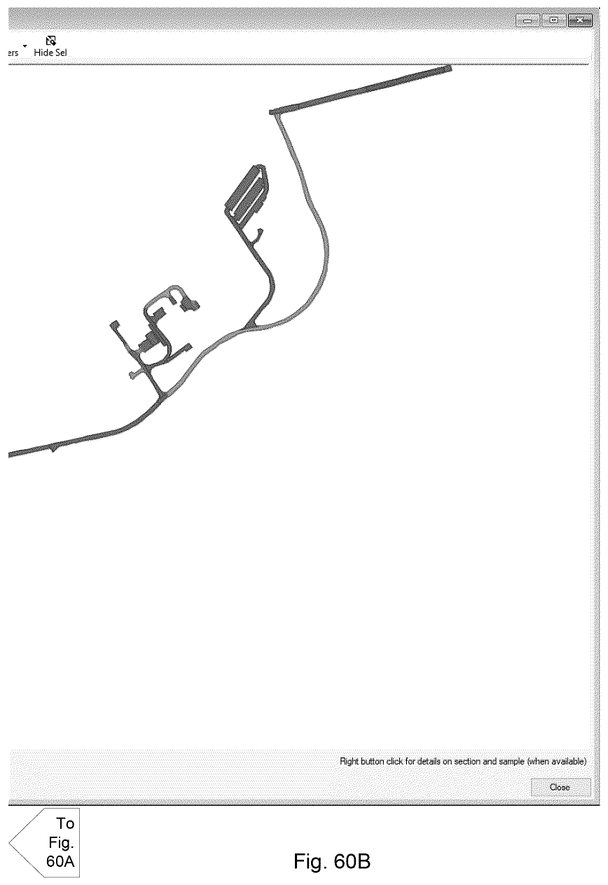

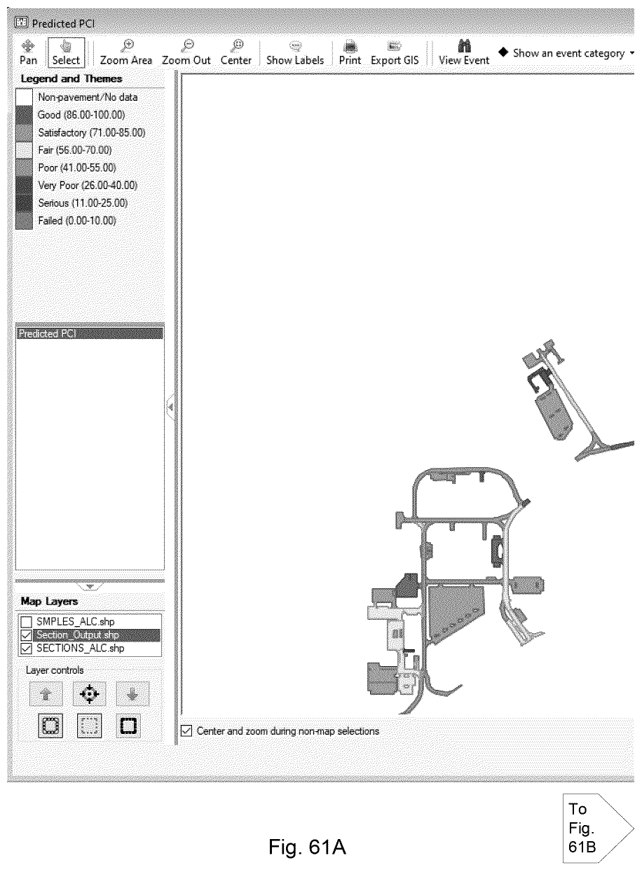

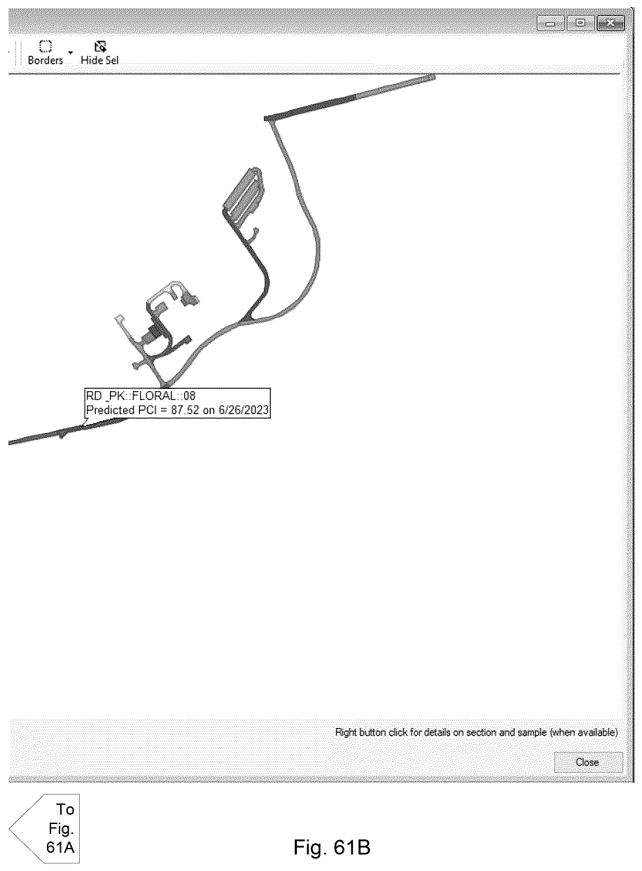

FIGS. 61A-61B show a predicted PCI when no work is performed window.

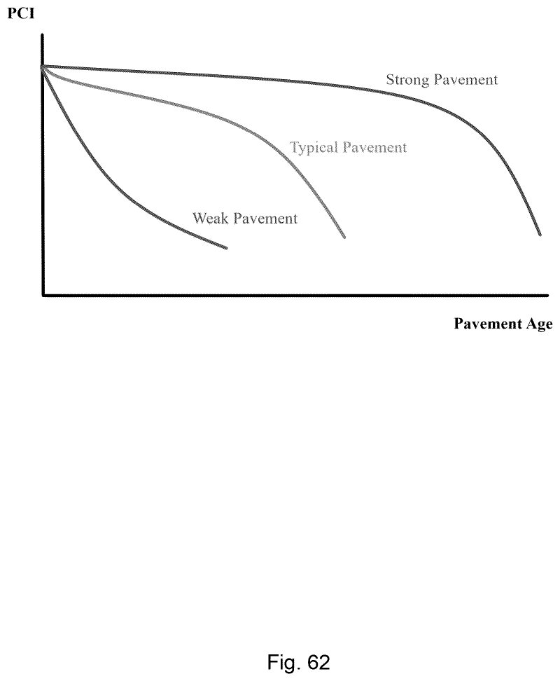

FIG. 62 shows a range of pavement performance.

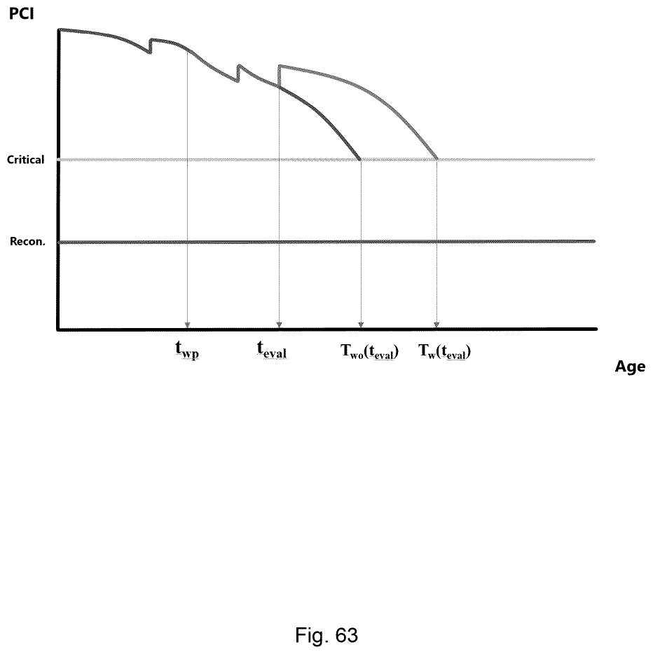

FIG. 63 shows a graph of pavement performance.

### DETAILED DESCRIPTION

Risk Cost (RC) and Return-On-Investment (ROI) provide useful data points for making investment decisions. These measures may be adapted to areas of application like pavement infrastructure maintenance management to be meaningful in those areas. For example, certain configurations of the invention provide methods and algorithms to determine an “estimated uniform annual cost” of a repairing and maintaining pavement section. Various equations can be used to facilitate estimations of costs and return-on-investments for maintenance and repair (M&R). The pavement management application (PMA), a specialized computer running the pavement management application (PMA) software, may be configured to apply RC and ROI to pavement maintenance activities.

PMA may be designed to make calculations of RC and ROI more accurate by considering pavement models (“families”). Use of pavement models may provide a more accurate outcome than, for example, using a linear-decay model or uniform pavement repair costs. PMA may be configured to calculate RC and ROI more accurately by including historical data about the particular pavement section being evaluated. PMA may be configured to make the RC and ROI numbers more usable by integrating these numbers into existing maintenance planning tools such as a section M&R Computer, Section Maintenance and/or Repair System, and/or an Inspection system.

PMA may be configured to resolve the pavement maintenance management question “what is the most economically effective maintenance and repair (M&R) actions to perform on my pavement infrastructure?” PMA may be configured to manage a pavement repair calendar for a small network of roads (like a gated community), a military base, a city or county, or even an entire country of roads.

PMA may be configured to calculate estimated uniform annual cost (EUAC) of global, major and localized preventive M&R at a particular point in time, based on both pavement condition family and section history in which the pavement condition family may be adjusted based on historical work and inspections. The pavement condition family may be adjusted based on already planned work. The adjusted pavement condition family may be used to calculate the EUAC both when performing and not performing the particular type of M&R under consideration.

For localized preventive M&R, the method of calculating EUAC may be varied depending on (a) whether the pavement condition family was built including or not including preventive M&R, and (b) whether a work planning method is including localized preventive M&R or not.

PMA may be configured to determine a localized cost component of EUAC for Major M&R in which: the cost calculation may be adjusted based on whether the condition family is built with or without preventive M&R. The cost calculation may be adjusted based on whether the work planning method includes localized preventive M&R or not. The cost calculation may be adjusted based on whether the current estimated condition of the section is above or below the critical condition.

PMA may be configured to determine the critical condition for a condition family that employs an iterative algorithm to determine the PCI at which Major M&R has a maximum ROI and in which an initial estimated critical PCI may be used to begin the iteration. The ROI for major M&R may be calculated at each condition value using the configurations described above, and the maximum of which is used as the next estimate of critical PCI. The final estimated critical PCI may be the value at which the iteration stabilizes.

PMA may be configured to determine an effect of localized preventive M&R on a section's life that employs an iterative algorithm. The algorithm may be used either for estimating the life gain for doing preventive work on a section whose condition family does not include preventive, or for estimating the life loss for not doing preventive work on a section whose condition family does include preventive. PMA may generate an estimate of life gain/loss for a pavement with a twenty-year life is adjusted appropriately to estimate the life gain/loss for a particular pavement. PMA may adjust the algorithm based on the inspection and work history of the section by shifting the pavement condition family appropriately, then calculating an annual age adjustment needed to determine a proportionality factor to apply to a twenty-year life effect.

There may be three categories of M&R; Localized (spot maintenance such as patching or crack sealing), Global (pavement preservation by applying different types of seal coats to eth entire pavement surface), and Major (such as pavement overlay or reconstruction to bring the pavement to new condition). The RC and ROI methods for each of these categories are different and are included in this disclosure.

PMA may comprise a repair priority logic configured to: prioritize repairs into three priority categories: low priority repairs, medium priority repairs, and high priority repairs; determine a repair priority for each of the pavements within a user's network; and adjust the repair priority of the pavements to maximize a user's return-on-investment.

PMA may comprise a return-on-investment calculator configured to prioritize different types of repairs as high, medium, and low priority. The return-on-investment calculator may be configured to set and modify these priorities to maximize a user's budget. The software can determine which roads should be repaired first and what kind of repairs should be made. The software may be configured to analyze all the possibilities a user has (e.g., what types of equipment for repairs) and provide the user with recommendations as to which repairs to make. return-on-investment calculator may be configured to forecast deterioration of roads if repairs are not made. The return-on-investment calculator may be configured to calculate an ROI for each section of each road in a network of roads. The return-on-investment calculator may include in its calculations, costs associated with making repairs versus costs of not making repairs.

PMA may comprise a pavement condition prediction engine. The pavement condition prediction engine may contain algorithms that analyze and predict pavement deterioration based on pavement type, pavement families, repair history, and deterioration history. The pavement condition prediction engine may be configured to perform this analysis on a pavement section level based on the actual history of that section of the road. The pavement condition prediction engine may be configured to determine a cost curve for repairs for a pavement section and determine an exact point in time where repair costs get much more expensive. This point is known as the PCI Pavement Condition Index.

PMA may comprise budget & reports generation module (also referred to as a results module). The budget & reports module may be configured to optimize a user's budget if the software is given a budget to spend over the course of several years. The budget & reports module may be configured to generate a budget to maintain road condition (as specified by the user) at or above a certain pavement quality. The budget & reports module may be configured to generate various reports that contain recommendations on what roads to repair and how to repair them over a course of time (e.g., a 5-year plan.) The budget & reports module may be configured to generate digital color code maps to aid the user in understanding what roads to repair and what their roads will look like if roads are not repaired.

### Terminology

S: refers to a specific pavement section on which PMA may be configured to determine M&R risk cost and return-on-investments. In some configurations, critical properties of S such as its surface type and its area (Area^{S}) are known.

PF: refers to a PCI family. PMA may assign a PCI family to a Section under consideration or evaluation. A PCI family may comprise three properties. One, a deterioration curve from pavement age to pavement condition. Two, PCI_{crit}: a critical PCI value for the family. The critical PCI value may be the value below which global and localized preventive M&R (pavement preservation) are no longer performed, and safety M&R begins. Three, whether the deterioration curve is based on sections that have had localized preventive M&R performed.

PF^{S}(t) refers to the PCI family PMA may have assigned to a section S after PMA has made adjustments based on section history or predicted condition up to time age t. Specifically, PMA may shift the deterioration curve for the family on the time axis so that the curve passes through a particularly observed (in the case of inspection) or calculated (in the case of global work or working planning) age×condition pair. It's possible that at different points in time t, the curve shift will be different, typically based on the latest work, inspection, or condition prediction prior to t.

MF: refers to an M&R family. PMA may assign an M&R family to a Section under consideration. The M&R family may have six properties. One, a cost curve from PCI to localized preventive M&R cost per unit area. Two, a cost curve from PCI to localized safety M&R cost per unit area. Three, a cost curve from PCI to major M&R cost per unit area. Four, the specific types of global work to perform for minimal, climate-related and skid-causing distresses. Five, a cost table specific global work type to cost per unit area. Six, the PCI at which sections in this M&R family are typically reconstructed (PCI_{recon}).

IH^{S}: refers to the inspection history for S. PMA may use each inspection in the section's history to identify the date, the age of the pavement at the time of inspection and its PCI value (based on observed distresses).

WH^{S}: refers to the work history of S. The work history of S may include the dates when the section received major or global M&R.

tₑᵥₐₗ: refers to the date at which PMA computes estimated uniform annual cost.

T^{S}_{w}(tₑᵥₐₗ): refers to the lifetime of section S from last Major M&R to PCI_{crit} when work of a particular category of M&R is performed by a third party on S at tₑᵥₐₗ.

t_{WP}: refers to the date at which M&R work planning begins.

PMA may be configured to integrate risk and ROI calculations into pavement work planning. PMA may be configured to use a work planning method incorporating PCI families assigned to a Section to estimate the Section condition in future years. The work planning method may include an algorithm for determining what work to do in which year. The work planning method may utilize the M&R work family assigned to the Section to estimate work costs for each plan year. The work planning method may be configured such that PMA can produce the following two outputs: WP^{S}(tₑᵥₐₗ): refers to work the work planner has planned for S from t_{WP} to tₑᵥₐₗ−1 and C^{S}(tₑᵥₐₗ): refers to the conditions the work planner has predicted for S from t_{WP} to tₑᵥₐₗ.

PMA may be configured with a date conversion module. The date conversion module may be configured to allow PMA to convert a Section's date (such as tₑᵥₐₗ) to a Section's age at that date. The date conversion module may utilize the information in the Section's work history WH^{S} to convert between Section data and Section age at that date. Throughout the application, date and ages are generally expressed in terms of fractional years, so an expression such as tₑᵥₐₗ−1 means “one year before the date/age given by tₑᵥₐₗ.”

PMA may be programmed to use the above elements to determine risk cost and return-on-investment.

EUAC^{S}_{w}(tₑᵥₐₗ): refers to an estimated uniform annual cost per unit area for S when performing work (w) of a particular category at time/age tₑᵥₐₗ.

EUAC^{S}_{wo}(tₑᵥₐₗ): refers to an estimated uniform annual cost per unit area for S without (wo) performing work of a particular category on S at time/age tₑᵥₐₗ.

ΔEUAC^{S}(tₑᵥₐₗ)=EUAC^{S}_{wo}(tₑᵥₐₗ)−EUAC^{S}_{w}(tₑᵥₐₗ): refers to the change in estimated uniform annual cost per unit area between doing work and not doing work of a particular category on S at time/age tₑᵥₐₗ.

$${ROI}^{s} ( {t}_{e v a l} ) = [ \frac{Δ E U A {C}^{s} ( {t}_{e v a l} )}{E U A {C}_{w}^{s} ( {t}_{e v a l} )} ] \times 100 :$$

refers to a return-on-investment for performing work of a particular category on S at tₑᵥₐₗ.

RCS (tₑᵥₐₗ)=ΔEUAC^{S}(tₑᵥₐₗ)×Area^{S} is the annual risk cost for performing work of a particular type on S at tₑᵥₐₗ. This is definition of risk cost based on estimated uniform annual cost includes a multiplier by section area. Since EUAC is expressed in terms of unit area, PMA may be configured to multiply the EUAC by the area of S to resolve risk cost.

PMA may be configured to use the equations for ΔEUAC, ROI and RC to accurately determine EUAC^{S}_{w}(tₑᵥₐₗ) and EUAC^{S}_{wo}(tₑᵥₐₗ) for a particular work category for a pavement section S at time/age tₑᵥₐₗ.

PMA may be configured to determine methods for each of three M&R categories: Global M&R, Localized Preventive and Major.

Referring to FIG. 1, PMA may be configured to determine EUAC^{S}_{w}(tₑᵥₐₗ) and EUAC^{S}_{wo}(tₑᵥₐₗ) for global M&R. To determine these values, PMA may utilize certain input information and determine certain costs in performing the calculations. As shown, PMA may be configured to:
1. Calculate EUAC w (tₑᵥₐₗ) and EUAC^{S}_{wo}(tₑᵥₐₗ) for global M&R (1.0.1);
2. Calculate the Commons by adding the cost for work done before tₑᵥₐₗ (G$_{before})+the cost for reconstructing the section Major$_{crit} when the Section reaches critical PCI (1.0.2);
3. Use PF^{S}(tₑᵥₐₗ) to determine T^{S}_{wo}(tₑᵥₐₗ), the life (time to critical condition) for S without doing global work at tₑᵥₐₗ (1.0.3);
4. Use P^{S}(tₑᵥₐₗ+1) to determine T^{S}_{w}(tₑᵥₐₗ)), the lifespan for S with global work at tₑᵥₐₗ. PMA may be configured to use P^{S}(t) to compute the condition C_{w} for S in each year from tₑᵥₐₗ+1 to T^{S}_{w}(tₑᵥₐₗ) (1.0.4);
5. Use a LocalCostCalc method to determine localized cost up to T^{S}_{w}(tₑᵥₐₗ) (1.0.5); and
6. Use the global work types identified in MF and whether the distresses recorded in IH^{S} are climate-related, skid-causing or other (1.0.6).

Referring to FIG. 2, the LocalCostCalc method (executed by PMA) can generate a sum of three cost vectors. PMA may use this Sum to determine the EUAC^{S}_{w}(tₑᵥₐₗ) and EUAC^{S}_{wo}(tₑᵥₐₗ). As shown, PMA may comprise:
1. A historical calculator for determining costs for the historical period; the historical calculator configured to generate a first cost vector (2.0.1);
2. A planned calculator for determining costs for the planned period; the planned calculator configured to generate a second cost vector (2.0.2);
3. A future calculator for determining costs for the future period; the future calculator configured to generate a third cost vector (2.0.3); and
4. A cost calculator may be configured to calculate a result cost generated by summing the first cost vector, a second cost vector, and a third cost vector (2.0.4).

Referring to FIG. 3, PMA may be configured to determine estimate uniform annual cost with and without major M&R at time tₑᵥₐₗ. As shown, PMA may be configured to:
1. determine EUAC^{S}_{wo}(tₑᵥₐₗ) (3.0.1);
   a. determine the cost for reconstructing the section at PCI_{recon} (Major$_{recon}), the cost for doing global work through t_{recon}−1 (G$_{wo}) (3.0.2);
   b. determine the cost for doing local through t_{recon}−1 (L$_{wo}). PMA may be configured to determine t_{recon} (3.0.3);
   c. determine the age at which S will reach the reconstruction PCI PCI_{recon}. t_{recon} can be determined using PF^{S}(t_{WP}) (3.0.4); and
2. determine EUAC^{S}_{w}(tₑᵥₐₗ) (3.0.5);
a. determine the cost for reconstructing the section at tₑᵥₐₗ (Major$ₑᵥₐₗ) (3.0.6);
b. determine the cost for doing global work through tₑᵥₐₗ−1 (G$_{w}) (3.0.7); and
c. determine the cost for doing local through tₑᵥₐₗ−1 (L$_{w}) (3.0.8).

Referring to FIG. 4, PMA may be configured to use major ROI calculations (such as may be generated by the process discussed with reference to FIG. 3) to determine critical PCI for a PCI. As shown, the PMA computer may receive (4.0) certain inputs (PF, Cᵢₙᵢₜ, Δh, B, [Cₘᵢₙ, Cₘₐₓ]). The PMA computer may determine major maintenance and repair costs (4.0.1), use a calculated value of critical PCI to determine an ROI calculation (4.0.2), and determine EUAC for major repairs (4.0.3). Co-pending application (COE-871B) filed ______ (incorporated by reference in its entirety) contains detailed information on the algorithm and method to determine critical PCI for a PCI using major ROI calculations.

Referring to FIG. 5, PMA may be configured to calculate the value of k₂₀ and k_{w} to determine a proportionality relationship of PF (PCI Family) & MF (Maintenance and Repair Family). K₂₀ being equal to ((Major$_{crit}+s$_{wo})/(Major$_{crit}+p$_{w})) use major ROI calculations (such as may be generated by the process discussed with reference to FIG. 3) to determine critical PCI for a PCI. As shown, PMA may be configured to:
1. Determine major maintenance and repair costs (Major M&R) (5.0.1);
2. Analyze two different scenarios depending on whether the PCI family assigned to S was built using data from sections on which localized preventive was performed regularly (“family built with preventive maintenance”) or not (“family built without preventive maintenance”) (5.0.2);
3. For scenarios involving a PCI family built with preventive maintenance, the pavement repair program may be configured to: use the PCI family to determine EUAC^{S}_{w}(tₑᵥₐₗ); and estimate a lifespan loss of the Section for not doing preventive maintenance (5.0.3);
4. For scenarios involving a PCI family built without preventive maintenance, the pavement repair program may be configured to estimate the lifespan gain for doing preventive maintenance (5.0.4); and
5. The repair program may be configured to calculate K₂₀ for calculating a proportionality relationship of PF (PCI Family) & MF (Maintenance and Repair Family). K₂₀ being equal to ((Major$_{crit}+s$_{wo})/(Major$_{crit}+p$_{w})) use major ROI calculations (such as may be generated by the process discussed with reference to FIG. 3) to determine critical PCI for a PCI. (5.0.5).

To determine these costs, PMA may utilize certain input information and determine certain costs in performing the calculations. Co-pending application (COE-871B) contains detailed information on the algorithm and method to determine critical PCI for a PCI using major ROI calculations.

Localized Preventive M&R—Family Built with Preventive

FIG. 6 provides a process for calculating EUAC^{S}_{w}. (tₑᵥₐₗ) and EUAC^{S}_{wo}(tₑᵥₐₗ) for localized preventive M&R when the PCI family was built with preventive. The inputs for this method are the same as those for Global M&R except that an estimate of life loss ΔT^{S} for never doing preventive on S is needed. PMA can be configured to determine ΔT^{S} using the method presented in the previous section. FIG. 6 shows exemplary inputs for the algorithm on the bottom left and right of the figure.

PMA may be configured to determine both EUAC^{S}_{wo} and EUAC^{S}_{w}, by determining Common$, the sum of global work cost up to tₑᵥₐₗ (G$_{before}), localized work costs before work planning (L$ₚᵣₑ₁), localized work costs from work plan start to tₑᵥₐₗ (L$ₚᵣₑ₂) and the cost for major at PCI_{crit} (Major$_{crit}) (steps 6A.2 and 6A.3). PMA may determine global cost G$_{before} using a sum of two elements. One, PMA may set G$ₚᵣₑ as the cost of actual global work recorded in the section work history WH^{S}(6A.1.1.1) Two, PMA may determine global work directly as it may be included in work plan results WP^{S}(tₑᵥₐₗ) before tₑᵥₐₗ (6A. 1.1.1).

PMA may be configured to calculate localized costs before the workplan starts (L$ₚᵣₑ₁) from conditions by using the family curve shifted based on inspection and work history at each time t from 0 to t_{wp}−1 to determine the condition at time t, and using MR to get the appropriate localized cost (preventive if the condition is above critical, safety otherwise) (6A.1).

PMA may be configured to obtain localized costs L$ₚᵣₑ₂ from workplan start to tₑᵥₐₗ by accessing details within the work plan which are in WP^{S}(tₑᵥₐₗ) (6A.1). PMA may be configured to calculate Major$_{crit}. For families built with preventive, PMA may be configured to use the family curve to calculate the inputs for EUAC^{S}_{w}(tₑᵥₐₗ). PMA may be configured to use PF^{S}(tₑᵥₐₗ) to calculate T^{S}_{w}(tₑᵥₐₗ) and the conditions C_{w} from tₑᵥₐₗ+1 to T^{S}_{w}(tₑᵥₐₗ) (6A.2.1). PMA may be configured to determine the localized cost term L$_{w} using the preventive cost curve in MF (6A.2.2).

For families built with preventive, PMA may be configured to determine T^{S}_{wo}(tₑᵥₐₗ) (the lifespan of S without doing preventive on or after tₑᵥₐₗ) and L$_{wo} (the cost for localized work from tₑᵥₐₗ to T^{S}_{wo}(tₑᵥₐₗ)). PMA may be configured to use PF^{S}(tₗᵢ), the family curve shifted to pass through the last pre-global-work inspection before t_{WP}, to calculate T^{S}_{w}, the life of S with preventive (6A.3.1). PMA may be configured to use T^{S}_{w} to calculate Δt^{S}(tₗᵢ), the life loss for S at tₗᵢ as the fraction of ΔT^{S} that applies at tₗᵢ. PMA may be configured to resolve T^{S}_{wo}(tₗᵢ), the lifespan loss for not doing preventive on S after tₗᵢ (6A.3.1). PMA may be configured to calculate an annual age increase Δa as Δt^{S}(tₗᵢ) divided by the interval from t^{li} to T^{S}_{wo}(tₗᵢ). PMA may be configured to use PF^{S}(tₑᵥₐₗ) (the family curve shifted to pass through the workplan calculated condition at tₑᵥₐₗ) and Δa to calculate conditions after tₑᵥₐₗ. PMA may be configured to perform this operation by using PF^{S}(tₑᵥₐₗ) for years i=1, 2, . . . , n after tₑᵥₐₗ until the calculated condition at age tₑᵥₐₗ+n Δa is below PCI_{crit}. PMA may resolve T^{S}_{wo}(tₑᵥₐₗ) by solving the equation T^{S}_{wo}(tₑᵥₐₗ)=tₑᵥₐₗ+(n−1) and the conditions C_{wo} are those from tₑᵥₐₗ to T^{S}_{wo}(tₑᵥₐₗ). PMA can use the safety cost curve of MF to compute L$_{wo} and finally EUAC^{S}_{wo}(tₑᵥₐₗ) when PMA has already resolved C_{wo} (6A.3.4).

Localized Preventive M&R—Family Built without Preventive

FIG. 7A shows an algorithm/method in which PMA may be configured to execute using its processor. In some configurations, PMA may be configured to calculate EUAC^{S}_{w}(tₑᵥₐₗ) and EUAC^{S}_{wo}(tₑᵥₐₗ) for localized preventive M&R when the PCI family was built without preventive. The inputs for this algorithm may be the same as those presented with reference to FIG. 6A (family built with preventive), except that PMA may be programmed to receive an estimate for life gain for doing preventive instead of an estimate of life loss. PMA may be configured to determine EUAC wo and EUAC^{S}_{w} by determining Common$, the sum of global work cost up to tₑᵥₐₗ (G$before), localized safety costs before work planning (L$ₚᵣₑ₁), localized work costs from work plan start to tₑᵥₐₗ (L$ₚᵣₑ₂) and the cost for major at PCI_{crit} (Major$_{crit}) (7A.2 and 7A.3).

PMA may be configured to determine Global cost G$_{before} by summing two elements. One, PMA may determine G$ₚᵣₑ as the cost of actual global work recorded in the section work history WH^{S}. Two, PMA may determine global work included in work plan results WP^{S}(tₑᵥₐₗ) before tₑᵥₐₗ (7A.1.1.1).

PMA may be configured to calculate localized costs before the workplan starts (L$ₚᵣₑ₁) from conditions by using the family curve shifted based on inspection and work history at each time t from 0 to t_{WP}−1 to determine the condition at time t, and using MR to get the localized safety cost at that condition (just safety costs are used because the family model is without preventive) (7A.1.2). PMA may be configured to resolve localized costs L$ₚᵣₑ₂ from workplan start to tₑᵥₐₗ from the work plan at WP^{S}(tₑᵥₐₗ). PMA may calculate Major$_{crit} by using MF. For example, PMA can determine Major$_{crit} directly from PCI_{crit} and the major M&R cost curve in MF (7A.1.3).

For families built without preventive, PMA may be configured to use the family curve to calculate the inputs for EUAC^{S}_{wo}(tₑᵥₐₗ). PMA may be configured to use PF^{S}(tₑᵥₐₗ) to directly calculate T^{S}_{wo}(tₑᵥₐₗ) and the conditions C_{wo} from tₑᵥₐₗ+1 to T^{S}_{wo}(tₑᵥₐₗ) (7A.2.2). PMA may be configured to determine the localized cost term L$_{w} using the appropriate cost curve in MF; when the PCI is above critical this will be the preventive cost, and when the PCI is below critical it will be the safety cost.

For families built without preventive, PMA may be configured to determine T^{S}_{w} (the life of S when doing preventive on and after t_{WP}) and L$_{w} (the cost for localized work from tₑᵥₐₗ to T^{S}_{w}). PMA may be configured to use PF^{S}(tₗᵢ), the family curve shifted to pass through the last pre-global-work inspection before t_{WP}, to calculate T^{S}_{wo}, the life of S without preventive. PMA may use T^{S}_{wo} to calculate Δt^{S}(tₗᵢ) the life gain for S at tₗᵢ as the fraction of ΔT^{S} that applies at tₗᵢ (7A.3.1). PMA may resolve T^{S}_{w}(tₗᵢ), the life gain for doing preventive on S after tₗᵢ. PMA may be configured to calculate the annual age decrease Δa as Δt^{S}(tₗᵢ) divided by the interval from tₗᵢ to T^{S}_{w}(tₗᵢ) (7A.3.2). PMA may be configured to use PF^{S}(tₑᵥₐₗ) (the family curve shifted to pass through the workplan calculated condition at tₑᵥₐₗ) and Δa to calculate conditions after tₑᵥₐₗ (7A.3.3). PMA may perform these calculations using PF^{S}(tₑᵥₐₗ) for years i=1, 2, . . . , n after tₑᵥₐₗ until the calculated condition at age tₑᵥₐₗ+n Δa is below PCI_{crit}. PMA may determine T^{S}_{w}(tₑᵥₐₗ) using the equation T^{S}_{w}(tₑᵥₐₗ)=tₑᵥₐₗ+(n−1) and the conditions C_{w} are those from tₑᵥₐₗ to T^{S}_{wo}(tₑᵥₐₗ). PMA may be configured to use the preventive cost curve of MF to compute L$_{w} and finally EUAC^{S}_{w}(tₑᵥₐₗ) when C_{w} has been resolved (7A.3.4).

Localized Preventive M&R—Work Planning without Preventive

The previous two sub-sections specified algorithms and methods for calculating estimated uniform annual cost for preventive work when planning work. These algorithms/methods may presume that work planning included planning preventive work, and that PMA would be configured to compute the ROI for continuing to do preventive work at tₑᵥₐₗ. FIGS. 6B and 7B illustrate the alternate scenarios (algorithms/process flows) of work planning without preventive work and computing the ROI of starting to do localized preventive work at tₑᵥₐₗ. To compute the estimated uniform annual costs associated with starting preventive work at tₑᵥₐₗ when the work planner is not planning localized preventive work: since the work plan is not planning localized preventive work, the cost L$ₚᵣₑ₂ (localized work costs from t_{wp} to tₑᵥₐₗ) is changed to the safety cost in Common$ (block 6A.1.3 or 7A.1.3 in FIGS. 6A and 7A respectively). FIGS. 6B and 7B show this change. PMA may also be configured to use a work plan that will also apply an age increment to reduce the calculated conditions from t_{wp} to tₑᵥₐₗ, with the result that the family curve PF^{S}(tₑᵥₐₗ) will start at a lower PCI than when the work plan is run with preventive.

### PMA Configurations

Referring to FIG. 8, a user may operate a computer comprising a processor 802, memory 804, system bus 806, network interface 808, storage media 810, display 812, and controls 814 (like a mouse and keyboard). The processor 802 may run or execute a program stored in the storage media and/or memory to cause the processor to execute a sequence of steps and/or algorithms, i.e., run the program PMA 820. PMA is a software program that may be configured to analyze and prioritize repairs of Sections (S). PMA may comprise a data input module 822, solver 824, and result module 826 capable of determining optimized maintenance and repair schedules for a network of Sections. As shown, the computer operating PMA may be connected to a database 830 and a second computer—the Section M&R computer 850 (also having processor, memory, system bus, network, storage media, display, mouse, and keyboard).

The database 830 may be a component in the PMA computer 800 or be its own server. As a database, the server may comprise database management software capable of sorting, updating, retrieving, and manipulating records stored in the database. The server may comprise standard hardware found in servers such as processors, memory, network interface, storage media, etc.

The Section M&R computer may have a section maintenance and/or repair scheduler 852 configured to schedule maintenance and/or repairs on a section. The Section M&R Computer 850 may interface with a section maintenance and/or repair system. The section maintenance and/or repair system 860 may comprise various trucks 862, computers 864, supplies 866, paving equipment 868, and pavement repair technology 870 useful for paving and repairing roads. In some configurations, the PMA computer and the Section M&R computer can be a single computer.

An inspection system 880 may be a machine configured to inspect a condition for one or more sections. The inspection system may comprise computers 882 and cameras 884. The computer may comprise specialized software for determining pavement condition from images obtained by the cameras. An inspection system may be mounted in a plane, helicopter, truck, car, or other vehicle 886. An inspection system may contain controls 888 for local or remote operations of the inspection system by an inspector. An inspection system may be configured to generate inspection records. Inspection records may contain information recorded and/or obtained about distresses (such as degree and quantity) of a Section. PMA may be configured to store these records. PMA may be configured to display these records in the inspection ribbon. PMA may be configured to allow a user to manage, change, sort, and manage an inspection history of a Section. An inspection history is a collection of inspection records of the Section.

A Section is a portion of a branch. Branches may include pavement, roads, streets, parking lots, highways, parkways, runways. PMA, taxiways, or aprons. A section may be surfaced with asphalt, concrete, brick, aggregate, or mat. Paver may be configured to manage sections as its primary unit.

PMA, like many programs/applications, may comprise a plurality of windows. A window may comprise one or more buttons, fields, labels, toggles, select boxes, drop down boxes, radial boxes, etc. Each window in PMA may comprise underlying or associated logic, algorithm, or software routine configured to accept inputs, process inputs, generate results, stores results, display results, and/or issue instructions to other logic and/or windows and/or systems. For example, the inspection window may comprise an inspection logic. The inspection logic may be configured to store inspections records for a Section. Or in another example, the inventory window may comprise an inventory logic. The inventory logic may be configured to divide a large area of pavement into groupings.

PMA may have a main menu and a ribbon menu. These menus may be configured organized various windows. The ribbon menu may have an inventory, reports, selectors, work, debug, inspection, family modeling, conditions performance analysis, M&R family models inventory, M&R work planning, project formulation wizard, and wizards. FIGS. 10A-10B shows the inventory ribbon menu.

FIG. 9 shows an overall view of various algorithms that PMA may be programmed to execute. FIG. 9 contains elements 1, 3, 4, 5, 6A, 6B, 7A and 7B. More details on each of these elements may be found in FIGS. 1-7B and in the other two co-pending applications incorporated by reference above.

FIGS. 10A-61B are screenshots of an embodiment of PMA. In these embodiments, PMA may be a software program running a specialized PMA computer. The PMA computer may comprise optimized hardware to more efficiently run the PMA software program. The PMA computer may comprise a monitor to display these screenshots to a user.

FIGS. 10A-10B shows an inventory window in PMA. PMA may have inventory. The inventory may be stored on the computer and/or remote database. The inventory can be used to divide a large area of pavement into groupings. As shown, the inventory window may have 3 tabs: a5 network tab, branch tab, and a section tab. FIG. 10A-FIG. 10B show the network tab in detail. The largest of these groupings may be a network such as a town or city. Within a network, there may be branches like a street. Branches may contain sections, i.e., a portion of a street reaching from one intersection to the next.

FIGS. 11A-11B show the inventory window of the branch tab, the branch tab may show branch properties. Example properties include branch ID, use, sum of section lengths, sum of true section areas, brand true area.

FIGS. 12A-12B shows the inventory window of the section tab. The section tab may show a table inventory section's properties. Sections (S) are represented by variable S in various algorithms in the application. The section tab may have several subtabs including: properties, conditions/families, and samples. FIGS. 12A-12B show the properties subtabs.

FIGS. 13-14 shows a window of GIS maps. GIS Maps can be used to give context to the inventory. The GIS map shows a map of roadways in this figure, but may also be configured to show a map of an airfield. FIGS. 13-14 show a current selection section.

FIGS. 15A-15B shows the inventory window with the conditions/families tab selected and one condition index for all dates. The box indicates M&R families (MF) assigned to this section. The window shoes inspection dates, conditions, and method. The box indicates the inspection (IH^{S}) of a current Section. FIGS. 15A-15B show a radial selector including: view all latest conditions, view all indices and dates, view one condition index for all dates, view PCI Deteriorations Family Assignments, View M&R family assignments. The view one condition index for all dates is selected in FIGS. 15A-15B.

FIGS. 16A-16D shows an inspection window of the inspection submenu. Sections may be inspected by a user on a regular basis. An inspection system may be configured to record the distresses and their quantity. Inspections give us the condition across time (IH^{S}). Distresses may include a distress identifier, distress descriptions, distress severity, quantity, units (for the quantity), density, deduct, and/or comment. PMA may be configured to take, accept, and store pictures/video of distresses and sum distresses. The inspection system may be configured to capture images and/or videos of distresses. The inspection system may automatically transfer captured images and/or videos of section distresses to PMA. In some configurations, an algorithm executed a computer in the inspection system may be configured to determine which images and or video to transfer to PMA. In some configurations, the inspection system may comprise a selection tool configured to allow an inspector to make and/or override images and/or video to transfer to PMA. The Distresses selections shows 20 exemplary distresses such as alligator cracks, bleeding, block cracks, bumps, sags, corrugation, edge cracks, JT Ref. Cr, lane sh drop, L&T Crack, patch/UT cut, polished AG, pothole, rutting, shoving, slippage crack, swell, raveling, and weathering. JT=Joint; Ref.=Reflection; Cr=Crack; sh=Shoulder; L&T=Longitudinal and Transverse; UT=Utility; AG=Aggregate.

FIG. 17 shows a window called or displayed when the show conditions button is clicked. PMA may be configured to calculate multiple different condition values from the recorded distresses and quantities. PMA may be configured to use PCI for risk analysis. The window shows a network ID, branch ID, and section ID. It also shows section area, section width, and section length. The PCI index and condition value are also displayed.

FIGS. 18A and 18B show a PCI Family Models (PF) window. Records may be stored within a PCI family model. PMA may store conditions of similar sections across time as groups. PMA may use the groups to graph a point cloud of Age vs PCI. A point cloud of Age vs PCI is shown in FIGS. 18A and 18B. The PCI Family Models window may comprise tabs: review model data, use boundary/outlier, options, view equations and stats, and assign family.

FIGS. 19A and 19B show the PCI family model window with the view equations and stats tab selected. The PMA software may be configured to fit a curve to the point cloud. The equation of this curve is representative of how the condition of a section will change over time. In other words, the curve of the line models or is a prediction the condition of the section as a function of age of the road.

FIGS. 20A and 20B show the PCI family model window with the Assign Family tab selected. As the behavior of a Section's condition may depend on several factors, PMA may provide multiple models of the pavement's lifespan with a network. PMA may assign Sections to models built with data from similar Sections.

FIGS. 21A and 21B show the PCI family model window with the Options tab selected, but the top graph is not shown for illustration purposes. However, FIGS. 21A and 21B show the Critical PCI Nomination window (accessible by clicking the sweet spot analysis button). PMA may be configured to use risk calculations to perform a sweet spot analysis. PMA may be configured to compute ROI many times. PMA may change the PCI at time of work and the Critical PCI of the family to identify a combination (of PCI at time of work and the Critical PCI of the family) that generates a maximized (highest potential) ROI.

FIGS. 22A-22B, 23A-23B, 24A-24B, 25A-25B show examples of M&R Family windows. PMA may use M&R Families to group together M&R data that may be shared to all the Sections assigned to that M&R Family. The M&R data may include Cost by Condition, Cost by Work Type, and work types. PMA may use this M&R data when planning work.

FIGS. 26A and 26B show a major M&R cost table window. For major work, PMA may be configured to model a cost table. The cost table may be used by PMA to approximate a cost of doing road work on a Section based on the condition of the Section at the time of the work.

FIGS. 27A and 27B show a global M&R work type window. Global work types may have a Delta ΔT value. The Delta T value may be the expected life gain from application of the roadwork (e.g., completing recommended roadwork). The global M&R work type window may be configured to calculate a section specific Delta T value in the current fiscal year.

FIGS. 28A and 28B show a global work is priced by work types instead of condition. A table in the window displays a code, name, cost, and units.

FIGS. 29A-29B shows a window for preventative cost by condition. A table shows condition, cost, and unit area.

FIGS. 30A-30B shows a window for stopgap cost by condition. A table shows condition, cost, and unit area.

FIGS. 31A-31B shows a condition performance analysis window. PMA may be configured to generate condition analysis models. Condition analysis models may be configured to determine how Sections are going to decay if no M&R work is performed. PMA may be configured to shift the assigned PCI family to the latest inspection point for each section and compute the condition year by year for the duration of the work plan.

FIGS. 32A-32B shows a section condition list associated with the condition performance analysis window. The PMA may be configured to collect condition values (C^{S}(tₑᵥₐₗ)) in the risk calculations of the pavement's life. PMA may be configured, for each of these conditions, to compute a cost using the appropriate cost by condition table and their sums become (C_{w}) and (C_{wo}).

FIGS. 33A-33B shows a work plan analysis window. The work plan analysis window may be configured to model conditions of Sections condition into the future. The work plan analysis window may be configured to apply M&R work to calculations regarding the condition of a Section in the present or in the future. Application of M&R work may result in an improvement of the condition and/or lifespan of the Section.

FIGS. 34A-34B shows a work plan analysis window with a budget tab selected. PMA may be configured to provide users with settings to constrain a budget available to a work plan. PMA may generate work recommendations. Work recommendations may be generated on a set schedule such as yearly or monthly. PMA may prioritize the work recommendation using a prioritization algorithm. PMA may reduce the work applied to fit within the budget limitations. In some configurations, PMA may comprise a prioritization method that utilizes risk analysis of ROI results.

FIGS. 35A-35B show a risk calculation window. The window can be turned on and off for each work category. As shown, there are checkboxes for localized stopgap M&R, localized preventative M&R. A global preventive M&R checkbox has sub-boxes: calculate risk and ROI, only plan global in PCI range, allow global for sections above critical with load defects, minimum age before global. A major M&R checkbox may comprise calculate risk and ROI.

FIGS. 36A-36B, 37A-37B, and 38A-38B show tabs. PMAM&R family tabs that may affect risk calculation. Paver may be configured to require the fill out these tabs when a risk calculation is turned on (enabled). The properties on these tabs may be configured to determine whether the assigned M&R Families are used to specify which cost tables to use or whether a single cost table should be used across all Sections.

FIGS. 39A-39B show a work plan analysis window with a global M&R family settings tab selected. PMA may be configured the user adjust/configure these global M&R family settings for the global risk calculations.

FIGS. 40A-40B show a results selection tool configured to cause PMA to display a result window such as a table, graph, map, menu, or display. In the example of FIGS. 40A-40B, PMA may be configured to generate thirty different results. In the example of FIGS. 40A-40B, a Section PCI by Year checkbox is selected. The result of Section PCI by Year is shown in FIGS. 41A-41C.

FIGS. 41A-41C show the results table Section PCI by Year table and graph. The table shows network ID, branch ID, and section ID. The screenshot also shows a graph of condition by year. Condition on the Y-axis, and year on the X axis.

FIGS. 42A-42B show a result window configured to display a major M&R risk by Section summary. In this window, PMA may be configured to calculate the ROI for each row and display them in the result window.

FIGS. 43A-43B show a result window configured to display a localized preventative M&R risk by section summary. The table shows year, NetworkID, BranchID, SectionID, PCI at work date, % ROI (localized preventive), deterioration rate with localized preventive, Critical PCI, and Work Date for Risk.

FIGS. 44A-44C show a project planning window. PMA may be configured to generate projects. PMA may be configured to allow user to set projects as required or optional. These projects may define specific work to be done in the future. These projects may be included when running the work plan. A work planner (a software routine or logic) may be configured to take the project work into account when budgeting and making work recommendations. Once the work is completed, PMA may move these projects into a work history database for the relevant Sections.

FIG. 45 shows a work required window. Work required logic in the work required window may generate additional windows when the calculate risk button is selected. The additional windows generated may be configured to allow PMA to present options to the user. The options may be selected through three tabs: localized stopgap M&R, localized preventative M&R, and Major M&R.

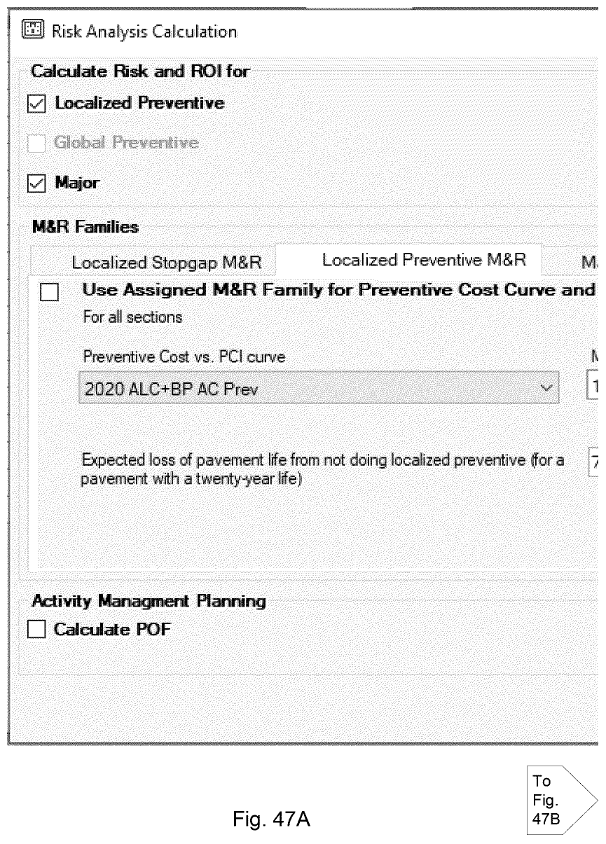

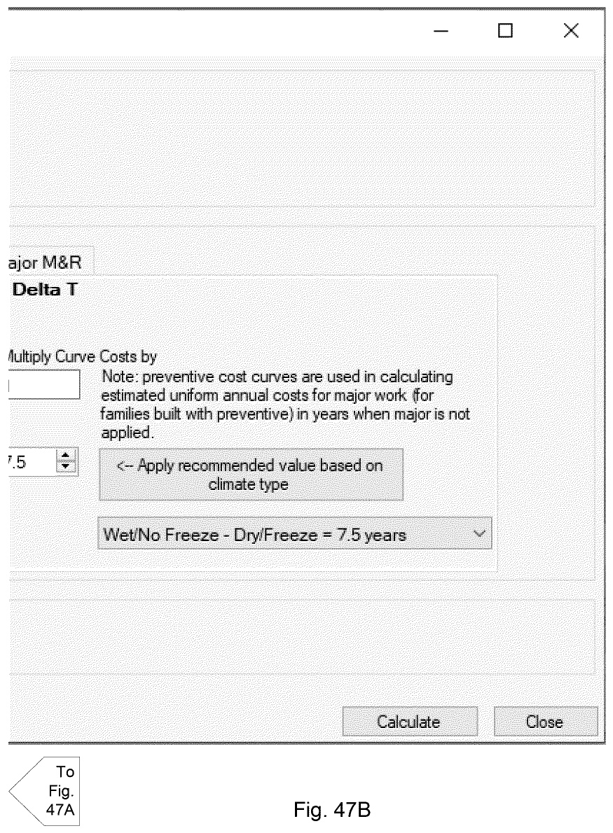

FIGS. 46A-46B, FIGS. 47A and 47B, and FIGS. 48A and 48B show additional risk calculation windows. FIG. 46 shows M&R Families calculations for localized stopgap M&R. FIG. 47 shows localized preventative M&R. Fig. shows a window to calculate risk and ROI.

FIGS. 49A-49C and FIGS. 50A-50C show a risk analysis for project work window. PMA may be configured to display this window as part of a results display. PMA may individually calculate risk for a project for each work item in the project. In some configurations, PMA may calculate an overall risk value at the project level.

FIGS. 51A to 51B show a project work detail window. The project work detail window may be configured to display individual work items risk value in an overview grid.

FIGS. 52A-52B show an inventory: surface, use, rank category window. The window shows parking in blue, roadways in green, and storage in yellow.

FIGS. 53A-53B show an assignment of PCI deterioration and M&R families window. The window may display an assignment of PCI deterioration families to pavement sections.

FIGS. 54A-54B show a work category by projects window. This window may display a list of projects—colors indicated M&R category.

FIGS. 55A-55B show a projects list window. This window may create a display of all projects—colors indicated M&R work type.

FIGS. 56A-56B show a work plan category by year window. This window may display a workplan recommended annual work categories for all pavement sections.

FIGS. 57A-57B show a workplan recommended for Major M&R by year window. Red is major above critical. Blue is major below critical.

FIGS. 58A-58B shows a first year of an annual section PCI when recommended workplan is performed window. White shows no data. Green is good. Teal is satisfactory. Yellow is fair. Salmon is poor. Red is very poor. Crimson is serious. Gray is failed.

FIGS. 59A-59B shows a second year of an annual section PCI when recommended workplan is performed window. White shows no data. Green is good. Teal is satisfactory. Yellow is fair. Salmon is poor. Red is very poor. Crimson is serious. Gray is failed.

FIGS. 60A-60B show a second year of an annual section PCI when recommended workplan is performed window. White shows no data. Green is good. Teal is satisfactory. Yellow is fair. Salmon is poor. Red is very poor. Crimson is serious. Gray is failed.

FIGS. 61A-61B show a predicted PCI when no work is performed window. The window features the same color legend as described for FIGS. 58-60.

Referring to FIG. 62, when the pavement is appropriately designed for traffic and the environment, one can expect the green curve. If the pavement is too weak to support the traffic, it normally fails very quickly and it performs as shown in the red graph. If the pavement is strong or overdesigned, it performs as shown in the blue graph. One can see strong pavement performance sometimes in concrete pavement performance. PMA may be configured to use the results of PCI inspection to develop the performance curve for each similar group of sections (family). A family curve may be somewhere between the red and blue curves.

Referring to FIG. 63, the figure shows how PMA might calculate pavement performance in the case when a Global is applied at tₑᵥₐₗ. The first blue portion of the curve (to to t_{wp}) may be the pavement history prior to starting the work plan analysis. The second purple portion (t_{wp} to tₑᵥₐₗ) may be where the work plan applies the family curve and accounts for any Localized or Global applications in that period. PMA may be configured such that if Major is applied the PCI becomes 100 and a new life analysis begins. The rest of the figure shows what might happen if PMA were determining the ROI (or calculate risk) assuming Global is applied at tₑᵥₐₗ. The dark blue shows a family curve applied to the section based on the section PCI at that time. The increase in PCI at tₑᵥₐₗ may be calculated based on the value of ΔT(tₑᵥₐₗ). The calculation may be done by shifting the curve so that the PCI value at tₑᵥₐₗ, (before the Global application), is equal to the PCI at tₑᵥₐₗ, (before the Global application), plus ΔT(tₑᵥₐₗ).

The claimed invention is:

1. A PMA computer comprising a processor and tangible memory storing non-transitory computer readable software configured to cause the processor to execute a pavement repair program specialized in determining calculating EUAC^{S}_{w}(tₑᵥₐₗ) (estimated uniform annual cost per unit area for S when performing work (w) of a particular category at time/age tₑᵥₐₗ) and EUAC^{S}_{wo}(tₑᵥₐₗ) (estimated uniform annual cost per unit area for S without (wo) performing work of a particular category on S at time/age tₑᵥₐₗ) for localized preventive M&R when the PCI family was built with preventive maintenance; the program comprising:
an input interface configured to allow a user to specify to the program:
a Section of road for evaluation (S);
a PCI family (PF) assigned to Section (S) defined as PF^{S}; wherein PCI is a pavement condition index of the Section;
a PCI_{crit} defined as a critical for PF^{S};
a M&R family (MF^{S}) assigned to S;
an inspection history (IH^{S}) for S;
a work history (WH^{S}) for S;
a tᵢᵢ defined as an age of last inspection prior to any global work on S;
ΔT^{S} defined as a lifespan loss not doing preventive maintenance on S;
a work plan start (t_{WP});
a time of evaluation (tₑᵥₐₗ);
a work-planned work WP^{S}(tₑᵥₐₗ) for S before (tₑᵥₐₗ); and
a work-plan predicted conditions (C^{S}(tₑᵥₐₗ)) for S up to tₑᵥₐₗ;
a EUAC calculator configured to use: Common$, the sum of global work cost up to tₑᵥₐₗ (G$_{before}), localized work costs before work planning (L$ₚᵣₑ₁), localized work costs from work plan start to tₑᵥₐₗ (L$ₚᵣₑ₂), and a cost for major at PCI_{crit} (Major$_{crit}) to determine EUAC^{S}_{wo} and EUAC^{S}_{w};
a global cost calculator configured to calculate G$_{before};
a calculator configured to:
determine localized costs before a workplan starts (L$ₚᵣₑ₁) are calculated from conditions by using the family curve shifted based on inspection and work history at each time t from 0 to t_{WP}−1 to determine a condition at time t of the Section S, and using MR to get the appropriate localized cost; wherein:
the appropriate localized cost being a preventive maintenance cost when the condition of the Section is above or equal critical;
the appropriate localized cost being a safety maintenance cost when the condition of the Section is below critical;
the work plan results (WP^{S}(tₑᵥₐₗ)) comprising localized costs L$ₚᵣₑ₂; calculate Major$_{crit};
calculate inputs for EUAC^{S}_{wo}(tₑᵥₐₗ) using a family curve for families built with preventative maintenance; and
calculate inputs for EUAC^{S}_{wo}(tₑᵥₐₗ) using a family curve for families built without preventative maintenance.

2. The PMA computer of claim 1 wherein the calculator is configured to calculate T^{S}_{w}(tₑᵥₐₗ) with PF^{S}(tₑᵥₐₗ).

3. The PMA computer of claim 1 wherein the calculator is configured to calculate conditions C_{w} from tₑᵥₐₗ+1 to T^{S}_{w}(tₑᵥₐₗ).

4. The PMA computer of claim 1 wherein the calculator is configured to determine a localized cost term L$_{w} using the preventive cost curve in MF.

5. The PMA computer of claim 1 wherein the global cost calculator is configured to determine a sum of two elements: (1) G$ₚᵣₑ a cost of actual global work recorded in the section work history WH^{S} and (2) Global work included in work plan results WP^{S}(tₑᵥₐₗ) before tₑᵥₐₗ.

6. The PMA computer of claim 1 wherein the calculator is configured to use PF^{S}(tₗᵢ), defined as the family curve shifted to pass through the last pre-global-work inspection before t_{wp}, to calculate T^{S}_{w}, the lifespan of S with preventive maintenance.

7. The PMA computer of claim 6 wherein the calculator is configured to use T^{S}_{w} to calculate Δt^{S}(tₗᵢ) defined as the lifespan loss for S at tₗᵢ as a fraction of ΔT^{S} that applies at tₗᵢ.

8. The PMA computer of claim 7 wherein the calculator is configured to resolve T^{S}_{wo}(tₗᵢ) which is the lifespan loss for not doing preventive maintenance on S after tₗᵢ.

9. The PMA computer of claim 8 wherein the calculator is configured to calculate an annual age increase Δa as Δt^{S}(tₗᵢ) divided by an interval from tₗᵢ to T^{S}_{wo}(tₗᵢ).

10. The PMA computer of claim 9 wherein the calculator is configured to use PF^{S}(tₑᵥₐₗ) defined as the family curve shifted to pass through the workplan calculated condition at tₑᵥₐₗ) and Δa to calculate conditions after tₑᵥₐₗ.

11. The PMA computer of claim 10 wherein the calculator is configured to calculate condition after tₑᵥₐₗ by using PF^{S}(tₑᵥₐₗ) for years i=1, 2, . . . , n after tₑᵥₐₗ until the workplan calculated condition at age tₑᵥₐₗ+n Δa is below PCI_{crit}.

12. The PMA computer of claim 11 wherein the calculator is configured to determine T^{S}_{wo}(tₑᵥₐₗ) using the equation T^{S}_{wo}(tₑᵥₐₗ)=tₑᵥₐₗ+(n−1) and the conditions C_{wo} are those from tₑᵥₐₗ to T^{S}wo (tₑᵥₐₗ).

13. The PMA computer of claim 12 wherein the calculator is configured to use the safety cost curve of MF to compute L$_{wo} once C_{wo} has been determined.

14. The PMA computer of claim 12 wherein the calculator is configured to use L$_{wo} to calculate EUAC^{S}_{wo}(tₑᵥₐₗ).

15. A PMA computer comprising a processor and tangible memory storing non-transitory computer readable software configured to cause the processor to execute a pavement repair program specialized in determining calculating EUAC^{S}_{w}(tₑᵥₐₗ) and EUAC^{S}_{wo}(tₑᵥₐₗ) for localized preventive M&R when the PCI family was built without preventive maintenance;
the program comprising:
an input interface configured to allow a user to specify to the program:
a Section of road for evaluation(S);
a PCI family (PF) assigned to Section(S) defined as PF^{S}; wherein PCI is a pavement critical index of the Section;
a PCI_{crit} defined as a critical for PF^{S};
a M&R family (MF^{S}) assigned to S;
an inspection history (IH^{S}) for S;
a work history (WH^{S}) for S;
a tᵢᵢ defined as an age of last inspection prior to any global work on S;
ΔT^{S} defined as a lifespan gain for doing preventative maintenance on S;
a work plan start (t_{WP});
a time of evaluation (tₑᵥₐₗ);
a work-planned work for S before (tₑᵥₐₗ); and
a work-plan predicted conditions (C^{S}(tₑᵥₐₗ)) for S up to tₑᵥₐₗ;
a EUAC calculator configured to use: Common$, the sum of global work cost up to tₑᵥₐₗ (G$_{before}), localized safety costs before work planning (L$ₚᵣₑ₁), localized work costs from work plan start to tₑᵥₐₗ (L$ₚᵣₑ₂), and a cost for major at PCI_{crit} (Major$_{crit}) to determine EUAC^{S}_{wo} and EUAC^{S}_{w};
a global cost calculator configured to calculate G$_{before};
a calculator configured to:
determine localized costs before a workplan starts (L$ₚᵣₑ₁) from conditions by using the family curve shifted based on inspection and work history at each time t from 0 to t_{WP}−1 to determine the condition at time t, and using MR to get the appropriate localized safety cost at that condition cost; the work plan results (WP^{S}(tₑᵥₐₗ)) comprising localized costs L$ₚᵣₑ₂;
calculate Major$_{crit}; and
calculate inputs for EUAC^{S}_{wo}(tₑᵥₐₗ) using a family curve for families built with preventative maintenance.

16. The PMA computer of claim 15 configured to determine G$ₚᵣₑ a cost of actual global work recorded in the section work history WH^{S}.

17. The PMA computer of claim 15 configured to determine Global work included in work plan results WP^{S}(tₑᵥₐₗ) before tₑᵥₐₗ.

18. The PMA computer of claim 15 wherein the calculator is configured to calculate T^{S}_{w}(tₑᵥₐₗ) with PF^{S}(tₑᵥₐₗ).

19. The PMA computer of claim 15 wherein the calculator is configured to calculate conditions C_{w} from tₑᵥₐₗ+1 to T^{S}_{w}(tₑᵥₐₗ).

20. The PMA computer of claim 15 wherein the calculator is configured to determine a localized cost term L$_{w} using an appropriate cost curve in MF; the appropriate cost curve being a preventative cost when the PCI of the Section is above or equal to critical; the appropriate cost curve being a safety cost when the PCI of the Section is below critical.

21. The PMA computer of claim 15 wherein the calculator is configured to (for families built without preventive maintenance) determine T^{S}_{w} (the life of S when doing preventive maintenance on and after t_{wp}) and L$_{w} (the cost for localized work from tₑᵥₐₗ to T^{S}_{w}).

22. The PMA computer of claim 21 wherein the calculator is configured to use PF^{S}(tₗᵢ), defined as the family curve shifted to pass through the last pre-global-work inspection before t_{wp}, to calculate T^{S}_{wo}, the lifespan of S without preventive maintenance.

23. The PMA computer of claim 22 wherein the calculator is configured to use T^{S}_{wo} to calculate Δt^{S}(tₗᵢ) defined as the lifespan gain for S at tₗᵢ as a fraction of ΔT^{S} that applies at tₗᵢ.

24. The PMA computer of claim 23 wherein the calculator is configured to resolve T^{S}_{wo}(tₗᵢ) which is a lifespan gain for performing preventive maintenance on S after tₗᵢ.

25. The PMA computer of claim 24 wherein the calculator is configured to calculate an annual age decrease Δa as Δt^{S}(tₗᵢ) divided by an interval from tₗᵢ to T^{S}_{w}(tₗᵢ).

26. The PMA computer of claim 25 wherein the calculator is configured to use PF^{S}(tₑᵥₐₗ) defined as the family curve shifted to pass through the workplan calculated condition at tₑᵥₐₗ) and Δa to calculate conditions after tₑᵥₐₗ.

27. The PMA computer of claim 26 wherein the calculator is configured to calculate condition after tₑᵥₐₗ by using PF^{S}(tₑᵥₐₗ) for years i=1, 2, . . . , n after tₑᵥₐₗ until the workplan calculated condition at age tₑᵥₐₗ+n Δa is below PCI_{crit}.

28. The PMA computer of claim 27 wherein the calculator is configured to determine T^{S}_{w}(tₑᵥₐₗ) using the equation T^{S}_{w}(tₑᵥₐₗ)=tₑᵥₐₗ+(n−1) and the conditions C_{w} are those from tₑᵥₐₗ to T^{S}_{wo}(tₑᵥₐₗ).

29. The PMA computer of claim 28 wherein the calculator is configured to use the preventative cost curve of MF to compute L$_{w} once C_{wo} has been determined.

30. The PMA computer of claim 29 wherein the calculator is configured to use L$_{w} to calculate EUAC^{S}_{w}(tₑᵥₐₗ).
